(19) United States
(12) Patent Application Publication
(10) Pub. No.: US 2026/0289672 A1
(43) Pub. Date: Sep. 24, 2026

(54) Order Book Storage Architecture for Electronic Trading Systems.

(71) Applicant: Jake Jinseok Yoon, Anchorage, AK (US)

(72) Inventor: Jake Jinseok Yoon, Anchorage, AK (US)

(21) Appl. No.: 19/674,421

(22) Filed: May 12, 2026

Related U.S. Application Data
(63) Continuation-in-part of application No. 19/360,977, filed on Oct. 16, 2025.
Application No. 19/360,977 is a continuation-in-part of application No. 19/334,857, filed on Sep. 20, 2025.
Application No. 19/334,857 is a continuation-in-part of application No. 19/260,613, filed on Jul. 7, 2025, now Pat. No. 12,541,795.
Application No. 19/260,613 is a continuation-in-part of application No. 19/080,927, filed on Mar. 16, 2025, now Pat. No. 12,462,304.
(63) Continuation-in-part of application No. PCT/US26/19442, filed on Mar. 16, 2026.

(51) Int. Cl. G06Q 40/04

(52) U.S. Cl. CPC G06Q 40/0432; G06Q 40/0451

(57) ABSTRACT

An order book storage architecture for electronic trading systems. Entries are stored in nodes having contiguously addressable slot regions, with priority indicators that enable priority determination without searching the entire order book. Node capacity may vary by depth from the book head. Price level metadata is maintained in balanced search trees supporting neighbor-aware insertion and deletion with bounded reference writes and single-path rebalancing. A price-level accelerator embodiment provides multi-banked descriptor memory, insertion and deletion pipelines, a fix-up micro-sequencer, and tick-indexed comparators. An order-queue storage accelerator circuit embodiment provides memory (e.g., on-chip memory) with contiguously addressable slot regions, indicator storage for priority indicators, and operation logic comprising insertion logic, removal logic, or both, with optional indicator-update logic. Engine, accelerator circuit, machine-readable medium, and service embodiments are disclosed, including ordered replicated deployments, such as those applying events in a total order derived from a consensus ledger.

### CROSS-REFERENCE TO RELATED APPLICATIONS

This application is a continuation-in-part under 35 U.S.C. § 120 of U.S. Non-Provisional application Ser. No. 19/360,977, filed Oct. 16, 2025, which is a continuation-in-part of U.S. Non-Provisional application Ser. No. 19/334,857, filed Sep. 20, 2025, which is a continuation-in-part of U.S. Non-Provisional application Ser. No. 19/260,613, filed Jul. 7, 2025, which is a continuation-in-part of U.S. Non-Provisional application Ser. No. 19/080,927, filed Mar. 16, 2025. This application also claims the benefit under 35 U.S.C. §§ 120 and 365(c) as a continuation-in-part of International Application No. PCT/US2026/019442, filed Mar. 16, 2026, which designates the United States. The disclosures of all of the foregoing applications are incorporated herein by reference in their entirety.

### FIELD OF THE INVENTION

This invention relates to electronic trading systems for processing large volumes of trade orders with ultra-low latency, and to associated order-queue storage architectures, hardware-circuitry realizations, machine-executable embodiments, and service deployments thereof.

### TECHNICAL BACKGROUND

Modern electronic trading platforms rely on matching engines to rapidly pair buy and sell orders and execute trades. These systems must maintain predictable low latency to ensure fair market operations and mitigate financial risks associated with execution delays. However, traditional matching engines are often overwhelmed by micro-bursts—short, intense spikes in order flow generated by advanced high-frequency trading algorithms. Such bursts can temporarily exceed the processing capacity of conventional systems, leading to increased latency, wider bid-ask spreads, and reduced order book depth. Studies have shown that nearly 20% of transactions across major exchanges occur during these micro-bursts, adversely affecting market makers, liquidity providers, and overall market quality (see Aquilina, Matteo; Budish, Eric B.; and O'Neill, Peter, Quantifying the High-Frequency Trading “Arms Race”, July 2021). This problem has been further exacerbated by the advent of sophisticated artificial intelligence-based trading bots and the continued growth of computational resources.

Existing solutions—including intentional speed bumps, periodic batch auctions, randomized order processing delays, and delayed market data dissemination—have been introduced to mitigate the effects of micro-bursts. However, these measures have failed to resolve the underlying throughput limitations of current matching engines. For instance, in 2017, NYSE American implemented a 350-microsecond “speed bump” designed to allow market makers sufficient time to update their quotes before high-frequency trading bots could exploit stale quotes. The measure, however, resulted in wider spreads (+40%), lower trading volume (−8%), and reduced market share, ultimately prompting its removal in 2019.

The typical core matching process is designed to operate in a single-threaded mode for each symbol, ensuring strict enforcement of order time priority. According to Amdahl's law, the portion of work that cannot be parallelized becomes the bottleneck, regardless of how many computational resources are available. Consequently, the overall throughput of the matching engine is ultimately limited by the latency of the core match process, since the core match throughput is essentially the inverse of its processing latency.

The discussion of background systems and publications is provided solely to place embodiments in context. No admission is made that any reference, system, or technique is prior art under any statute or that it forms part of the knowledge of persons of ordinary skill.

### SUMMARY OF THE PROBLEM

The core issue with prior art matching engine technologies is their inability to efficiently scale throughput during periods of extreme order flow. One of the world's largest exchanges—Eurex (Deutsche Börse group)—typically achieves a throughput of about 200,000 orders per second per symbol based on their July 2024 technical publication. During micro-bursts, however, the surge in order volume far exceeds this capacity, leading to severe latency spikes. This limitation forces market makers to adopt more defensive quoting strategies, since they are unable to quickly change the quote due to the overwhelmed matching engine and thus their orders being sniped by “faster” opportunistic high-frequency trading bots, which increases bid-ask spread and ultimately reduces revenue for exchanges.

### SUMMARY OF THE INVENTION

In general terms, the disclosure provides an order-queue storage architecture for electronic order books. The architecture integrates several coordinated technical features which, in combination, overcome throughput and tail-latency limitations of conventional electronic trading systems under extreme order-flow micro-bursts. The architecture may be embodied as computer-executable instructions executed by one or more processors, as hardware circuitry, or as a combination thereof. The features include, without limitation:
(a) slot-based Data Holder Nodes that store entries contiguously in fixed-capacity, memory-aligned arrays, each entry comprising an order object or a reference thereto;
(b) bounded-direction relocation cascades (Push Back and Push Forward) that maintain dense node population while bounding worst-case insertion or prepend cost;
(c) a flexible, depth-aware node-capacity function that is monotone, non-increasing with distance from the book head;
(d) priority indicator abstractions (e.g., bitmasks, encoded index registers, or embedded fields) that encode priority status under a predetermined priority rule and may permit constant-bounded indicator updates;
(e) in software embodiments, core-local, huge-page memory pools for Data Holder Nodes and Price Level Descriptors;
(f) lock-free, cache-aligned queues supporting zero-copy and copy-optimized SIMD block moves;
(g) neighbor-aware balanced-search-tree operations for price level indexing with constant-time splice/graft when in-order neighbors are known, followed by bounded rebalancing;
(h) an optional order-book price-level accelerator (OBA) that realizes the price-level index in reconfigurable or application-specific logic using contiguous descriptor memory and neighbor-aware insertion/deletion pipelines that perform splice and graft updates with a constant-bounded number of reference writes followed by single-path, local-transform rebalancing. The OBA maintains price-level metadata, exposes best-of-book registers for constant-time top-of-book reads, and provides a memory-mapped or message-based host interface; one accelerator instance services one symbol to preserve time priority, and multiple instances may operate in parallel; and
(i) an order-queue storage accelerator circuit that provides memory (e.g., on-chip memory) with contiguously addressable slot regions, indicator storage for priority indicators, and operation logic comprising insertion logic, removal logic, or both, with optional indicator-update logic. The order-queue storage accelerator circuit may operate as a standalone device or communicatively coupled to a host processor, and may be combined with the price-level accelerator on the same device.

Illustrative Performance (non-limiting)—In one measured deployment on a latest generation (2025) AWS bare-metal instance, a single-threaded core matching unit sustained throughput of up to 30 million order messages per second when tested by benchmark data based on SEC-reported market-activity distributions, including bursts exceeding 2 million consecutive messages without inter-message gaps. Latency remained deterministic and sub-microsecond during the harshest micro-burst events. These figures are representative of one configuration and workload; actual performance may vary with implementation and operating conditions.

In one aspect, the system comprises:
(a) in software embodiments, a memory-management subsystem that allocates per-core memory pools on large contiguous pages and pre-constructs Data Holder Nodes and Price Level Descriptors;
(b) an order-book structure in which each node provides fixed-capacity, contiguously addressable slots for up to a predetermined maximum number (C) of order objects, and maintains priority indicators logically associated with slots as described at Chapter II. E.;
(c) wherein each indicator encodes, under the selected priority rule, a priority status of an entry stored in a slot, a priority-predicate state resolvable for slots of the slot region, or an inactive, non-asserted, or sentinel state interpreted under Chapter II. F—for example, under FIFO, an indicator may identify the slot whose entry is the head or tail at a price level, or may carry a sentinel state indicating that no slot satisfies a denoted predicate;
(d) wherein the indicators may be realized, without limitation, as bitmasks with a bit per slot, encoded index registers, slot-indexed flags or references stored in or alongside the node, fields carried in the order objects that occupy the corresponding slots, an occupancy state of a designated slot position, an indicator memory separate from the slot region, or any other data representation or hardware structure satisfying the structural-association requirement set forth at Chapter II. E.;
(e) one or more core-match units that receive incoming orders, execute matches according to a selected policy (e.g., price-time), and update nodes, priority indicators, and Price Level Descriptors;
(f) bounded-direction Push Back/Push Forward cascades that relocate at most a fixed number of orders in one direction to free capacity while preserving priority;
(g) in certain embodiments, the order-book price-level accelerator (OBA) configured to maintain the balanced-search-tree representation of active price levels in descriptor memory and to provide constant-time access to best-bid and best-ask via dedicated extrema registers; and
(h) in certain embodiments, an order-queue storage accelerator circuit comprising memory (e.g., on-chip memory) with contiguously addressable slot regions, indicator storage for priority indicators, and operation logic comprising insertion logic, removal logic, or both, with optional indicator-update logic.

In another aspect, in software embodiments, the transport layer employs lock-free, cache-aligned ring buffers (SPSC, SPMC, MPSC, or MPMC). The layer supports zero-copy placement (e.g., NIC-to-core DMA rings, shared-memory mailboxes, RDMA writes) and copy-optimized payload movement that transfers exactly one cache line per message via vector instructions (e.g., AVX/AVX-512, NEON/SVE), with optional non-temporal stores and NUMA-aware placement. In hardware embodiments, the order-queue storage accelerator circuit may receive operations directly from a network parser pipeline or from a host interface without requiring a software transport layer.

In a further aspect, a balanced search tree (e.g., red-black, AVL, B/B+-tree, or other embedding/quotient-morphism balanced structure) indexes price levels. Each Price Level Descriptor records the price, aggregate quantity, and a reference to the node holding the highest-priority and/or lowest-priority order at that level. When in-order predecessor and successor are known, insertion (splice) and deletion (predecessor or successor graft) proceed in constant time at the identified parent slot, followed by a rebalancing walk bounded to a single root-to-leaf path. In hardware embodiments, the OBA implements this tree logic and fix-up sequencing directly over a contiguous, multi-banked descriptor memory, with predecessor/successor neighbor links and atomic single-word updates of child/parent references, as well as tick-indexed comparators parameterized by base price and tick size; a coherency module optionally arbitrates hazards when limited overlap is allowed. In certain embodiments, the order-queue storage accelerator circuit and the OBA are combined into a single accelerator circuit, with insertion or removal logic supplying in-order neighbor references directly to the price level indexing logic within the same circuit. The observable behavior of the hardware embodiments is functionally equivalent to the software procedures and produces isomorphic trees and top-of-book outcomes for the same event stream.

In certain embodiments, the node-capacity function is learned and adjusted online from live telemetry by a lightweight controller that periodically recomputes an optimal node size per depth (or per node), applies rate-limited updates between batches, and resizes node classes without violating latency bounds; static policies may be substituted where desired.

The disclosed architecture may be realized as: (i) an order-queue storage engine; (ii) a hardware accelerator circuit (including without limitation an order-queue storage accelerator circuit, an order-book price-level accelerator (OBA), or a combined accelerator integrating both); (iii) a non-transitory machine-readable medium storing machine-executable content per Chapter II. L. that, when executed by one or more processors or by hardware circuitry per Chapter II. M., performs one or more of the operations disclosed herein; or (iv) a service per Chapter X. A. made available to one or more clients. The above categories are not mutually exclusive and may be practiced independently, in any combination, or as further species enumerated elsewhere herein. Other realizations within the scope of the disclosure are not foreclosed.

The foregoing is a simplified overview; it is not intended to identify key or essential features of the claimed subject matter, nor to limit the scope of any claims.

### BRIEF DESCRIPTION OF DRAWINGS

The present invention is described in detail through non-limiting examples with reference to the accompanying drawings.

FIG. 1 is a schematic diagram illustrating a general overview of the core matching process.

FIG. 2 is a high-level diagram illustrating Data Holder Nodes, which store entries (each entry comprising an order object or a reference thereto) and Price Level Pointers (pointer-based embodiment), along with the relevant operations performed on them.

FIG. 3 is an illustration showing the alignment of Price Level Descriptors in a tree-like structure.

FIG. 4 is a high-level overview of the specially designed memory pool.

FIG. 5 is a schematic of a conventional computer-memory hierarchy (context diagram).

FIG. 6 is a flowchart outlining the matching process between an incoming order and existing orders in the order book.

FIG. 7 is a flowchart illustrating the process of inserting an incoming order into the order book.

FIG. 8 is a schematic diagram showing the object structure of the order book.

FIG. 9 is an illustration depicting the relationship between orders and Price Level Pointers (pointer-based embodiment) within a Data Holder Node.

FIG. 10 is an illustration of a procedural overview of order execution within a Data Holder Node.

FIG. 11 is an illustration of the Append (after the rule-defined reference) operation within a Data Holder Node.

FIG. 12 is an illustration of the Prepend (before the rule-defined reference) operation within a Data Holder Node.

FIG. 13 is an illustration of the Push Back operation within a Data Holder Node.

FIG. 14 is an illustration of the Push Forward operation within a Data Holder Node.

FIG. 15 is an illustration depicting the relationship between orders and bit-values in a bitmask within a Data Holder Node.

FIG. 16 is an illustration of a procedural overview of order execution with bitmask abstraction.

FIG. 17 is an illustration of the Append (after the rule-defined reference) operation with bitmask abstraction.

FIG. 18 is an illustration of the Prepend (before the rule-defined reference) operation with bitmask abstraction.

FIG. 19 is an illustration of the Push Back operation with bitmask abstraction.

FIG. 20 is an illustration of the Push Forward operation with bitmask abstraction.

FIG. 21 is an illustration of the accelerator top-level block diagram (descriptor memory, pipelines, fix-up sequencer, coherency, host interface).

FIG. 22 is an illustration of the Price Level Record layout.

FIG. 23 is an illustration of the insertion/deletion pipelines.

FIG. 24 is an illustration of the tick-comparator and configuration registers.

FIG. 25 is an illustration of an order-queue storage accelerator circuit showing memory (e.g., on-chip memory), indicator storage, operation logic illustratively depicted as insertion logic, removal logic, or both, with optional indicator-update logic, an optional priority-resolution circuit, an optional free-slot identification circuit, and an optional host interface.

FIG. 26 is an illustration of hardware indicator arrangements: non-limiting examples include Path A, in which priority-resolution circuitry computes priority slot indices from indicator storage and free-slot identification circuitry computes vacant-slot indices from vacancy state; and Path B, in which encoded index registers maintain slot indices persistently, or indicate that no slot satisfies a predicate, and are updated by operation logic performing indicator-update functionality; or other realizations within the priority-indicator genus described in Chapter II. E.

### BEST MODE FOR CARRYING OUT THE INVENTION

The following paragraph provides implementation guidance for software embodiments to disclose the present best mode. The present best mode for implementing this invention in software involves using a low-level language such as C or C++, which allows direct memory control; implementations using managed-memory languages are equally within scope, and when a garbage-collected language is used, disabling or tuning the garbage collector is suggested to prevent interference with latency-critical operations. For optimal data movement in one embodiment, the hardware supports at least 128-bit SIMD instructions, with 256-bit or 512-bit instructions being preferred; implementations using scalar memory-copy paths do not require SIMD support. A major source of processing latency arises from storing each incoming order's unique identifier in a hash map, so matching the hash map implementation to the hardware architecture is suggested; a linear, closed-hashing approach is one such option. Hardware-circuitry embodiments are addressed separately in Chapter IX.

### DETAILED DESCRIPTION

Table of contents.

Chapter I. Overview of the Disclosure.
Chapter II. Terminology Definitions.

| | |
|---|---|
| A. | Reference (genus). |
| B. | Rule-defined reference. |
| C. | Array of slots / slot table; contiguously addressable. |
| D. | Slot payload (object vs. reference). |
| E. | Priority indicator. |
| F. | Inactive / neutral value. |
| G. | Constant-bounded. |
| H. | Page (multi-way tree). |
| I. | Computer. |
| J. | API (application-programming interface). |
| K. | Price Level Descriptor / Price Level Record / Price Level Pointer. |
| L. | Machine-executable content. |
| M. | Hardware circuitry. |
| N. | Adjacency. |
| O. | Logical association and physical association. |
| P. | Predetermined priority rule. |
| Q. | Predetermined number of entries. |
| R. | Structural meaning of logic and circuit terms. |
| S. | Disambiguation. |

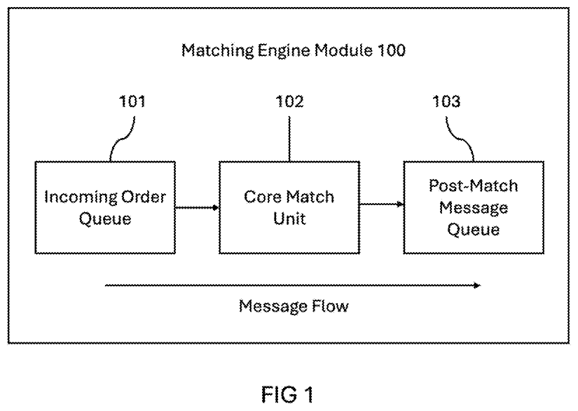

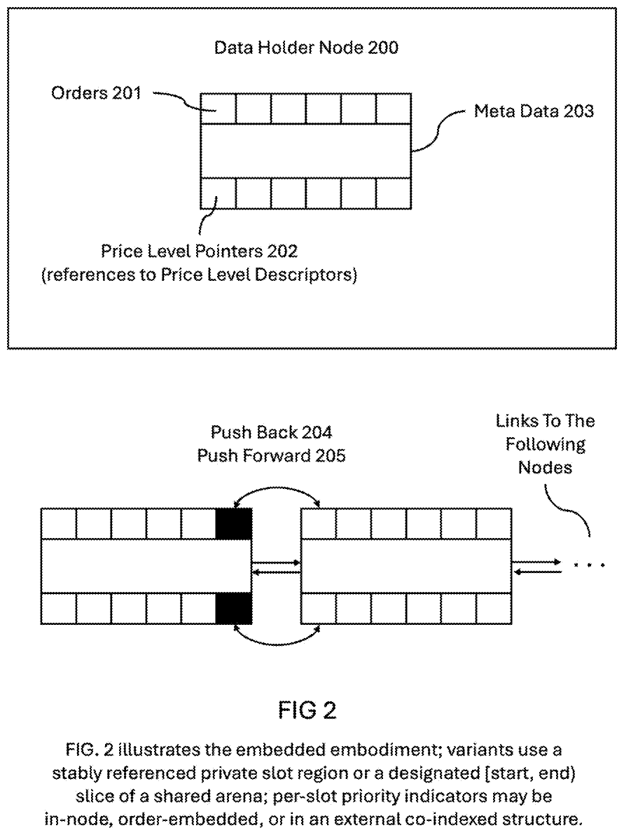

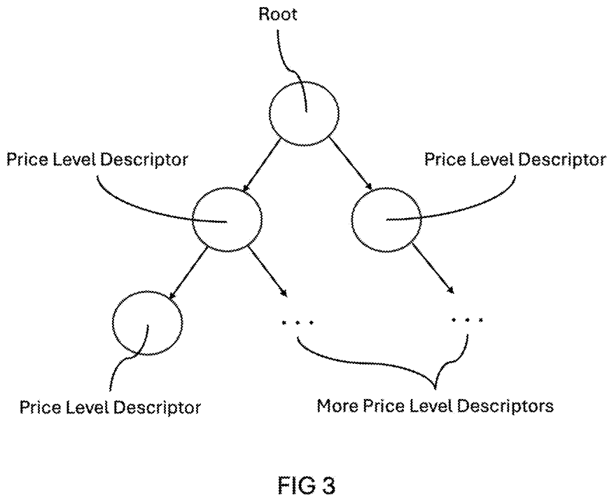

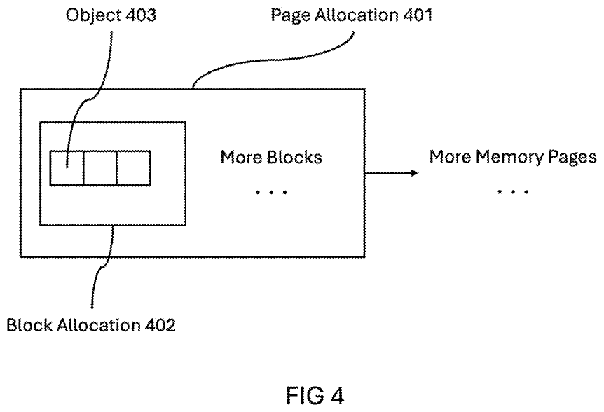

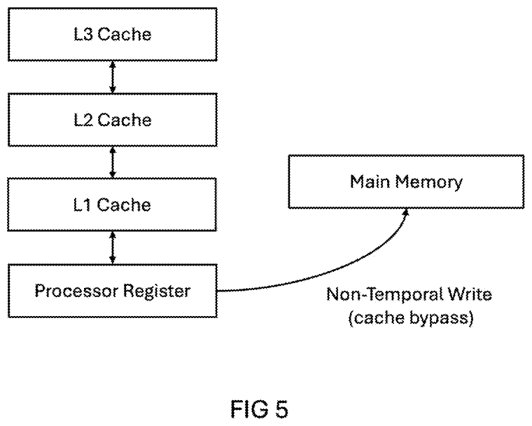

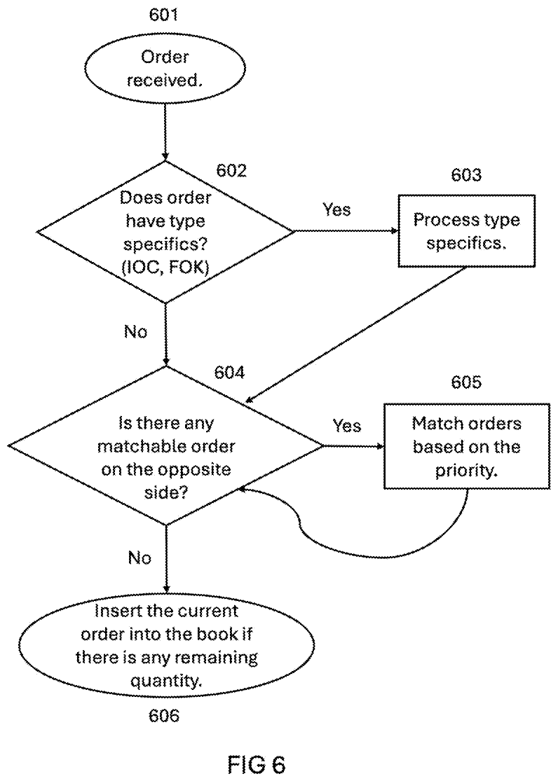

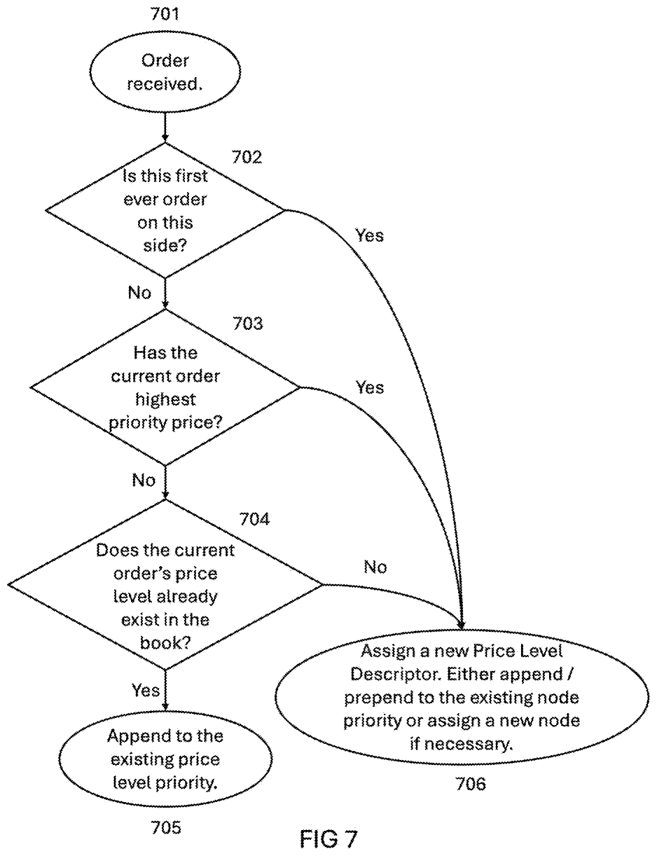

Chapter III. System Architecture (Overview with Figures).

| | |
|---|---|
| A. | Matching-engine modules and flow (FIG. 1, FIG. 6-7). |
| B. | Data Holder Nodes (FIG. 2). |
| C. | Price Level Descriptor (FIG. 3). |
| D. | Memory pools and allocator model (FIG. 4-5). |

Chapter IV. Data Transport.

| | |
|---|---|
| A. | Queue semantics (SPSC/SPMC/MPSC/MPMC; invariants). |
| B. | Zero-copy vs. copy-optimized modes; SIMD_COPY routine. |
| C. | Cache/NUMA policy; non-temporal writes; prefetch patterns. |
| D. | Cache warming / Cache-line alignment / Data correctness. |

Chapter V. Core Operations (policy-agnostic).

| | |
|---|---|
| A. | Append and Prepend (defined against the rule-defined reference). |
| B. | Directed relocation cascades (Push Forward / Push Back); hop bound; exemplary |
| | new-node attach at boundary. |
| C. | Order matching. |
| D. | Order insertion / modification / cancellation / storage of lookup information. |

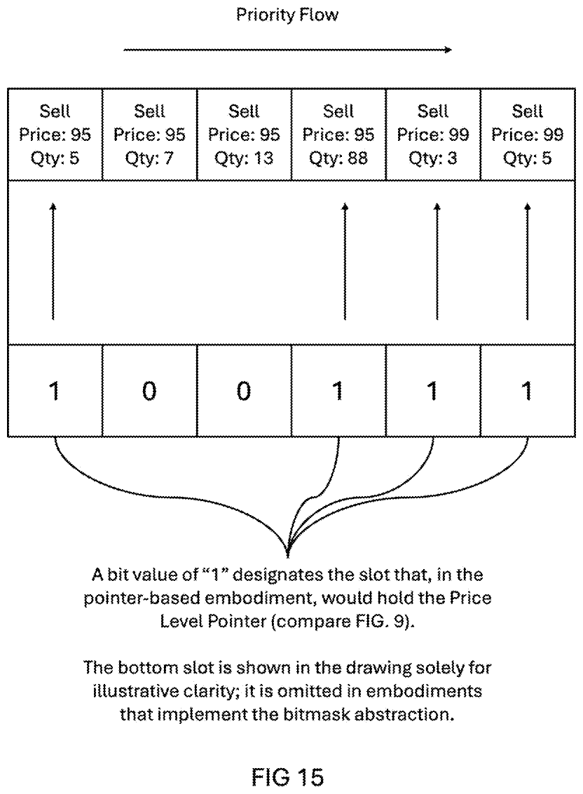

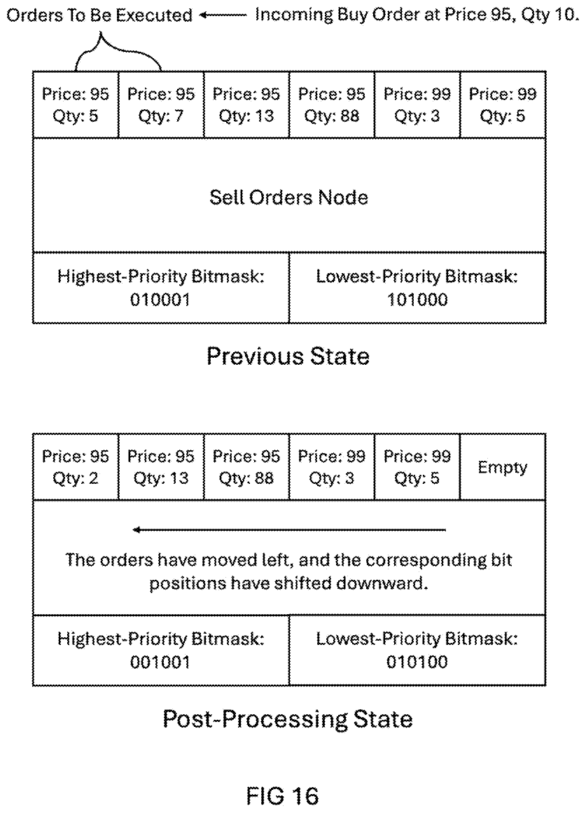

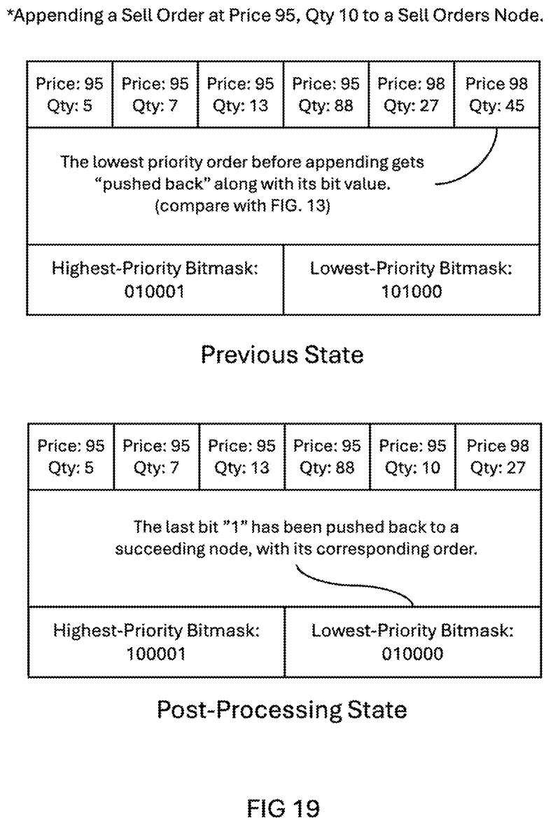

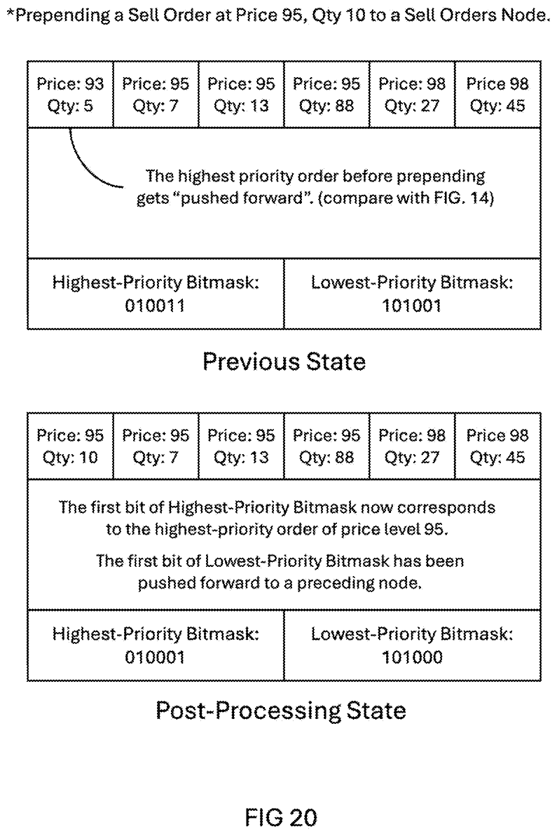

Chapter VI. Core Operations with exemplary bitmask-based embodiment.

| | |
|---|---|
| A. | Introduction. |
| B. | Formal background: word-width model; single-word vs. multi-word; composite |
| | packing (FIG. 15). |
| C. | Update primitives (shift/clear/suffix-shift; XOR↔OR considerations) |
| | (operators table) |
| D. | Order matching; Append paths (simple and general); Prepend paths; branch-free |
| | updates (FIG. 16-18). |
| E. | Cascades (mask shifts and clears; derivative Append/Prepend) (FIG. 19-20). |

Chapter VII. Flexible node capacity.

| | |
|---|---|
| A. | Motivation; depth-aware capacity function. |
| B. | Latency optimization model (hit/miss, per-node cost). |
| C. | Optimal node capacity. |
| D. | Online controller (parameter learning; safety rails; rate limiting). |
| E. | Allocator integration (node-size classes; pool refresh; swap-in/out). |

Chapter VIII. Neighbor-aware insertion/deletion for price levels.

| | |
|---|---|
| A. | Tree model (binary and multi-way; EQ-BST category notion). |
| B. | Neighbor-aware insertion. |
| C. | Neighbor-aware deletion. |
| D. | Variants: red-black, AVL, B/B+-tree, weight-balanced, randomized (expected case). |

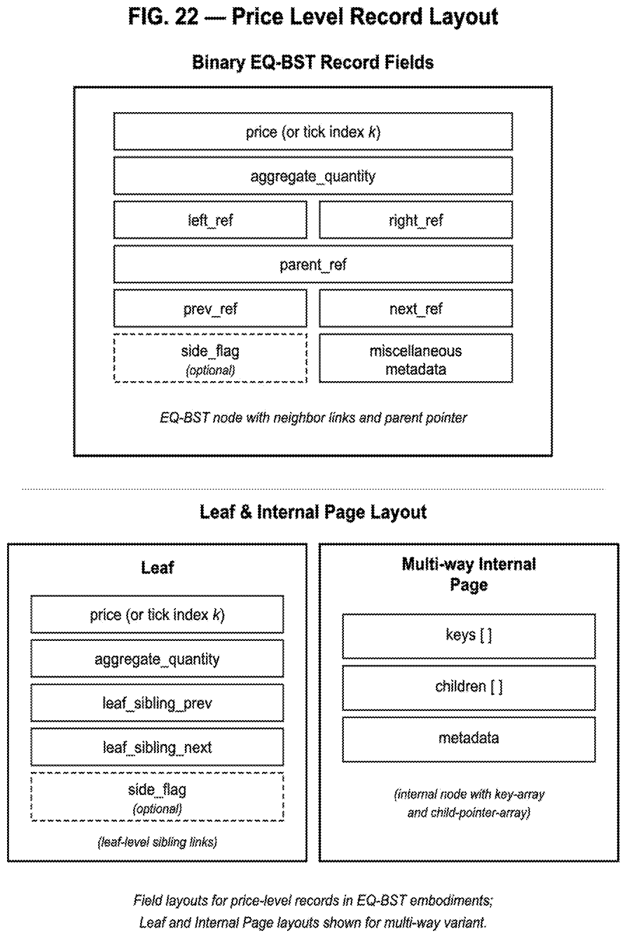

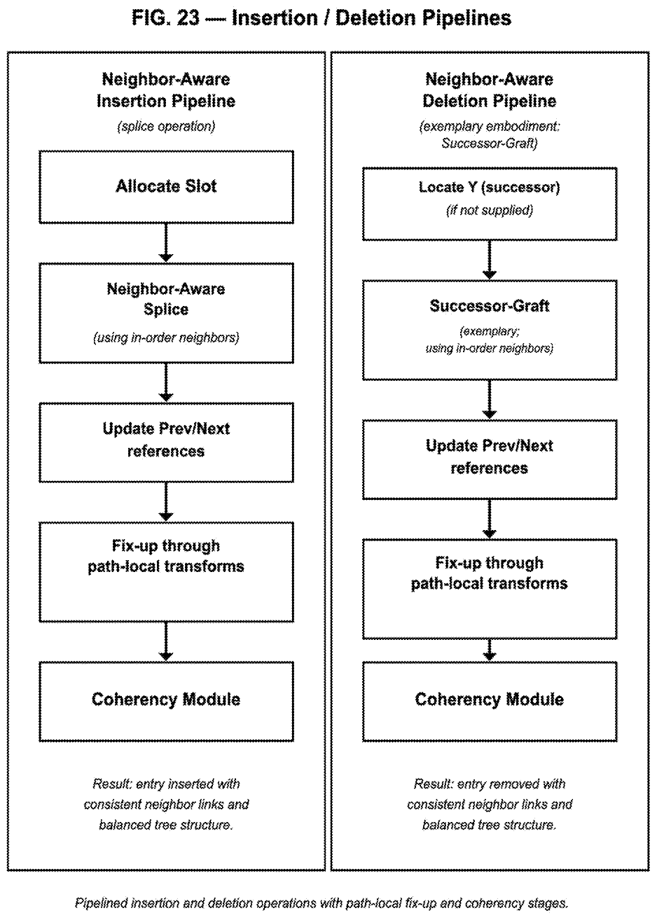

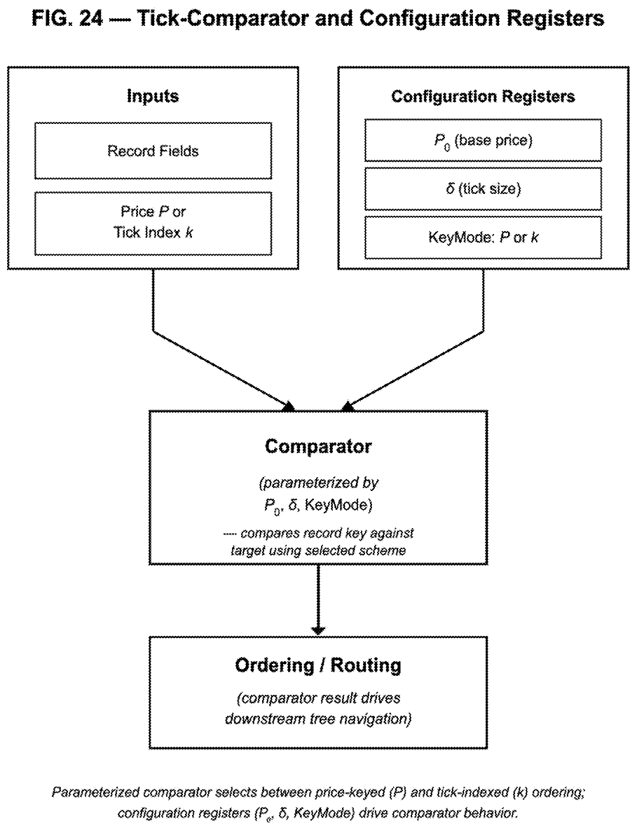

Chapter IX. Hardware accelerator.

| | |
|---|---|
| A. | Hardware accelerator overview. |
| B. | Descriptor memory and banking (FIG. 22). |
| C. | Insertion/deletion pipelines; fix-up micro-sequencer (FIG. 23). |
| D. | Neighbor links; extrema registers & snapshot semantics. |
| E. | Host interface; tick-indexed comparators (FIG. 24). |
| F. | Coherency/hazard handling; atomicity; configuration images. |
| G. | Micro-architectural variants (red-black/AVL/B/B+ selectable). |
| H. | Order-queue storage in hardware circuitry. |

Chapter X. Ordered replicated deployments, including consensus-ledger embodiments.

| | |
|---|---|
| A. | Consensus ledger; roles; replicated deployment; ingestion. |
| B. | Deterministic application to slot regions and indicators; convergence. |
| C. | Bounded directed relocation in ordered replicated deployments. |
| D. | Finality, reorganization, verification, and sharding. |

Chapter XI. Appendices (illustrative, non-limiting)

| | |
|---|---|
| A. | Appendix A: Bitmask algebra/proofs (word-width model; operators; invariants). |
| B. | Appendix B: Cascade termination. |

### Chapter I.—Overview of the Disclosure

The disclosure includes, without limitation, the following aspects, which may be practiced independently or in any combination, and other aspects within the scope of the disclosure are not foreclosed: (1) a matching engine with contiguous-memory Data Holder Nodes, priority indicators, directed relocation cascades, and lock-free data transport; (2) depth-aware flexible node capacity; (3) neighbor-aware insertion and deletion of price levels in balanced search trees; (4) a hardware price-level accelerator with multi-banked descriptor memory, insertion/deletion pipelines, and a fix-up micro-sequencer; (5) an order-queue storage accelerator circuit with memory (e.g., on-chip memory), indicator storage, and operation logic comprising insertion logic, removal logic, or both, with optional indicator-update logic; and (6) an order-queue storage engine with contiguously addressable slot regions providing sequential memory access and priority determination without a book-wide search in order entries, including ordered replicated deployments (consensus-ledger embodiments and other event-order sources per Chapter X. A.).

The detailed description is organized into terminology (Chapter II), system architecture (Chapter III), data transport (Chapter IV), core operations (Chapters V-VI), flexible node capacity (Chapter VII), neighbor-aware tree operations (Chapter VIII), hardware accelerator (Chapter IX), ordered replicated deployments, including consensus-ledger embodiments (Chapter X), and appendices (Chapter XI). Capitalized terms have the meanings assigned in Chapter II unless otherwise indicated.

### Chapter II.—Terminology Definitions

### Chapter II. A.—Reference (Genus).

For clarity, throughout this specification and the claims, the term “reference” is used in a genus sense and expressly includes a pointer; a pointer is one non-limiting species of a “reference.” Non-limiting examples of a “reference” include a handle, index, offset, identifier, tuple (e.g., {node-id, slot-id}), or any other datum sufficient to locate or retrieve the addressed object. As used herein, a Price Level Pointer is a reference to the Price Level Descriptor for a level.

### Chapter II. B.—Rule-Defined Reference.

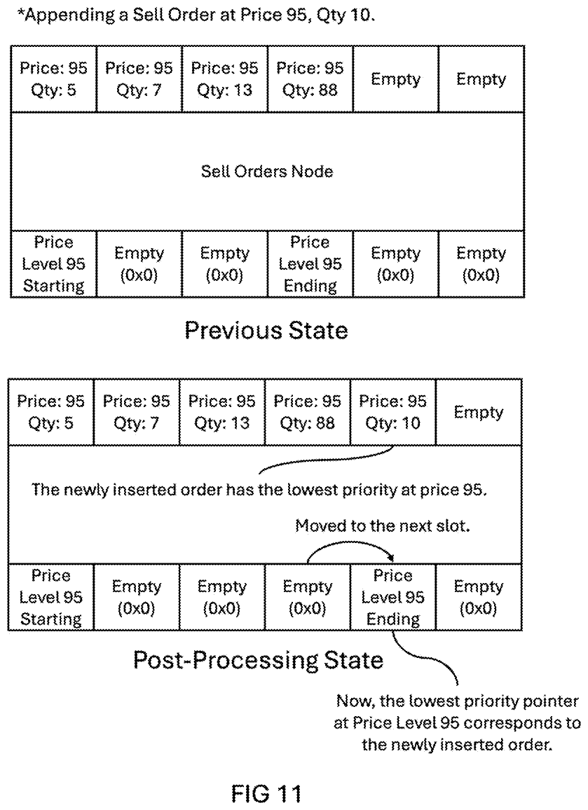

As used herein, rule-defined reference means the policy-selected anchor at a price level that determines where an insertion is placed under the currently selected priority rule (see Chapter V. C-D.). Non-limiting examples include: under FIFO/price-time, the starting (head) and ending (tail) references of the level; under a policy with tiered or cohort-based precedence, the anchor may be the start or end of the active cohort. Append places an order immediately after the appropriate rule-defined reference; Prepend places an order immediately before it. This terminology generalizes the starting/ending pointers and bitmask heads/tails illustrated in FIGS. 11-12 and FIGS. 17-18. For avoidance of doubt, these base Append/Prepend placements are distinct from Append/Prepend invoked as derivative steps within a Push Forward or Push Back cascade; in the cascade path the rule-defined reference may differ from the price-level start/head or end/tail designations (e.g., a vacated or shifted slot selected by the cascade).

### Non-FIFO Examples of “Rule-Defined Reference” (Illustrative, Non-Limiting).

(a) Size-time (tiered size cohorts).
   Some exchanges prioritize orders by size tier first (larger sizes ahead of smaller), then by time inside the tier. At each price level π, define the active cohort C(π) as the currently highest-precedence size tier that has at least one resting order. The rule-defined reference is the tail of C(π) for Append, and the head of C(π) for Prepend when policy authorizes “jump-to-front” within the cohort. Orders joining a lower tier are anchored after the cohort tail of their own tier; orders joining a higher tier create or expand a new active cohort, and Prepend places them before that cohort's head when authorized. This leaves other tiers intact and may preserve constant-bounded priority indicator updates.
(b) Pro-rata with execution epochs.
   Under pro-rata, fills are allocated across all resting orders at a price level in proportion to size; time is a tie-breaker only when required. To avoid mid-allocation re-ranking, define an epoch barrier E(π) at each price level π. Orders at or to the “left” of E(π) are eligible in the current allocation epoch; new orders Append after E(π) so they participate starting with the next epoch. When the engine rolls the epoch (e.g., after an execution round or timer), E(π) advances to the current tail. Thus, the rule-defined reference under pro-rata is E(π), not FIFO head/tail, and updates may remain constant-bounded (see mask variants below).
(c) Attribute buckets (displayed/non-displayed; parity/lot buckets).
   In rules that prioritize displayed over non-displayed liquidity, or that split the level into parity/lot-size buckets (e.g., round-lot vs. odd-lot), the level is partitioned into named buckets B₁, B₂, . . . of decreasing precedence. For a join into bucket Bⱼ, the rule-defined reference is that bucket's tail for Append (or the bucket's head for an authorized Prepend). Buckets are independent; entering one bucket does not move anchors of another, and cascade steps continue to be bounded and directional.
(d) Tiered maker-taker or fee/priority ladders.
   If a venue prioritizes tiers (e.g., platinum→gold→standard), a tier index and tier-head mask identify the first slot of each tier at the level. The rule-defined reference is the current tier's anchor; orders move only within their tier unless a policy-authorized tier change occurs (which clears one head bit and sets another).
(e) Time-windowed (micro-batch) arrival.
   With windowed acceptance, orders sharing a window get equal “time” and the level maintains a window anchor W(π) (head/tail of the current window set). Append goes after W(π); when the window closes, W(π) is retired and a new window anchor starts at the then-tail. This is analogous to the epoch barrier in (b), but its cadence is ingress-window rather than allocation-epoch.

### Representation and Update Bounds of “Rule-Defined Reference.”

These anchors may be realized in any of the structural-association forms set forth at Chapter II. E., Feature (a) (and including the representation-neutrality clause thereof). Indicator updates for insert, delete, or relocate may remain constant-bounded per node, and the structural association between priority indicators and their corresponding slots set forth at Chapter II. E. is preserved. Figures for pointer- and bitmask-based embodiments (e.g., Append/Prepend and Push Forward/Back) illustrate these behaviors.

Chapter II. C.—Array of slots/slot table; contiguously addressable.

As used herein, array of slots (or slot table) denotes:
(a) a single contiguous array;
(b) two or more back-to-back sub-arrays; or
(c) a designated contiguous section of a shared slot arena.

In all cases, the array(s) or designated section are either physically embedded in the Data Holder Node's contiguous region or stably referenced by the node (see Chapter II. A.—Reference) to an equivalently contiguous slot region whose effective base address (or base offset into the arena) and per-slot stride remain invariant during normal operation, wherein normal operation comprises insert, delete, modify, in-node realignment, and directed relocation cascades and excludes allocation, deallocation, and resizing of the slot region. The arrays (or designated section) collectively define one logical index space with a predetermined maximum slot capacity C (i.e., the fixed cardinality of the node's slot index space) for the node's order objects. A variable-sized realization whose runtime size satisfies 0≤size≤C also qualifies as an “array of slots,” provided that growth within C does not relocate or reallocate the underlying storage. Each slot's payload may be either an order object or a reference to an order object, and both forms preserve the same base/stride addressing and single logical index space described herein. Accordingly, contiguously addressable covers slots whose payloads are references as well as slots whose payloads are objects.

### Segmented Logical Index Space.

In some embodiments, the contiguously addressable slot region is presented as a single logical index space spanning multiple embedded contiguous arrays (“segments”). Let segment(i) map a global slot index i to a segment identifier s and a per-segment offset off=i−start_index(s). Let base[s] be the base address of segment s and let stride be a constant element size common to all segments. The effective address for slot i is computed as:

$$addr ( i ) = base [ segment ( i ) ] + off * stride$$

During normal operation, each base[s] is invariant for its segment and stride is invariant across all segments. This realizes a contiguously addressable (logically contiguous) slot region over physically discontiguous arrays.

### The Meaning of “Contiguously Addressable.”

Contiguously addressable means that consecutive slot indices map to fixed-offset locations (e.g., base+i·stride), even when the next index lands in the first element of a subsequent sub-array or when, in the shared-arena case, the index wraps from the section's end back to its start (ring semantics) or advances to the first element of the next designated section.

### Non-Exhaustive, Non-Limiting C++ Examples:

(a) one or more std::array<T> whose capacity is collectively C, and embedded into the node.
(b) an std::vector<T> whose capacity C is established for the node (e.g., via reserve(C) or an allocator policy that prohibits relocation) and whose size grows and shrinks within C—without reallocation that changes the base—qualifies as an array of slots; increasing size up to C (e.g., push_back, resize(n) with n; C) is permitted, whereas any operation that increases capacity beyond C or would relocate the storage is outside this example.
(c) a single monolithic std::vector<T> (shared arena) that is not reallocated after initialization, where each node stores start and end indices delimiting its designated contiguous section; for that node, C=(end−start) and all indexing and ring behavior occur relative to that section; operations that grow the node's size within C are permitted so long as the arena itself is not reallocated.

### Sequential Memory Access.

Sequential memory access, as used herein, refers to access patterns that operate on physically proximate storage locations. A slot region is structurally configured to provide sequential memory access when it is organized as a storage unit in which multiple slots are arranged to enable such access. For example, a node having a slot region with capacity greater than one—in which two or more slots are organized as part of a single storage unit configured for physically proximate access—structurally provides sequential memory access, regardless of the specific runtime memory arrangement produced by any particular implementation. However, mere logical adjacency created only by traversing stored inter-entry or inter-node links, without an independently slot-index-resolvable slot region whose slot addresses are determined by a bounded deterministic address-generation function over stable base information, does not by itself provide sequential memory access.

### Further Clarification Regarding Sequential Memory Access.

The presence of auxiliary links, handles, references, or traversal metadata does not disqualify an otherwise qualifying contiguously addressable slot region, provided that the slot addresses used for the sequential-memory-access property are resolvable by slot index without reading such links, handles, references, or traversal metadata as the address-generation mechanism. A contiguously addressable slot region providing sequential memory access refers to the architectural property of the region that provides such access, and does not preclude random memory access to the same region. Banked, interleaved, vectorized, SIMD-lane-distributed, column-oriented (including struct-of-arrays), tiled, page-tiled, segment-striped, NUMA-partitioned, channel-partitioned, rank-interleaved, or other multi-span layouts likewise does not disqualify an otherwise qualifying contiguously addressable slot region for purposes of this Chapter where slot-index resolution to address occurs by a bounded deterministic address-generation function, including without limitation a constant-stride function, a bounded-bank-interleave function, a bounded-segment-selection function, or a per-component or per-segment stride function, applied to stable base information for the slot region, and without reading a stored inter-entry pointer or reference as the address-generation mechanism for the next slot address.

### Sequential Memory Access in Shared Arena.

Where a node's contiguously addressable slot region is realized as a contiguous subrange of a shared arena—delimited by stable low and high indices (or equivalently low and high addresses) into the arena that remain valid for the lifetime of that node, and where the arena is not reallocated in a manner that relocates that subrange—the region structurally provides sequential memory access in the sense described above in this chapter, notwithstanding that the arena is shared across multiple nodes and even if each node has a single slot capacity. This is because, under shared-arena realizations, the multi-slot “storage unit” referred to in the foregoing definition may be regarded as the underlying arena, such that a single-slot subrange within a multi-slot arena qualifies as a slot region organized as a storage unit in which multiple slots are arranged. Capacity overflow handling of the kind described in Chapter V.B. operates on such a region without altering this property: overflow handling that yields a slot by relocating entries across existing nodes preserves each node's subrange unchanged, and overflow handling that allocates an additional node may realize the additional node's slot region as a further contiguous subrange of the same arena, as a contiguous subrange of a further arena, or as a separately allocated contiguous region, in each case without disturbing the subranges of existing nodes.

### Requirement for Multi-Slot Region.

For the avoidance of doubt, the “two or more slots organized as part of a single storage unit configured for physically proximate access” criterion is satisfied by any slot region with capacity equal to or larger than 2, regardless of the manner of formation of the arena that allocates such storage units.

### Requirement for Single-Slot Subrange of Shared Arena.

Notwithstanding any broader reading of the foregoing “Sequential memory access in shared arena” provision, where a node's slot region has a slot count of one (i.e., a single-slot subrange of a shared arena, including without limitation an implementation in which a plurality of size-one nodes collectively store entries at a price level or other ordering bin), the single slot qualifies as a “contiguously addressable slot region providing sequential memory access” only by virtue of its membership in a shared arena or arena block satisfying the following requirements:
(a) the shared arena or arena block provides a plurality of fixed-stride slot positions with stable base/stride addressing;
(b) the single-slot node is assigned a stable slot position and stable low/high boundaries within the shared arena or arena block during the node's lifetime; and
(c) the single-slot subrange remains under a stable order-entry or order-reference slot schema throughout the lifetime of the single-slot node, including while the slot contains a neutral, empty, reserved, default, or uninitialized representation of the order entry or order reference for that slot, such that the slot payload is not used as the operative storage for state whose structural role is unrelated to representing that order entry or order reference for the slot, including without limitation allocator bookkeeping, allocator free-list links, or pool-management metadata.

Block-wise or arena-wise metadata may be maintained separately from the slot payloads, including metadata identifying free slot positions, occupancy, allocation state, node ownership, generation counters, bounds, or other management information for the arena or block, provided that such metadata does not retype or repurpose the slot payload of a single-slot node away from the order-entry or order-reference slot schema. Such metadata may reside within the same arena block as the slot region, with the slot region accessed at a fixed offset from the arena block base, provided that the slot region remains dedicated exclusively to slot storage as set forth above.

### Preferred-Embodiment Disclosure.

In latency-critical software embodiments, the arena or arena block may be page-aligned and contained within a single hardware-supported translation page, including a huge page, or within an equivalent physically contiguous hardware memory region. Such page-alignment and page-containment cause sequential traversal of the arena block to remain within a single virtual-to-physical translation entry, including a huge-page translation entry when huge-page backing is used. On processors whose hardware prefetchers are constrained by page boundaries, this layout avoids page-boundary transitions within the arena block that may otherwise stop or restart hardware-prefetch streams or require additional address-translation activity, thereby improving the predictability of sequential access for latency-critical order-entry storage.

Chapter II. D.—Slot Payload (Object Vs. Reference).

Unless stated otherwise, writing an order into a slot means writing either the order object itself or a reference (genus term) sufficient to locate or retrieve that order. A slot payload therefore denotes an element of the node's contiguously addressable slot region whose value is either an order object or a reference thereto. This construction rule applies throughout the specification and claims. For reference-payload slots, non-occupancy is encoded by a reserved reference value (e.g., null, zero, an empty handle, a designated sentinel, or another representation designated by the engine as not locating a valid order entry). This slot-payload occupancy encoding is distinct from, but may be maintained coherently with, any neutral priority-indicator state under Chapter II. F.

### “Order Object” as a Genus Term.

As used herein, “order object” is a genus term denoting any data representation of an order encoding attributes sufficient for matching operations, including without limitation those described in this specification, and is not limited to object-oriented-programming constructs. Non-limiting exemplary realizations of an order object include: (i) an instance of a class, struct, or record in a software embodiment, with fields representing order attributes; (ii) a fixed-width or variable-width bit-field representation in a hardware-circuitry embodiment, wherein order attributes are encoded as designated bit ranges within the slot payload; (iii) a register-based representation in which order attributes are stored in one or more hardware registers associated with the slot; (iv) a row in a columnar or tabular storage layout, wherein order attributes are stored across multiple arrays indexed by slot index; or (v) any combination of the foregoing or other data representations, whether in software, hardware circuitry, or a combination thereof, that encode the attributes sufficient for matching operations.

### Chapter II. E.—Priority Indicators.

### Definition.

As used herein, a “priority indicator” is a datum or structural state (e.g., the absence or the existence of the indicator, or other structurally associated information) maintained in logical association with slots of a node's contiguously addressable slot region, the datum or structural state encoding—under an encoding rule defined by the active predetermined priority rule—a priority status of an entry stored in a slot, a priority-predicate state associated with one or more slots, or an inactive, neutral, non-asserted, default, absent, or sentinel state interpreted according to Chapter II. F. The term “priority indicator” is used in this disclosure as a genus term, encompassing—without limitation—a stored value, an occupancy state under a positional rule, a register whose structural identity is a priority predicate, or a combination of the foregoing.

### Common Structural Features of the Priority Indicator Genus.

The priority indicator embodiments described herein share the following common structural features that define the genus. All embodiments must have the following features (a)-(c) to qualify as the “priority indicator” in the meaning of this chapter:
(a) Be structurally associated with slots of the contiguously addressable slot region;
(b) Have an encoding rule from which a priority status of a slot can be unambiguously inferred; and
(c) Provide for maintenance of coherent state of the indicator.

### Feature (a): Structural Association.

A structural association between a priority indicator and slots of a contiguously addressable slot region is required. Such structural association is realized by one or more of, or any combination of:
(a) slot-index addressing into a slot-indexed storage (e.g., a bitmask with one bit per slot, including separate head and tail masks or a composite word, or an array with one or more flags or small fields per slot);
(b) physical co-location of the priority indicator with the slot (e.g., an order-embedded field carried by the order object occupying the slot or referenced by the slot, the field serving as the indicator for that slot);
(c) a register or field whose structural identity is a priority predicate under the active predetermined priority rule, and whose value directly or deterministically identifies a slot satisfying that predicate, or indicates that no slot satisfies that predicate, such that each slot's priority status for the predicate is resolvable by comparison of the slot's index to that value or via the priority predicate's own structural identity (e.g., a head or tail pointer register whose value is a memory address of the satisfying slot, or a sentinel value indicating that no slot satisfies the predicate);
(d) an occupancy state of a designated slot position whose structural identity is a priority predicate defined by an active predetermined priority rule, such that occupancy of the designated slot position encodes a priority status (e.g., compacted-leftmost arrangements or shift-register realizations, as further described below);
(e) an indicator memory or co-indexed structure that is separate from the storage of any slot of the contiguously addressable slot region, whose entries are addressed by slot index and whose entry for a specific slot of the contiguously addressable slot region encodes the priority status of said specific slot (e.g., an array of references stored in a per-node structure addressed by slot index, or a presence-bitmask equivalent of such references); or
(f) any other data representation or hardware structure that satisfies the foregoing structural-association requirement and the other common structural features set forth in this chapter.

### Representation-Neutrality of the Priority Indicator Genus.

The priority indicator is representation-neutral as to data form, word size, and storage medium; any of the foregoing realizations, or any combination thereof, satisfies this feature. As used herein, “structural association” admits physical realizations (e.g., physical co-location of the indicator with the slot per Feature (a), bullet (b) above, or an occupancy state of a designated slot position per Feature (a), bullet (d) above), logical realizations (e.g., a register or field whose structural identity is a priority predicate per Feature (a), bullet (c) above, or correspondence by slot index between separate storage regions per Feature (a), bullet (e) above), hybrid realizations combining physical and logical structural elements (e.g., slot-index addressing into slot-indexed storage per Feature (a), bullet (a) above), or any combination thereof; the relationship between physical association, logical association, and structural association is further described in Chapter II. O.

### Feature (b): Unambiguous Inference of Priority Status.

An indicator's encoding rule must enable a person of ordinary skill in the art to unambiguously infer a priority status from the value or structural state of the indicator, where “structural state” encompasses the absence, existence, or other structurally associated information of the indicator, alone or in combination with other information such as the order's price level. By “unambiguously inferable,” the value or structural state of the indicator, alone or in combination as described above, must produce a deterministic sign for the priority status or priority predicate denoted by the indicator, including any sentinel state indicating that no slot satisfies a denoted predicate, under the active predetermined priority rule. The deterministic-sign requirement set forth in this Feature may be satisfied by the value or structural state of a single indicator, or, where the predetermined priority rule defines multiple priority predicates, by the collective value or structural state of multiple indicators associated with a contiguously addressable slot region, each indicator denoting a priority status with respect to a respective priority predicate.

### Feature (c): Maintainability of the Indicator.

A priority indicator must be maintained such that the priority status of each slot that contains an entry, including any non-asserted status for a predicate denoted by the indicator, as interpreted under the indicator scheme via the encoding rule defined by the active predetermined priority rule, remains logically coherent with the slot's actual priority status under the rule upon completion of each operation. Representation-preserving re-encoding, sparse materialization or elision, migration between physical encodings, canonicalization, or other implementation transformations that do not alter the interpreted priority status of any slot under the active predetermined priority rule are not deemed changes to the indicator for purposes of this Feature. Transient indicator incoherence internal to coherency or hazard-resolution logic of an accelerator circuit (Chapter IX. H.; see also Chapter IX. F.) or to replicated-state convergence in an ordered replicated deployment (Chapter X.) is not deemed a violation of this Feature, provided that the interpreted priority status is restored to logical coherence with the slot's actual priority status under the rule before the earlier of: (i) the affected operation or event subject to the event order per Chapter X. A. being treated as finally applied to the relevant engine instance's externally observable state; and (ii) exposure of the incoherent state to an external observer or to a subsequent operation that relies on the indicator state. For example, this Feature is not satisfied by an indicator scheme in which an operation having one slot as its structural target leaves the interpreted priority status of a different slot incoherent with that different slot's actual priority status under the active predetermined priority rule, where that different slot is not itself a structural target of the operation.

### Further Clarifying Information.

Embodiments with Multiple Priority-Related Representations.

Where an embodiment maintains multiple representations of priority-related state, including without limitation dense masks, sparse encodings, encoded registers, designated-position states, caches, snapshots, summary layers, or derived copies, any representation used by the engine for insertion, removal, priority resolution, free-slot identification, indicator coherency, or externally visible priority-status reporting is an operative priority-indicator representation to the extent it denotes priority status or a state interpreted under Chapter II. F. under the active predetermined priority rule. Each operative priority-indicator representation must satisfy the common structural features of the priority-indicator genus at the point of use or external visibility. A derived copy or summary layer that is not used to denote priority status under the active predetermined priority rule does not substitute for an operative priority-indicator representation.

Meaning of “in Combination with Other Information” in Unambiguous Inference.

As used in this chapter, “in combination with other information” permits inference based on the indicator's value or structural state taken alone, in combination with other priority indicators within the same node, in combination with information obtained through examination of entries stored in slots within a constant-bounded physical or logical slot distance, or in combination with the value of a register or field whose structural identity is a priority predicate. However, examination of order entries across the entire order book to derive an entry's priority status is not permitted under this provision, because such examination would defeat the structural function of the priority indicator (i.e., enabling inference of priority status without a book-wide search of order entries). For the avoidance of doubt, the constant-bounded distance set forth above includes without limitation up to the node's predetermined number of entries within the node where the indicator resides, provided that the number of examined slots remains bounded by a constant that does not grow with order book size or dynamic state.

### Meaning of “Priority Indicator Value of a Slot” as Used in Feature (b).

For the avoidance of doubt, the “priority indicator value of a slot” as used in this Feature (b) refers, for an indicator structurally associated with that slot under Feature (a) by way of slot-index addressing, physical co-location, occupancy of a designated slot position, or indicator memory addressed by slot index, to the value or structural state of that indicator; and, for a register or field whose structural identity is a priority predicate per bullet (c) of Feature (a), to the value indicating whether the slot satisfies said priority predicate, as directly resolvable by comparison of the slot's index to the value of the register or field.

### Meaning of “Slot Index.”

For clarity, references as used herein and in the claims to a “slot index” encompass any equivalent slot-identifying value within the contiguously addressable slot region, including without limitation a memory address, an offset relative to a base address of the slot region, a pointer to a slot, a content-addressable slot-location key, a hash-derived slot identifier that uniquely identifies the slot after any collision-resolution scheme, a tuple-based slot identifier (such as a {base-address, offset} or {segment-id, offset} tuple), a computed slot identifier derivable from a stored value by an engine-defined transformation, a handle, an opaque token, or any other identifier that uniquely identifies a slot of the contiguously addressable slot region. This paragraph operates as a coordinate-space broadening for slot-region addressing only and does not affect the comparison-input exclusion set forth elsewhere in this specification.

### Meaning of “Slot Index” in Order-Queue Storage Context.

As used herein “a slot” within the order-queue storage context is a slot that stores an order object or a reference thereto per Chapter II.D; accordingly, neither a tree key, a sortable key, an ordering key, nor any other input that requires a comparison to identify the slot within the meaning of Chapter II.E qualifies as a slot index for purposes of order-queue storage or the related claims. A slot index for purposes of order-queue storage further encompasses any deterministically decodable encoding of any of the foregoing, where the encoded value is decoded by a function whose sole inputs are the encoded value and optionally one or more decode parameters fixed at allocation and configuration time, and where the decoding function does not read or otherwise depend on the contents of any slot of the contiguously addressable slot region.

### Priority Predicate.

As used herein, “priority predicate” means a boolean-valued condition, defined by the predetermined priority rule, identifying a specific position or classification within the priority sequence. Non-limiting examples of priority predicates under FIFO/price-time are “is the head of the level,” identifying the highest-priority entry, and “is the tail of the level,” identifying the lowest-priority entry. Non-limiting examples under non-FIFO priority rules are “is the rule-defined reference of the active cohort,” “is the head of a particular tier,” or any other position or classification identifiable by a boolean condition over the entries. A priority rule may define one or more priority predicates, and the priority statuses under the rule comprise the classifications induced by the rule's predicates over the entries—for example, a tail-only rule (defining only a “tail” predicate) yields priority statuses of “tail” and “non-tail” (the “non-tail” classification encompassing slots whose stored entries do not satisfy the tail predicate); a head-and-tail FIFO rule (defining “head” and “tail” predicates) yields priority statuses of “head”, “tail”, and “neither” (the “neither” classification encompassing slots whose stored entries satisfy no defined predicate); and a custom rule may define a single predicate, multiple predicates, or any other rule-defined predicate set, with corresponding priority statuses; the number of predicates is independent of the number of slots. Without limiting the foregoing, where a priority rule defines a categorical or finite-valued classifier directly producing a priority-status label, the boolean condition that the classifier has a particular value constitutes a corresponding priority predicate within the meaning of this paragraph.

### Meaning of “Priority Status.”

As used herein and in the claims, “priority status” of an entry denotes the entry's position or classification within a priority sequence defined by an active predetermined priority rule, the position or classification representing a predicate or classifier output produced by applying the rule to the entry. Priority status may be represented in any form that, alone or in combination with other information permitted under the unambiguous-inference framework of Feature (b) above, enables a person of ordinary skill in the art to unambiguously infer the entry's priority status under the active predetermined priority rule—including without limitation as a categorical classification, a flag, a boolean indicator, an ordered tuple of such values, a predicate-satisfaction state, or any other form satisfying the unambiguous-inference requirement set forth in Feature (b) above. A value that merely serves as a comparison input for deriving priority status, including without limitation a timestamp, sequence number, price key, tree key, sortable key, or other field requiring comparison across a non-constant-bounded number of order entries, is not itself a priority status merely because it is stored with or associated with an entry.

### Meaning of “Rank.”

As used in this chapter, the rank is the minimum categorical classification of orders required for matching orders under a predetermined priority rule. The representation of rank need not be exact ordinal position in the book's complete priority order; categorical classification (for example, head, middle, or tail of the time-ordered sequence at a price level, or cohort, bucket, or tier membership under non-FIFO policies) combined with an applicable higher-level ordering (such as price level ordering) suffices to represent an entry's rank within the meaning of this definition. The term “rank” as used in this Chapter and in references to priority status throughout this specification refers to the priority rank as defined in this paragraph and operates independently of the term “rank” as used in references to mathematical operators, linear endomorphisms, well-founded ranking functions in cascade-termination arguments, or global/ordinal indices in mathematical derivations elsewhere in this specification.

### Meaning of “a Priority Status of a Slot.”

As used herein and in the claims, “a priority status of a slot” denotes the priority status of the order entry stored in that slot under the active predetermined priority rule, where “order entry” refers to the order object or reference thereto per Chapter II. D. Where the slot is unoccupied, no priority status is asserted for that slot; a priority indicator may represent that condition under the inactive/neutral-value semantics of Chapter II.F. Transient or in-flight states permitted under Feature (c) (e.g., transient incoherence in coherency or hazard-resolution logic of an accelerator circuit per Chapter IX. H., or replicated-state convergence per Chapter X.) are not deemed violations of this paragraph.

### Determination of “Priority Status.”

The foregoing definition of rank governs whether a candidate datum or structural state qualifies as a “priority status” denoted by a priority indicator within the meaning of Chapter II. E. For example, a cardinal value lacking intrinsic priority encoding, such as an order-submission timestamp embedded in the order object, may resemble a priority indicator, but the timestamp's value alone does not produce a deterministic sign for any priority status—making that determination requires comparing the timestamp against those of every other entry in the order queue. Such comparison across all entries in the queue fails Feature (b)'s unambiguous-inference requirement, because it constitutes a book-wide examination of order entries excluded under the “Meaning of in combination with other information” paragraph above. The same observation applies to other indicative information whose values must be compared across a non-constant-bounded number of order entries to derive rank, including without limitation per-order sequence numbers, per-order priority scores, and other numeric fields whose values function as comparison inputs rather than as encodings of priority status under an active predetermined priority rule.

### Meaning of “Structural Target.”

As used in this chapter, whether a slot is a “structural target” of an operation is determined at the slot's entry level, by reference to whether the operation causes a change to the entry stored in, written to, removed from, or relocated to or from that slot, or to that entry's actual priority status or position within the slot region. A slot is a structural target if the operation changes the entry's presence, identity, actual priority status under the active predetermined priority rule, position within the slot region, or matching-relevant order property. Operations that may cause a slot to become a structural target include, without limitation, insertion, modification, cancellation, invalidation, execution, relocation, in-node realignment, directed relocation cascade, compacted-leftmost rearrangement, shift-register update, or any other rule-bounded propagation triggered by the operation. Changes to data-structure implementation links—including without limitation previous, next, sibling, parent, or child pointers used for inter-entry traversal between slots or between nodes—do not, standing alone, make a slot a structural target where such links are maintained only for internal storage management or traversal and are not used as a matching-relevant order property or priority-status encoding. Likewise, changes to allocator state, generation counters, free-list state, lock or claim flags, and similar housekeeping state maintained outside the slot payload do not, standing alone, make a slot a structural target where such state is maintained only for internal storage management and is not used as a matching-relevant order property or priority-status encoding.

### Meaning of “Matching-Relevant Order Properties.”

As used herein, matching-relevant order properties include, without limitation, quantity, remaining quantity, price, side, order identifier, time-in-force designation, order-type designation, display or reserve designation (e.g., visible versus iceberg portion of an order), participant or self-trade-prevention attribute (e.g., participant identifier or anti-self-match designation), timestamp, sequence, cohort, bucket, tier, or other property supplied by the submitting user, by an external protocol or venue gateway, or assigned by the engine pursuant to the exchange rulebook or predetermined priority rule, where the property is used to determine matching eligibility, execution, cancellation, modification, allocation, priority status, or rank.

### Designated Slot Position—Exemplary Protocols.

One or more designated slot positions within the contiguously addressable slot region whose occupancy, under the active predetermined priority rule, encodes a priority status—for example, a designated position for the price-level-ending entry, defined relative to a reference point, such that occupancy of the designated position by a given entry encodes that entry's tail priority status for its price level. As a further non-limiting example of a designated-position realization, in a compacted-leftmost arrangement, the head slot for a price level is designated as the lowest-indexed occupied slot of the price level's contiguously addressable slot region; insertion writes to the lowest-indexed vacant slot and removal compacts by shifting entries toward the lowest index, so that the occupancy pattern of the slot region, combined with the lowest-indexed-occupied rule, encodes each entry's head priority status without a separate indicator datum. As a further non-limiting example, in a shift-register realization, slot position 0 is designated as the head slot and slot position C−1 is designated as the tail slot of a fixed-capacity C-slot region; insertion and removal maintain these designations by shifting entries as required, and the occupancy of slot positions 0 and C−1 under the shift-register protocol encodes the head and tail priority statuses of those slots under the predetermined priority rule.

### Illustrative Priority-Indicator Storage Forms.

Priority indicators may be realized in any storage form consistent with the common structural features set forth above, including without limitation:
(a) a dense structure addressed by slot index (e.g., bitmasks or arrays aligned with the node's contiguously addressable slots);
(b) a sparse or compressed structure that materializes only asserted entries and supplies a default neutral value for unmapped indices; or
(c) a hybrid that uses dense words where activity is high and sparse elision elsewhere; or any other storage form consistent with the common structural features.

In each storage form set forth above (i.e., realizations under Feature (a) bullet (a) or bullet (e)), the logical mapping “slot i→indicator value for i” is maintained; physical absence of storage for i is interpreted as the neutral value for i. For register-based realizations under Feature (a) bullet (c) and designated-position realizations under Feature (a) bullet (d), no per-slot indicator value need be materialized; the priority status of a slot is instead directly resolvable from the register's or designated position's structural state per the corresponding bullet, and the storage forms set forth in this paragraph do not apply to such realizations.

Meaning of “Determining a Priority Status of an Entry without a Search Across the Entire Order Book.”

As used herein and in the claims, “determining a priority status of an entry without a search across the entire order book” means that information obtained through examination of order entries physically or logically within a constant-bounded distance (where the bound does not grow with the size of the order book per Chapter II. G.) qualifies as structurally available information that may combine with the representation to enable the unambiguous inference set forth in Feature (b) of the priority-indicator genus at Chapter II. E.; however, a representation that requires book-wide search across all entries in the book to determine the entry's rank does not, by that requirement, qualify as enabling such inference. For clarity, examination of data structures that characterize entries without being the order entries themselves—such as aggregate metadata structures (for example, a price-level indexing structure that characterizes price-level aggregate properties rather than individual order properties) or priority indicators (for example, a bitmask or reference array denoting priority-related information about slots)—does not constitute book-wide search within the meaning of this paragraph, because such examination operates over data characterizing order entries rather than over the order entries themselves.

### Per-Slot Priority Indicator Subgenus.

As used herein, “per-slot priority indicator” denotes a subgenus of priority indicator in which a priority-indicator datum is maintained in one-to-one correspondence with a slot of the contiguously addressable slot region, including by slot-index addressing into slot-indexed storage or by physical co-location of the datum with the slot. The priority-indicator genus described in this chapter also encompasses, without limitation, a register or field whose structural identity is a priority predicate, and an occupancy state of a designated slot position, as further described in Feature (a). No disclaimer or limitation of the priority-indicator genus to the per-slot priority indicator subgenus is intended by any use of the term “per-slot priority indicator” in this disclosure or in the claims.

### Application of the Priority-Indicator Framework to the Per-Slot Subgenus.

A per-slot priority indicator denotes slot-relative priority status under the active predetermined priority rule, including, under FIFO or price-time priority, whether the corresponding slot is the head, the tail, or both for its price level, and, under non-FIFO policies, whether the corresponding slot satisfies a rule-defined reference, cohort, bucket, or tier condition used by Append or Prepend logic. The per-slot subgenus requires the common structural features of the priority-indicator genus, including structural association with the corresponding slot, unambiguous inference of priority status from the indicator's value, and coherent maintenance with the slot's actual priority status under that rule. The per-slot limitation specifies one-to-one slot correspondence of the datum, but does not convert a general order attribute, timestamp, sequence number, price key, tree key, sortable key, or other comparison input into a priority indicator merely because that value is stored in association with an order entry or can be compared with values carried by other order entries to determine rank.

Distinction from Priority Encoder.

An encoding rule of a priority indicator is distinct from a “priority encoder,” which refers elsewhere in this specification to a combinational logic circuit or a pipelined logic circuit (for example, a 74148-class priority encoder, a leading-zero counter, a trailing-zero counter, or a tree-structured OR-reduction with index propagation) that reads one or more priority indicators and produces a slot index of at least one slot satisfying a predicate defined by the predetermined priority rule. In a single-action (combinational) realization, the priority encoder produces the slot index in constant-bounded gate delays. In a pipelined realization, the priority encoder distributes the computation across one or more pipeline stages, with per-operation latency measured in clock cycles; the constant-bounded gate-delay characterization applicable to single-action realizations does not apply to pipelined realizations, and the per-operation latency of pipelined realizations is not required to be constant-bounded. In both realizations, however, the per-operation constant-bounded property (Chapter II. G.)—as measured by per-operation work bounded by a constant that does not grow with the size of the order book or any of its dynamic state—remains applicable. A priority encoder is thus an apparatus that operates over priority indicators; it is not itself a priority indicator.

### Meaning of “Pipelined Logic Circuit.”

As used herein, a “pipelined logic circuit” refers to a hardware datapath comprising one or more combinational logic stages separated by clocked storage elements (e.g., flip-flops, latches, or pipeline registers), and does not include software loops, iterative procedures, or sequential search algorithms executed by a general-purpose processor.

### Hardware Realization of Priority Indicators.

The following paragraphs describe non-limiting exemplary embodiments of priority indicators in hardware circuitry; other hardware realizations that maintain priority indicators as defined in this chapter are within the scope of this disclosure. The realizations set forth as Feature (a) bullets above are available to any hardware-circuitry embodiment within the scope of Chapter II.M., including without limitation the order-queue storage accelerator circuit described at Chapter IX.H.

### Indicator Storage in Hardware.

In hardware-circuitry embodiments (Chapter II.M.), Feature (a) bullet (a) (slot-index addressing into a slot-indexed storage) may be realized using indicator registers comprising flip-flops, latches, distributed RAM, block RAM, or other clocked storage elements.

### Encoded Index Register Representation.

In hardware-circuitry embodiments, Feature (a) bullet (c) (a register or field whose structural identity is a priority predicate) may be realized as an encoded index register implemented in hardware. The number of encoded index registers is determined by the number of priority predicates defined by the predetermined priority rule and is independent of the number of slots in the contiguously addressable slot region; for example, under a FIFO priority rule with head and tail predicates, the indicator storage comprises two encoded index registers regardless of whether the node has 16 or 64 slots (exemplary slot counts). The encoded index registers are updated by the insertion logic, removal logic, or indicator-update logic as part of each node operation. This representation is complementary to the priority-resolution circuit described below: the priority-resolution circuit computes a slot index on demand from a dense indicator representation, whereas the encoded index register maintains the slot index persistently and makes it available without combinational computation.

### Per-Slot Resolution in Register-Based Realizations.

An accelerator circuit may combine encoded index registers with any other indicator representation described in this chapter. In a register-based realization, absence of a materialized per-slot indicator value does not preclude priority-status resolution for any slot: a slot whose index corresponds to the register value has the priority status denoted by the register's predicate, and any other slot has the corresponding non-asserted status for that predicate; if the register carries a sentinel state indicating that no slot satisfies the predicate, each slot has the corresponding non-asserted status for that predicate. Where an encoded index register is combined with a slot-indexed, co-located, sparse, compressed, or other per-slot representation, absent values in that accompanying per-slot representation are interpreted as neutral values per Chapter II. F.

### Stored Value Representation and Sentinel Realization.

The encoded index register's stored value may be the slot index in a literal binary representation, or any deterministically decodable encoding thereof, including without limitation: a memory address of, an offset relative to a base address of, or a pointer to, the satisfying slot of the contiguously addressable slot region; a single-field representation in which the slot index occupies a designated bit range and other bit ranges of the same field carry epoch, version, generation, or other metadata; a representation obtained by adding an offset to, applying a permutation to, or applying a deterministic transform to the slot index; or any other deterministically decodable representation from which the slot index is recoverable. An encoded index register may also realize bullet (c) by carrying a sentinel state indicating that no slot satisfies the priority predicate, in which case the register's structural identity itself resolves the predicate per bullet (c) of Feature (a) without further comparison.

### Priority-Resolution Circuit.

A priority-resolution circuit reads the indicator storage and produces a slot index of at least one entry satisfying a predicate defined by the predetermined priority rule—for example, the index of the highest-priority occupied slot (head) or the lowest-priority occupied slot (tail). The priority-resolution circuit may be realized as a single-action combinational logic circuit, in which case a slot index is produced in constant-bounded gate delays, or as a pipelined logic circuit, in which case a slot index is produced across one or more clock cycles and the per-operation latency is measured in clock cycles rather than gate delays.

### Non-Limiting Realizations of the Priority-Resolution Circuit.

Non-limiting realizations of the priority-resolution circuit include a combinational priority encoder, a leading-zero counter (CLZ), a trailing-zero counter (CTZ), a tree-structured OR-reduction with index propagation, or a content-addressable comparison network, each of which may be implemented in a single-action combinational form or as a pipelined sequence of stages. In each case, the circuit resolves the query “which slot satisfies the priority predicate?” from the indicator storage without sequentially scanning the entries of entire slot region and confirming the predicate on each slot; the result is available after a fixed propagation delay determined by the circuit topology in a single-action combinational realization, or after a number of clock cycles in a pipelined realization, the number of clock cycles for a pipelined realization not being required to be constant-bounded.

### Free-Slot Identification Circuit.

The accelerator circuit may include a free-slot identification circuit, separately or in cooperation with a priority-resolution circuit, that determines from indicator storage, a vacancy bitmap, a separate vacancy record, or other vacancy state associated with a contiguously addressable slot region, a slot index of a vacant slot, or an indication that no vacant slot exists in the slot region. The free-slot identification circuit may be realized as a priority encoder on a vacancy bitmap derived from the indicator storage, as a priority encoder on a separate vacancy record maintained in parallel with the priority indicators, or as any other circuit that identifies a vacant slot without sequentially scanning the order entries of entire slot region. The free-slot identification circuit enables the insertion logic to select a target slot for a new entry without sequentially scanning the entire slot region for vacancies.

### Clarification Regarding “Sequential Search” in Hardware Embodiments.

The exclusion of sequential search in this subsection refers to unbounded (book-wide) search over order entries to derive priority status. It does not exclude sequential examination of indicator storage, vacancy state, or other slot-associated priority-indicator state within a fixed-capacity or predetermined-capacity slot region. Such examination remains distinct from book-wide examination of order entries.

### Relationship to Software Embodiment.

The priority-resolution circuit is the hardware analogue of the bit-manipulation operations described in Chapter VI, but operates directly on the indicator storage without instruction fetch, decode, or pipeline scheduling latency. Because the indicator storage is updated by operation logic, including insertion logic, removal logic, indicator-update logic, shared datapath or control circuitry, or any combination thereof, as part of each node operation, the priority-resolution circuit continuously reflects the current priority state and can supply a target insertion position or the identity of a slot of interest based on the predetermined priority rule within a propagation interval determined by the circuit topology, measured in gate delays for a single-action combinational realization or in clock cycles for a pipelined realization, where the number of clock cycles for a pipelined realization is not required to be constant-bounded.

### Chapter II. F.—Inactive/Neutral Value.

As used herein for a priority indicator, inactive, non-asserted, unset, default, and neutral value refer to an indicator state that, under the applicable encoding rule, is not the asserted state for the priority predicate or priority status denoted by that indicator. Implementations may realize the inactive state either:
(a) by logical absence of storage for that slot's indicator (e.g., a sparse or compressed representation that elides zero/false entries); or
(b) by presence with a neutral value (e.g., bit=0 in a bitmask, flag=false, null/zero/NaN/sentinel code-point, or a default field value inside the order object).

### Further Clarification.

Unless explicitly stated otherwise, references to “priority indicators” include both explicit and implicit (default-zero) encodings; the engine treats an absent indicator as semantically equivalent to a present indicator holding a neutral value. This preserves the logical structural association between priority indicators and their corresponding slots even when physical storage is elided; for slot-index-addressed and co-located realizations, the association takes the form of a logical mapping between slot indices and indicator values, and for register-based or designated-position realizations, the association is maintained by the corresponding structural tie set forth in Chapter II. E.—namely, by the structural identity of a register as a priority predicate, or by the designation of a slot position under the active predetermined priority rule, as the case may be. For avoidance of doubt, a neutral, absent, default, sentinel, or non-asserted indicator state is interpreted according to the applicable encoding rule and may, depending on that rule and any other information permitted under Feature (b), denote non-occupancy of a slot, non-satisfaction of a denoted priority predicate by an occupied slot, or that no slot satisfies the denoted predicate.

### Chapter II. G.—Constant-Bounded.

As used herein, a quantity is “constant-bounded” when it is bounded by a constant that does not grow with the size of the order book or any of its dynamic state, including the total number of orders, price levels, or nodes in the order book. Different applications of the constant-bounded property may be measured in units appropriate to the quantity being bounded. For example, the property may be attributed to the work of a per-operation step, a number of slot positions examined under the unambiguous-inference framework of Chapter II. E., a slot-index distance within a contiguously addressable slot region, the hop count of a directed relocation cascade as described in Chapter V. B., or another discrete quantity to which this disclosure expressly attributes the constant-bounded property. The remainder of this chapter elaborates the property as it applies to per-operation work, which is the principal application discussed herein.

### Application to Per-Operation Work.

The constant-bounded property of per-operation steps described in this disclosure is exemplified by, for example, a single priority-resolution query, a single per-slot indicator update, an in-node insertion/deletion/modification (excluding any preceding price-level tree lookup), a single cascade hop, or any other discrete computational step performed by the engine in completing a logical edit. The work of each such step is constant-bounded per Chapter II. G. The constant-bounded property characterizes the work of each per-operation step exemplified above; it does not characterize the elapsed-time latency of compound engine flows that may include a price-level tree operation, rebalancing, or allocator activity. No scope of any claim term is disclaimed by this clarification, and no limitation of the genus to the per-operation subset is intended in this disclosure or in the claims. Unless stated otherwise, the bound is measured by the number of distinct machine-word locations (e.g., references, flags, or per-slot indicator fields) that must be read or written to complete the logical edit, excluding any price-level tree lookup, rebalancing, allocator activity, or subsequent maintenance.

### Configuration-Dependent Bound.

In one embodiment, the bound may depend on configuration parameters—for example, a node's maximum slot capacity or the native word width—and therefore remains bounded across nodes even when actual per-node capacities vary within that cap; in all cases, it is independent of total book size.

### Constant-Bounded in Hardware-Circuitry Embodiments.

In hardware-circuitry embodiments, the bound may equivalently be measured by the number of distinct storage elements (e.g., flip-flops, BRAM locations, or register bits) read or written, or by a bounded number of gate delays or clock cycles, as appropriate for the implementation technology.

### Chapter II. H.—Page (Multi-Way Tree).

As used herein for B/B+-tree embodiments, a “page” means a tree node (leaf page or internal page) that stores an array of keys and, for internal pages, child references. “Page-local” describes edits whose writes are confined to a single page and, if minimum-degree constraints require, one sibling and the parent along the update-to-root corridor anchored at the LCA; these transforms include insert, remove, borrow, merge, and redistribute and preserve in-order sequence with rebalancing along at most one root-to-leaf path. The term does not denote OS or hardware memory pages (e.g., 4 KB, 2 MB huge pages) used by the memory allocator elsewhere in this specification.

### Chapter II. I.—Computer.

As used herein, a “computer” means any device—including servers, validator machines, and mining devices (e.g., ASIC- or FPGA-based systems)—that includes one or more general-purpose processors executing the engine instructions and memory that stores the contiguously addressable slot regions and the priority indicators; in proof-of-work systems, a “miner” is a type of validator (see Chapter X for the broader “validator” genus, which encompasses processes, machines, hardware circuitry, or combinations thereof). As used herein, “engine instructions” include, without limitation, instructions that implement any of the following: order ingestion and API processing, queue transport, core matching, memory management for nodes and descriptors, priority indicator maintenance, price level indexing and tree operations, communication of operations to and from a hardware accelerator via a host interface, relocation cascades, and depth snapshot traversal.

### Chapter II. J.—API (Application-Programming Interface).

As used herein, an application-programming interface (API) denotes a programmatic interface by which external or internal components provide electronic order messages (including add, cancel, and modify requests) to the service, and encompasses the interface/order-transport mechanisms disclosed in the parent, including without limitation: queue-based transports (e.g., lock-free, cache-aligned single- and multi-producer/consumer rings), zero-copy channels, SIMD-copy channels, mailbox/DMA/RDMA-backed queues, and a host interface; as well as network or inter-process communication endpoints (e.g., RPC, HTTP/REST, gRPC, TCP/UDP) and callable library entry points. References herein to an “interface,” “order transport,” “transport layer,” “host interface,” or “inbound order queue” are species of this API genus.

### Hardware Realization of API.

In embodiments where the service is realized in whole or in part as hardware circuitry, the API may be realized as a hardware interface that receives order messages and produces corresponding operations. Non-limiting examples of such a hardware-realized API include:
(a) a network parser pipeline that extracts order events from incoming network packets and converts them to insertion, removal, or modification operations;
(b) a memory-mapped register or command interface;
(c) a hardware message queue or FIFO; or
(d) a streaming data interface.

### Chapter II. K.—Price Level Descriptor/Price Level Record/Price Level Pointer.

As used herein, ‘Price Level Descriptor’ (software) and ‘Price Level Record’ (hardware) denote corresponding representations of the same price level metadata that typically includes:
(a) price;
(b) aggregate quantity;
(c) left-child, right-child, and parent references (genus “reference” per Chapter II. A., e.g., index/handle into the descriptor array); and
(d) predecessor and successor references that realize the in-order neighbor links; and a node-back-reference field identifying the Data Holder Node holding the head or tail order of the price level.

As used herein, ‘Price Level Pointer’ is a reference (genus term) to a Price Level Descriptor.

### Chapter II. L.—Machine-Executable Content.

As used herein, “machine-executable content” denotes any stored representation that, when loaded onto one or more target devices, causes the one or more target devices to perform operations. Machine-executable content includes, without limitation:
(a) processor-executable binary instructions, firmware, or microcode;
(b) a configuration image (e.g., an FPGA bitstream, a partial-reconfiguration image, or a datapath configuration for a coarse-grained reconfigurable array) that defines circuitry or datapath routing on a reconfigurable device;
(c) an application-specific device image (e.g., a fuse map, mask image, or programming image) that defines circuitry on a programmable or mask-programmed device;
(d) a compute kernel or accelerator program loadable onto a co-processor, graphics processing unit, network processor, data processing unit, digital signal processor, or other accelerator device;
(e) a configuration table or lookup-table image loadable onto a table-driven processing device;
(f) an intermediate representation (e.g., bytecode, portable executable, or device-loadable intermediate language) that is compiled, interpreted, translated, or verified by the target device at load time or at run time;
(g) a collection of two or more of (a) through (f), whether stored as a single archive, as separately stored files, or as a combination thereof; or
(h) any other stored representation that is loadable onto a target device and operative to cause the target device to perform operations upon loading.

### The Meaning of “Target Device”.

As used herein, “target device” denotes any device or combination of cooperating devices capable of performing operations in response to loaded content, including without limitation: a processor, a microcontroller, a reconfigurable logic device, an application-specific integrated circuit, a co-processor, an accelerator, a digital signal processor, a system-on-chip, or a multi-device system in which two or more cooperating devices collectively perform operations.

### Representation Neutrality.

The term “machine-executable content” is representation-neutral and device-neutral; the requirement is only that the content is loadable onto one or more target devices and operative to cause the one or more target devices to perform operations. The term encompasses content in any encoded format, including without limitation: binary, hexadecimal, serialized, compressed, encrypted, or obfuscated representations.

The meaning of “Loading”.

As used herein, “loading” denotes any mechanism by which machine-executable content is transferred to, programmed into, or made accessible by one or more target devices, including without limitation: file loading, memory mapping, network transfer, direct memory access, bus-mastered transfer, shared-memory access, serial or parallel programming interface (e.g., JTAG, SPI, SelectMAP), boot loading, flash programming, inter-process communication, or streaming transfer.

### Internal Transformations.

Where the target device performs one or more internal transformations as part of loading—including without limitation: decryption, decompression, signature verification, deserialization, address relocation, dynamic linking, binary translation, initialization, or just-in-time compilation—the stored representation remains machine-executable content provided it is operative to cause the target device to perform operations upon completion of such loading. In the context of this disclosure, the operations are those of the order-queue storage engine or the order book price-level apparatus as described herein. References elsewhere in this specification or in the claims to “computer-executable instructions executed by one or more processors” refer to one non-limiting example of machine-executable content as defined herein, encompassing without limitation processor-executable binary instructions, firmware, microcode, and analogous processor-instruction-stream realizations; references to “hardware circuitry” (Chapter II. M.) refer to other non-limiting examples of machine-executable content realized as hardware circuitry, including without limitation FPGA bitstreams, ASIC mask images, accelerator circuit configurations, and the other realizations enumerated above. The foregoing examples are illustrative and do not limit the scope of any claim term to the enumerated examples.

### Chapter II. M.—Hardware Circuitry.

As used herein, “hardware circuitry” denotes any physical implementation that performs one or more operations through means other than solely through execution of a stored processor-instruction stream by a general-purpose processor. Hardware circuitry includes, without limitation:
(a) reconfigurable logic in which the logic paths are defined by a configuration image loaded after fabrication (e.g., a field-programmable gate array (FPGA), a complex programmable logic device (CPLD), or a coarse-grained reconfigurable array (CGRA));
(b) application-specific integrated circuitry in which the logic paths are fixed at fabrication (e.g., an ASIC, a standard-cell design, or a gate-array design);
(c) structured or configurable application-specific logic in which a base silicon fabric is customized by one or more metal or via layers (e.g., a structured ASIC or a mask-configurable gate array);
(d) a system-on-chip (SoC) integrating one or more general-purpose processors with programmable logic fabric on a single die or in a single package, wherein the hardware circuitry comprises the programmable logic fabric portion (e.g., Zynq, Agilex SoC, and Versal);
(e) a dedicated functional unit, co-processor, or accelerator implemented as fixed-function logic on a processor die or on a companion die within the same package;
(f) a processing-in-memory device or near-memory processing device in which operations are performed within or adjacent to a memory array;
(g) a network interface device, data processing unit, or SmartNIC comprising fixed-function or programmable processing pipelines; or
(h) any other physical implementation that performs one or more operations through means other than solely through execution of a stored processor-instruction stream by a general-purpose processor.
   Elaboration on “Means Other than Solely Through Execution of a Stored Processor-Instruction Stream.”

Hardware circuitry encompasses implementations based on configured or fixed digital logic paths, including the logic paths defined by an FPGA bitstream, the gate-level connections of an ASIC, and the pipeline stages of a fixed-function accelerator. Hardware circuitry also encompasses implementations that perform operations through other physical mechanisms provided the operations are not performed solely through execution of a stored processor-instruction stream by a general-purpose processor. A logic path that is selected at run time by a multiplexer, state machine, microcode sequencer, or pipeline control signal is hardware circuitry provided the selection mechanism is itself realized through means other than an instruction decoder of a general-purpose processor fetching and decoding a processor-instruction stream. A micro-sequencer that issues a bounded, fixed repertoire of micro-operations (e.g., RotateL, RotateR, Recolor, HeightAdj) from a hardware control store is hardware circuitry, even though the micro-operations are sequenced, because the sequencing mechanism is fixed-function rather than a general-purpose processor executing an unbounded processor-instruction stream. Hardware circuitry within the meaning of this Chapter further encompasses graphics processing units (GPUs), tensor processing units (TPUs), digital signal processors (DSPs), data processing units (DPUs), neural processing units (NPUs), and similar specialized processing elements executing stored kernels or instructions, where the operations recited herein are performed by such specialized processing elements rather than by a general-purpose processor fetching and decoding a processor-instruction stream.

### Implementation Neutrality.

The term “hardware circuitry” is implementation-neutral; the requirement is only that the implementation performs one or more operations through means other than solely through execution of a stored processor-instruction stream by a general-purpose processor. The term encompasses implementations at any process node, in any fabrication technology, at any clock frequency or operating speed, and with any number of pipeline stages or processing elements. The term also encompasses circuitry that is partially or wholly generated by high-level synthesis (HLS) tools from behavioral descriptions, provided the resulting implementation performs operations through means other than solely through execution of the behavioral description as a stored processor-instruction stream by a general-purpose processor.

### Coupling and Communication.

The hardware circuitry can be communicatively coupled to one or more general-purpose processors via a host interface. The coupling may be realized as a local bus or on-chip interconnect (e.g., PCIe, AXI, AHB, Wishbone, CXL, or a proprietary interconnect), a shared-memory region accessible by both the one or more general-purpose processors and the hardware circuitry, a network fabric, or any other communication channel that permits the one or more general-purpose processors and the hardware circuitry to exchange operation requests, completion responses, and data. Where the hardware circuitry and the one or more general-purpose processors reside on the same die (e.g., in a system-on-chip), the coupling may be an on-chip bus or a tightly coupled memory interface. Where they reside on separate devices, the coupling may be a board-level bus, a chip-to-chip link, or a network-attached channel.

### Application of Hardware Circuitry to the Order-Queue Storage Engine.

In embodiments where the order-queue storage engine is realized in whole or in part as hardware circuitry, the hardware circuitry may perform any of the operations of the order-queue storage engine, including without limitation: storage of entries in contiguously addressable slot regions; maintenance of priority indicators; determination of a target insertion position according to the predetermined priority rule; storing an entry into a selected slot; capacity overflow detection and handling; removal or invalidation of entries; updating priority indicators for affected slots in response to changes in entries; in-node realignment of entries; and single-hop or multi-hop directed relocation. Any operation not performed by the hardware circuitry is performed by the one or more general-purpose processors executing a processor-instruction stream, or by a combination of the hardware circuitry and the one or more processors. The partitioning of operations between the hardware circuitry and the one or more processors is implementation-specific; any combination of hardware-realized and processor-realized operations is within the scope of this disclosure.

Priority Resolution from Indicator Storage.

Priority resolution from indicator storage in hardware-circuitry embodiments is described at Chapter II. E., ‘Priority-resolution circuit’ and ‘Relationship to software embodiment’. The hardware priority-resolution circuit is distinct from software bit-manipulation instructions (e.g., CLZ, CTZ, LZCNT, TZCNT executed by a general-purpose processor), as further set forth in those subsections.

### Meaning of “Node” in Hardware-Circuitry Embodiments.

As used herein, where the order-queue storage engine or any portion thereof is realized as hardware circuitry, “node” means a structural unit that maintains a physical association of entries, the structural unit being realized as a contiguously addressable slot region of memory (e.g., on-chip memory as defined below at Chapter IX. H.) or of memory otherwise accessible to the hardware circuitry. A node in this sense shares the conceptual core (having a contiguously addressable slot region and priority indicator associated with slots in the region) with the software Data Holder Node described in Chapter III. B.; the hardware-circuitry node is defined by the conceptual core itself; the slot-region realization maintaining physical association of the entries stored therein, with priority indicators logically associated with the slots of the region which may be implemented as a separate structural element per Chapter II. E. The hardware circuitry node may be implemented in any memory tier within the scope of this disclosure, including low-latency memory (such as on-chip SRAM or BRAM), higher-capacity memory (such as off-chip DRAM), or any hierarchical combination thereof.

### Accelerator Circuit as a Sub-Genus of Hardware Circuitry.

An accelerator circuit, as used herein, is hardware circuitry within the meaning of this chapter that is configured to perform one or more operations in acceleration of or in cooperation with a host system. Accelerator circuits form a sub-genus of hardware circuitry; every accelerator circuit is a form of hardware circuitry, but not every hardware-circuitry realization is an accelerator circuit. The order-queue storage accelerator circuit described at Chapter IX. H. is a species of accelerator circuit; other accelerator-circuit species may perform other operations in acceleration of or in cooperation with a host system. The order-queue storage accelerator circuit may be realized on any of the platform categories enumerated above—including without limitation reconfigurable logic (e.g., FPGA), application-specific integrated circuitry (e.g., ASIC), structured or configurable application-specific logic, a system-on-chip, a dedicated functional unit or co-processor, a processing-in-memory or near-memory device, or a network interface device or SmartNIC. Hardware-circuitry realizations that perform matching-engine operations without qualifying as the order-queue storage accelerator circuit species under the structural definition at Chapter IX. H. fall within the hardware circuitry genus without being within the accelerator-circuit sub-genus.

### Availability of Accelerator-Circuit Features in Hardware-Circuitry Embodiments.

The features, embodiments, and operational characteristics disclosed for either accelerator-circuit species described herein are available as disclosed embodiments of hardware circuitry within the meaning of Chapter II. M., whether or not a given hardware-circuitry realization satisfies every structural element of the accelerator-circuit species from which the feature is drawn. The features available from the order-queue storage accelerator circuit (Chapter IX. H.) include without limitation pipelined operation acceptance, configurable priority rule, depth-aware heterogeneous slot-region allocation, on-chip order-identifier indexing, multi-port on-chip memory, integrated price level indexing, and the realization-neutral disclaimer. The features available from the order-book price-level accelerator (OBA, Chapters IX. A.-G.) include without limitation banked descriptor memory for price-level records, tree logic for balanced search tree representation of price levels, neighbor-link registers holding predecessor/successor references, insertion and deletion pipelines implementing neighbor-aware splice and neighbor-aware deletion, a fix-up micro-sequencer executing constant-size local transforms along at most a single root-to-leaf path, extrema registers and snapshot semantics, tick-indexed comparators, coherency and hazard handling, configuration images for balanced-tree variant selection (e.g., red-black, AVL, B-tree, or B+-tree), and the associated host interface variants. The on-chip memory described at Chapter IX. H. is one such available feature; hardware-circuitry realizations may optionally employ on-chip memory for storage of slot regions, indicator storage, or other state, or may employ other memory architectures (including without limitation external memory, non-coherent memory, or any memory arrangement compatible with the hardware circuitry) while remaining within the hardware circuitry genus.

### Chapter II. N.—Adjacency.

As used herein, adjacency between nodes—including the adjacency traversed by a Push Forward or Push Back cascade, the placement of a new node at the cascade boundary, and the maintenance of adjacency among remaining nodes upon removal of a node that becomes empty during matching execution or cancellation, as described at Chapter V. B. and below in this Chapter II. N.—may be realized by any means within the scope of this disclosure. Each of the foregoing adjacency operations applies uniformly across all such mechanisms as follows:
(a) Cascade traversal: each hop proceeds to the next adjacent node in a designated direction.
(b) New-node placement at cascade boundary: a new node is established in adjacency with its neighbors such that subsequent adjacency-dependent operations proceed correctly through the established adjacency.
(c) Maintenance of adjacency upon node removal: upon removal of a node that becomes empty during matching execution or cancellation, the removed node's former neighbors are re-established in adjacency with each other such that the adjacency structure remains intact without the removed node and subsequent operations proceed through the re-established adjacency.

### Exemplary Adjacency Mechanisms.

The adjacency between nodes may be realized by any means within the scope of this disclosure, including without limitation:
(a) pointer-based linking (e.g., the doubly-linked or singly-linked arrangements described at Chapter III. B.);
(b) address-ordered arrangement in memory, including on-chip storage and any memory accessible to the order-queue storage engine or the order-book price-level accelerator;
(c) indexed arrangement, including arrangements where the next adjacent node is identified by deterministic index computation from a current node identifier;
(d) chained hardware storage elements (e.g., chained memory banks, register chains, or block-RAM arrays) connected by dedicated interconnect such that a cascade proceeds from one storage element to the next via hardwired routing;
(e) fixed interconnect topologies (e.g., systolic arrays, ring-connected processing elements, or mesh-connected arrays of hardware units), wherein adjacency is determined by physical connection between hardware units;
(f) content-addressable lookup between nodes, wherein the next adjacent node is identified by associative matching on a key maintained for each node, the slots within each node remaining contiguously addressable per Chapter II. C.;
(g) crossbar or switch-based routing (e.g., on-chip networks or reconfigurable interconnect), wherein adjacency between nodes is realized through programmable routing between hardware units; or
(h) any equivalent mechanism, whether realized in software, hardware circuitry, or a combination thereof, by which the adjacency operations described in this chapter proceed through the adjacency structure.

### Chapter II. O.—Logical Association and Physical Association.

### Logical Association.

As used herein, “logical association” between two or more entities denotes any association that can be logically construed—that is, any association for which a deterministic correspondence between the entities can be reasonably inferred by a person of ordinary skill in the art through data relationships, algorithmic derivation, indexing, correspondence mapping, or any other means that maintains the association at an abstract level, independent of the physical storage arrangement, memory location, spatial proximity of the entities, or the existence of any physical representation. Logical association does not require physical materialization; an association between entities is logical whenever the correspondence between them can be construed as a matter of data or algorithmic relationship, whether or not a physical materialization of such relationship between the entities exists.

### Physical Association; Physical Materialization Implies Logical Association.

As used herein, “physical association” means physical materialization of a logical association through physical means, such as a spatial relationship, an electrical, mechanical, or optical signal, or any other physical arrangement between entities—for example, through co-location, adjacency in memory or storage, or direct electrical or mechanical connection between the entities. Physical materialization of any associative relationship between two or more entities necessarily implies that a logical association between those entities also exists, because the physical arrangement simply materializes the correspondence required by logical association. Physical association is therefore a subset of logical association: every physical association is also a logical association, but the converse does not hold—not every logical association requires physical materialization.

### Scope of “Logically Associated” as Used Herein and in the Claims.

It follows that any accused or disclosed embodiment exhibiting physical association between two entities also exhibits logical association between those entities within the meaning of this specification. Accordingly, the term “logically associated” as used herein and in the claims is satisfied by any physical realization that maintains the correspondence between the associated entities, including without limitation embodiments that physically co-locate the entities, embodiments that store or maintain the entities in adjacent memory or storage structures, and embodiments that electrically, mechanically, or optically connect the entities in hardware circuitry. The term “logically associated” is also satisfied by embodiments that do not exhibit physical association between the entities but maintain the correspondence through data relationships, algorithmic derivation, indexing, content-addressable lookup, or any equivalent logical means.

### Application to Priority Indicators.

The priority indicators described herein are logically associated with the slots of the contiguously addressable slot region. The logical association may be realized physically (e.g., indicators stored in-node alongside the slot payloads, or as fields embedded within order objects), logically without physical co-location (e.g., indicators stored in a separate indicator memory with correspondence maintained through slot indices, or computed on demand from a sparse or compressed encoding per Chapter II. F.), or through any combination thereof. The structural association between each priority indicator and the slots, slot region, or predicate-defined slot positions of the contiguously addressable slot region, as applicable, defined at Chapter II. E. and realized by any of the structural ties set forth therein (including slot-index addressing, physical co-location, a register whose structural identity is a priority predicate, an occupancy state of a designated slot position, or an indicator memory or co-indexed structure that is separate from the storage of any slot of the contiguously addressable slot region), is the structural property that characterizes the logical association, regardless of the physical realization employed. References elsewhere in this specification or in the claims to a “storage region separate from the contiguously addressable slot region” are non-limiting examples of the foregoing realization, and the broader “separate from the storage of any slot of the contiguously addressable slot region” realization is not disclaimed by such references.

### Chapter II. P.—Predetermined Priority Rule.

As used herein, “predetermined priority rule” denotes a priority rule that is determinate at the time of each operation it governs, such that the engine logic performing the operation, and any priority-resolution circuit present, apply a specific rule uniformly to operations occurring under that rule. A priority rule is predetermined for purposes of this specification where the rule applicable to each operation is determinate at the time of that operation, regardless of whether the same rule applies to all operations of the engine throughout its lifetime.

### Scope of “Predetermined Priority Rule.”

A priority rule is predetermined within the meaning of this specification in any of the following circumstances, without limitation:
(a) where the priority rule is fixed for all operations of the engine or the accelerator circuit;
(b) where the priority rule is selected at configuration time (e.g., via a configuration register writable by a host processor, a configuration image loadable onto an accelerator circuit, a synthesis parameter applied at design time, or a runtime configuration parameter) and applied uniformly during a period of operation;
(c) where the priority rule differs across instruments, symbols, sessions, or other partitions of the engine's workload, and the applicable rule for each partition is determinate at the time of each operation within that partition;
(d) where the priority rule transitions between distinct rules at specific points during the engine's operation, with each rule being predetermined for the period of its application and the transition between rules being itself determinate at the time of transition;
(e) where the priority rule is a parameterized rule with parameter values that may change during the engine's operation, each set of parameter values being predetermined for the period during which it applies; or
(f) where the priority rule is otherwise determinate at the time of each operation, such that operations occurring under a particular applicable rule are governed by that rule without ambiguity.

As provided in the definition above, changes to the priority rule or its parameters between operations do not disqualify the rule from being “predetermined” for each operation governed by the then-applicable rule and parameter values.

Exemplary Embodiment: Mixed FIFO/ProRata Allocation with Configurable Allocation Ratio.

In one embodiment, the predetermined priority rule is a mixed allocation rule combining FIFO (price-time priority) and ProRata (size-weighted allocation) components, with an allocation ratio parameter specifying the fraction of an incoming order's quantity allocated to each component. For example, a 40%/60% mixed rule allocates 40% of an incoming order's quantity according to ProRata (distributed across orders at the price level in proportion to their respective sizes, subject to minimum-lot and rounding rules) and allocates 60% according to FIFO (to the head of the price level, proceeding to subsequent orders in time-priority sequence if the head is partially filled). The priority indicators may maintain head/tail identification for the FIFO component and size-ranking or similar information for the ProRata component, consistent with the common structural features of the priority indicator genus described at Chapter II. E.

### Priority Parameters Change During Operation.

The allocation ratio parameter may change during the engine's operation. In one embodiment, the allocation ratio changes from a first ratio (e.g., 40% ProRata/60% FIFO) to a second ratio (e.g., 60% ProRata/40% FIFO) at a specific point during operation, in response to a configuration change, a scheduled transition, a market condition, a regulatory event, or any other triggering condition. Following the parameter change, the engine logic performing the operation, and any priority-resolution circuit present, apply the second ratio uniformly to operations occurring after the change. Priority indicators are maintained coherently across the parameter change; any restructuring of indicators or contiguously addressable slot regions that the new priority rule requires is performed during the priority rule transition, because the structural framework of indicators (structural association with slots per Chapter II. E., logical association with slots per Chapter II. O.) requires that the indicator states remain coherent with the governing priority rule.

### Determinacy Across the Parameter Change.

The transition itself is determinate: the engine applies the first ratio to operations occurring before the transition and the second ratio to operations occurring after the transition, with the transition point being itself determinate at the time it occurs. Each ratio is predetermined for the period during which it applies, satisfying the “predetermined priority rule” requirement of the claims throughout the engine's operation.

Generalization from the Exemplary Embodiment.

This embodiment illustrates, without limitation, that the “predetermined priority rule” may encompass parameterized rules with parameter values that change during engine operation, consistent with the scope of “predetermined priority rule” set forth above.

### Chapter II. Q.—Predetermined Number of Entries.

As used herein, ‘predetermined number of entries’ denotes a maximum entry count that is determinate for each node at the time of each operation governing storage of entries within that node, such that the insertion logic, removal logic, and any capacity overflow handling logic govern normal operations according to a specific maximum, wherein normal operations comprise insert, delete, modify, in-node realignment, and directed relocation cascades as defined at Chapter II. C., and exclude allocation, deallocation, and resizing of the slot region. A number of entries is predetermined for purposes of this specification where the maximum applicable to each operation is determinate at the time of that operation, regardless of whether the same maximum applies to all nodes of the engine throughout its lifetime or whether the maximum for a given node may change between distinct periods of the engine's operation.

### Scope of “Predetermined Number of Entries.”

A number of entries is predetermined within the meaning of this specification in any of the following circumstances, without limitation:
(a) where the predetermined number of entries is uniform across all nodes of the engine and fixed throughout the engine's lifetime;
(b) where the predetermined number of entries differs across nodes (e.g., according to a depth-aware capacity policy as described at Chapter VII), with the applicable maximum for each node being determinate at the time of each operation within that node;
(c) where the predetermined number of entries is selected at configuration time (e.g., via a configuration register, a configuration image loadable onto an accelerator circuit, a synthesis parameter applied at design time, or a runtime configuration parameter) and applied uniformly during a period of operation;
(d) where the predetermined number of entries for a given node is adjusted between distinct periods of operation (e.g., through node resizing, capacity reconfiguration, or allocation of replacement nodes with different capacity), with each maximum being predetermined for the period of its application and the adjustment between maxima being itself determinate at the time of adjustment;
(e) where the predetermined number of entries is determined by a capacity policy with parameter values that may change during the engine's operation (e.g., the depth-aware capacity policy of Chapter VII responding to learned parameters or online controller adjustments per Chapter VII. D.), each set of parameter values yielding a determinate maximum for each node; or
(f) where the predetermined number of entries is otherwise determinate at the time of each operation, such that operations storing entries in a node are governed by the then-applicable maximum without ambiguity.

As provided in the definition above, adjustments to the maximum for a node between periods of normal operation, or differences in the maximum across nodes, do not disqualify the maximum from being “predetermined” for each normal operation governed by the then-applicable maximum.

Exemplary Embodiment: Depth-Aware Capacity Policy with Dynamic Node Resizing.

In one embodiment, the predetermined number of entries for each node is determined by a depth-aware capacity policy as described at Chapter VII, wherein the maximum entry count for a node is a function of the node's distance from the head of the order book. For example, nodes near the order book head may have a larger predetermined maximum (e.g., capacity of 256 entries) to amortize cache-line shifts and reduce the frequency of relocation cascades at the active price levels, while nodes deeper in the book may have a smaller predetermined maximum (e.g., capacity of 32 entries) to maintain a small per-node cache and TLB footprint at less-active price levels. Although each individual deep-region node holds fewer entries than each near-head node, the total memory footprint of the deep-node region is typically substantially larger than that of the near-head-node region, because the number of deep nodes is substantially greater than the number of near-head nodes for a representative order book; this asymmetric per-region allocation is justified by the per-order access probability in the deep-node region being exponentially smaller than the per-order access probability in the near-head-node region (consistent with the empirical access model of Chapter VII. B.), such that the larger deep-node region accommodates the long aggregate residency tail of the order book without paying the per-order cache-residency cost that the near-head-node region requires. The depth-aware capacity policy is parameterized by a capacity function K that maps node depth to capacity, with parameter values governing the function's shape and scale.

### Capacity Parameters Change During Operation.

The parameter values of the depth-aware capacity policy may change during the engine's operation. In one embodiment, the parameter values are adjusted by an online controller (Chapter VII. D.) that learns from observed order-flow patterns and adapts the capacity function to optimize end-to-end latency. When the parameter adjustment yields a new applicable maximum for one or more nodes that differs from those nodes' current capacities, the engine performs node resizing (Chapter VII. E.) by allocating replacement nodes with the new applicable maxima and migrating entries from the prior nodes. Following the resizing, the insertion logic, removal logic, and any capacity overflow handling logic apply the new maxima uniformly to normal operations occurring after the resizing. Priority indicators are maintained coherently across the resizing; the indicator structure of each replacement node is established consistent with the common structural features of the priority indicator genus described at Chapter II. E.

### Determinacy Across Capacity Adjustment.

The capacity adjustment itself is determinate: each node has a determinate maximum at any given time, with normal operations storing entries in the node being governed by that maximum. When the maximum for a node is adjusted, normal operations occurring before the adjustment are governed by the prior maximum and normal operations occurring after the adjustment are governed by the new maximum. Each maximum is predetermined for the period during which it applies, satisfying the “predetermined number of entries” requirement of the claims throughout the engine's operation.

Generalization from the Exemplary Embodiment.

This embodiment illustrates, without limitation, that the “predetermined number of entries” may encompass capacity policies with parameter values that change during engine operation, including without limitation depth-aware capacity policies with adaptive parameter adjustment, consistent with the scope of “predetermined number of entries” set forth above.

### Chapter II. R.—Structural Meaning of Logic and Circuit Terms.

As used herein and in the claims, “insertion logic,” “removal logic,” “indicator-update logic,” and “capacity overflow handling logic” denote structural elements with definite structural content. The accompanying terms “priority-resolution circuit,” “free-slot identification circuit,” “accelerator circuit,” and “order-queue storage accelerator circuit” denote structural elements in their ordinary meaning as understood by a person of ordinary skill in the art. Each such logic or circuit element is realized by one or more of the structural species enumerated below, or by any combination or equivalent thereof, configured to perform the operations specified for that logic or circuit element in this specification.

### Software Realizations.

In software embodiments, each such logic element is realized as one or more sequences of computer-executable instructions, which are one non-limiting example of machine-executable content per Chapter II. L., stored in a non-transitory machine-readable medium, and configured, when executed by one or more processors, to perform the operations specified for that logic element in this specification. Non-limiting structural realizations of the instruction sequences include: function definitions, method definitions, and procedure definitions encapsulating the operations; instruction sequences realizing the bit-manipulation operations of Chapter VI. C., including without limitation sequences utilizing processor bit-manipulation, single-instruction-multiple-data (SIMD), or other processor-level instruction extensions where available; routines implementing the cascade procedures of Chapter V. B.; routines implementing the order-matching procedures of Chapter V. C.; and routines implementing the order insertion, modification, and cancellation procedures of Chapter V. A. and Chapter V. D.

### Hardware Circuitry Realizations.

In hardware circuitry embodiments per Chapter II. M., each such logic element is realized as one or more datapath and control structures, including without limitation: combinational logic gates; sequential logic elements including flip-flops, latches, and registers; finite state machines; micro-sequencers, including the fix-up micro-sequencer of Chapter IX. C.; pipeline stages with associated control signals, including the insertion and deletion pipelines of Chapter IX. C.; arithmetic-logic units, shifters, and bitwise-operation units realizing the bit-manipulation operations of Chapter VI. C.; priority encoders, leading-zero counters, trailing-zero counters, tree-structured OR-reductions, and content-addressable comparison networks realizing the priority-resolution circuit of Chapter II. E.; free-slot identification circuits per Chapter II. E.; combinational datapath stages per Chapter IX. H., “Insertion, removal, and indicator-update logic”; multiplexers, demultiplexers, and programmable interconnect; and any combination thereof, configured to perform the operations specified for that logic element. Each such hardware realization may be instantiated in any of the hardware circuitry technologies enumerated at Chapter II. M.

### Operational Specifications by Logic Element.

The operational specifications for each logic element are set forth in this specification as follows:
(a) For insertion logic: Chapter V. A. (Append and Prepend), Chapter V. D. (Order insertion), Chapter VI. D. (Append paths and Prepend path), and Chapter IX. H., “Insertion, removal, and indicator-update logic”;
(b) For removal logic: Chapter V. D. (Order cancellation and storage of lookup), and Chapter IX. H., “Insertion, removal, and indicator-update logic”;
(c) For indicator-update logic: Chapter V. B. (Directed relocation cascades), Chapter VI. C. (Update primitives), and Chapter IX. H., “Insertion, removal, and indicator-update logic”; and
(d) For capacity overflow handling logic: Chapter V. B. (Directed relocation cascades), Chapter V. D. (Order insertion), and the allocation procedures invoked by overflow handling as described at Chapter III. D. (Memory pools and allocator model).

### Structural Genus Character.

The foregoing logic and circuit terms are used as structural genus terms that encompass the software and hardware realizations enumerated above, together with any equivalent structural realization that performs the same operations. The terms are not used as nonce terminology or as functional placeholders; they identify structures drawn from the genus defined in this chapter. Other logic and circuit terms used in this disclosure or in the claims—including without limitation “coherency or hazard-resolution logic”—are likewise interpreted according to the structural-meaning framework set forth above, with corresponding structure disclosed at the chapters and paragraphs cited herein.

### Operation Logic.

As used herein, “operation logic” refers to accelerator-circuit logic that performs operations on entries stored in slot regions or maintains priority indicators logically associated therewith, including insertion logic, removal logic, indicator-update logic, any combination thereof, or shared datapath or control circuitry performing corresponding functions. Operation logic does not require all named component blocks to be separately present. Priority-indicator maintenance may be performed by insertion logic, removal logic, indicator-update logic, shared circuitry, or any combination thereof, including as part of an entry-insertion or entry-removal operation or as a standalone indicator-update operation.

### Structural Recitation of Operations.

As used in the claims of this application, recitations that an engine, accelerator circuit, service, memory, logic, circuit, or other claimed apparatus is “configured to” perform an operation, and recitations of operations in participial or gerund form within an apparatus claim, identify the structural configuration and capability of the recited apparatus, including corresponding instructions, circuitry, control logic, datapaths, state machines, memory arrangements, or combinations thereof described in this specification. Such recitations do not require actual performance of the operation during any particular instance of use and do not convert an apparatus claim into a method or mixed-class claim. Where a limitation is stated in relation to completion of, response to, or performance of an operation, the limitation requires the apparatus to be configured so that, when the operation is performed by or through the apparatus, the recited resulting state, relationship, or capability is provided.

### Chapter II.S.—Disambiguation.

### Rank.

The term “rank” is used in this specification in multiple context-specific senses. References include, without limitation:
(a) the priority rank of an entry under a predetermined priority rule, as used in Chapter II.E;
(b) the rank of a linear operator, linear endomorphism, affine update, or matrix over F2, as used in this Appendix and related mathematical passages;
(c) well-founded ranking functions used in cascade-termination or recursion-safety arguments; and
(d) global, ordinal, or modeling indices used in mathematical derivations. Each use is governed by its respective context and applicable definition.

### Block.

As used in this specification, the term “block” is used in several technical senses determined by context, including without limitation a BRAM/SRAM block (hardware memory unit, Chapter II. M. and Chapter IX), an allocator block (memory-pool unit, Chapter III. D. and Chapter VII), an arena block (slot-region or sub-region unit, Chapter II. C. and Chapter III. B.), a flowchart block (operational step illustrated in figures), a committed block (consensus-ledger unit per Chapter X. D.), and a SIMD or vector block (vector-instruction unit, Chapter VI). The sense is determined by chapter and surrounding context; the use of “block” in one sense does not modify the meaning of “block” in other senses. The Chapter X. D. carve-out concerning “block boundaries” and related consensus-ledger terms remains operative within its scope.

### Node.

The term “node” is used in this specification in multiple context-specific senses. References include, without limitation:
(a) the structural unit recited in the claims of this application, having a contiguously addressable slot region configured to store entries, which structural unit may be realized as a software Data Holder Node (Chapter III. B.) or as a hardware-circuitry node (Chapter II. M.), without limitation;
(b) a price-level tree node—a node of the price-level search tree, as scoped by the carve-out at Chapter VIII. A. and the corresponding carve-out at Chapters IX. A. through IX. G.; and
(c) a deployment-participant role-identifier—when appearing in Chapter X as a compound such as validator node, sequencer node, partial-replica node, shard-specific node, or state-summary node, referring to a participant in a replicated deployment context, as scoped by the Chapter X disambiguation paragraph.

References to “node” in the claims of this application refer to sub-bullet (a), unless a claim expressly recites a different context. Each use is governed by its respective context and applicable definition; the use of “node” in one sense does not modify the meaning of “node” in another sense. The carve-outs at Chapter II. M., Chapter VIII. A., Chapters IX. A. through IX. G., and Chapter X remain operative within their respective scopes.

### Engine.

The term “engine” is used in this specification in multiple context-specific senses. References include, without limitation:
(a) an order-queue storage engine—the structural unit recited in the claims of this application as an “order-queue storage engine”, configured to store entries in contiguously addressable slot regions of one or more nodes and to maintain priority indicators logically associated with the slots, as further described throughout this specification;
(b) a matching engine—a system-level matching arrangement described at Chapter Ill. A. (illustratively module 100 of FIG. 1), which may include an order-queue storage engine of sub-bullet (a) together with adjunct components such as an incoming-order queue, a core match unit, and a post-processing message queue; and
(c) a replicated engine instance—an instance of an engine of sub-bullet (a) or (b) deployed across a plurality of participants as further described at Chapter X.

References to “order-queue storage engine” in the claims of this application refer to sub-bullet (a). Where the term “engine” appears in this specification without a qualifier (e.g., bare “the engine” in chapter-local descriptive passages), the term refers to any of sub-bullets (a)-(c) as determined by surrounding context. Bare references to “the engine” do not, solely by that usage, import the components of a matching engine into a claim reciting an order-queue storage engine. Each use is governed by its respective context and applicable definition; the use of “engine” in one sense does not modify the meaning of “engine” in another sense.

### Store.

The term “store” is used in this specification in multiple context-specific senses. References include, without limitation:
(a) a store as a structural container—a noun denoting a container or repository for entries, as recited in the claims of this application (e.g., “a store realized as an order-queue storage engine”), the container being realized by an order-queue storage engine comprising contiguously addressable slot regions and priority indicators as recited in the claims;
(b) a store as a memory-write operation or instruction—a noun-verb denoting the operation of writing data to memory or an instruction performing such an operation (e.g., a CPU “store” instruction, a “non-temporal store”, a “load-linked/store-conditional” pair, or “two stores”), as used in chapter-local descriptive passages including without limitation Chapter IV., Chapter VI., and Chapter IX.; and
(c) a hardware control store—a microcode read-only memory, configuration read-only memory, or similar control-data memory used to configure hardware-circuitry behavior, as referenced at Chapter II. M. and elsewhere.

References to “store” as a structural container in the claims of this application refer to sub-bullet (a). Each use is governed by its respective context and applicable definition; the use of “store” in one sense does not modify the meaning of “store” in another sense.

### Slot.

The term “slot” (and its plural “slots”) is used in this specification in multiple context-specific senses. References include, without limitation:
(a) a slot of the contiguously addressable slot region—a position within the contiguously addressable slot region of a node, configured to store an entry comprising an order object or a reference thereto, as recited in the claims of this application and further described at Chapter II. C., Chapter II. D., Chapter II. E., Chapter III. B., and elsewhere herein;
(b) a memory-pool free slot—an allocator-bookkeeping unit for whole-object allocation in memory-pool management, as referenced at Chapter III. D. and Chapter VII.;
(c) a transport-ring slot—a cache-line-aligned or similar position within a single-producer-single-consumer (SPSC) queue, a message-queue ring, or similar transport buffer, as referenced at Chapter IV.;
(d) an order-book price-level descriptor slot—a position within an order-book price-level accelerator (OBA) descriptor memory holding a Price Level Descriptor, a Price Level Record, or related descriptor data, as referenced at Chapter IX. A. through Chapter IX. G.; and
(e) a tree-pointer slot—a child-pointer position within a node of a price-level search tree (e.g., a “null slot” or “parent slot” referenced in tree-topology operations such as insertion at the parent location preserving the binary-search-tree property), as referenced at Chapter VIII and in related descriptions of price-level tree operations.

References to “slot” and “slots” in the claims of this application refer to sub-bullet (a). Each use is governed by its respective context and applicable definition; the use of “slot” in one sense does not modify the meaning of “slot” in another sense.

### Indexing Data Structure.

The terms “indexing data structure” and “indexing structure” are used in this specification in two context-specific senses, distinguished in the claims by the presence or absence of the qualifier “price level.” References include, without limitation:
(a) a price level indexing data structure—a structure that indexes price levels of the order book to enable identification of, traversal among, or modification at price-level granularity, as recited in the claims of this application with the qualifier “price level” (e.g., “price level indexing data structure”) and as further described at Chapter VIII. A. and Chapter IX. A.-G.; and
(b) an order-identifier indexing data structure—a structure that maps each order identifier to a storage location of a corresponding entry within the order book (including within a slot region thereof), as recited in the claims of this application without the “price level” qualifier (e.g., “an indexing data structure that maps each order identifier to a storage location,” or “an on-chip indexing structure that maps each order identifier to a storage location”) and as further described at Chapter V. D. and Chapter IX. H.

References to “price level indexing data structure” in the claims refer to sub-bullet (a). References to “indexing data structure” or “indexing structure” in the claims without a “price level” qualifier, where the structure maps an order identifier to a storage location of a corresponding entry, refer to sub-bullet (b). Each use is governed by its respective context and applicable definition; the use of “indexing data structure” in one sense does not modify the meaning of “indexing data structure” in another sense.

### Sequencer.

The term “sequencer” is used in this specification in multiple context-specific senses. References include, without limitation:
(a) a replicated-deployment event-ordering primitive—a mechanism that establishes an ordering of application events for a replicated deployment (e.g., a sequencer process in a layer-2 rollup, a hosted matching-as-a-service infrastructure, or a centralized matching engine that designates one or more sequencer processes to assign canonical ordering, as further described at Chapter X. A.), as recited in the claims of this application in connection with replicated-deployment event ordering (e.g., “a sequencer” alongside total-order broadcast, a consensus protocol, or a leader-replicated log); and
(b) a fix-up micro-sequencer—a hardware control unit within an accelerator circuit that issues a bounded, fixed repertoire of micro-operations (e.g., RotateL, RotateR, Recolor, HeightAdj, or split/merge/redistribute) from a hardware control store, as referenced at Chapter II. M. and described at Chapter IX. C.

References to “a sequencer” in the claims of this application in the context of a replicated-deployment event-ordering primitive (e.g., “an event order derived from . . . a sequencer”) refer to sub-bullet (a). References to a “micro-sequencer” or “fix-up micro-sequencer” refer to sub-bullet (b). Each use is governed by its respective context and applicable definition; the use of “sequencer” in one sense does not modify the meaning of “sequencer” in another sense.

### Relationship to Chapter-Local Terminology.

This Chapter II. S. provides disambiguation for terms used in multiple context-specific senses. Unless a claim expressly recites or invokes a chapter-local sense, the claim terms identified in this Chapter II. S. are construed according to the claim-specific sense identified herein. Chapter-local definitions and carve-outs remain operative for the subject matter described in their respective chapters, but reuse of the same word in a chapter-local sense does not, by itself, import that chapter-local sense into a claim term governed by this Chapter II. S.

### Chapter III.—System Architecture (Overview with Figures)

### Chapter III. A.—Matching-Engine Modules and Flow (FIG. 1, FIG. 6-7).

The disclosed embodiments relate to a method for constructing a high-speed matching engine by integrating the techniques described herein. As used herein, a “matching engine” includes, without limitation, the matching-engine module 100 illustrated in FIG. 1, and any equivalent functional arrangement. The module 100 comprises an incoming-order queue 101, a core match unit 102, and a post-processing message queue 103 arranged sequentially so that messages flow from the order queue, through the core match unit, to the message queue.

### Chapter III. B.—Data Holder Nodes (FIG. 2).

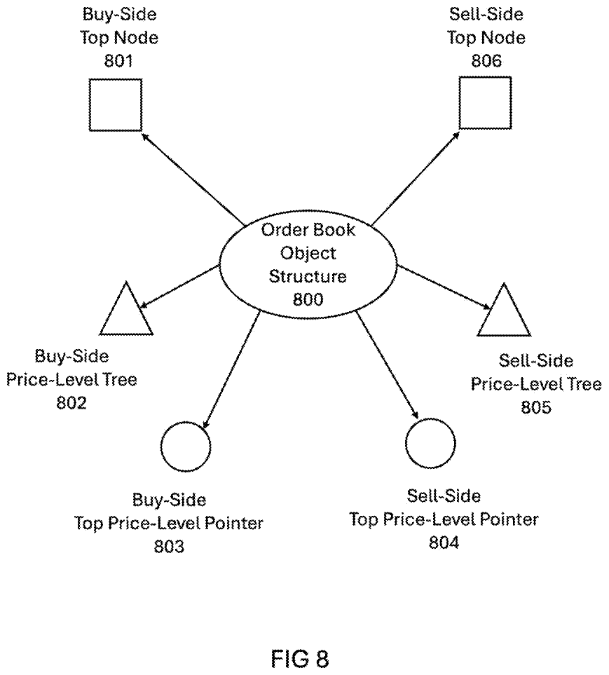

Before describing the matching process in detail, it is necessary to explain the underlying data structure of the order book 800 (see FIG. 8), including the Data Holder Node 200 (see FIG. 2), the Price Level Descriptor (see FIG. 3), and the memory pool (see FIG. 4).

### Exemplary Embodiments of Data Holder Node 200.

Referring to FIG. 2, the Data Holder Node 200 comprises the following components:
(a) an order-slot storage region that is either embedded in the node's contiguous region (FIG. 2, element 201) or stably referenced by the node to an equivalently contiguous region with invariant base and per-slot stride during normal operation, wherein normal operation comprises insert, delete, modify, in-node realignment, and directed relocation cascades, and excludes allocation, deallocation, and resizing of the slot region;
   wherein the payload of each slot is either an order object or a reference to an order object;
(b) one or more priority indicators, with exemplary representations:
   (i) an area containing Price Level Pointers 202 (for pointer-based embodiments) and/or other co-indexed per-slot fields inside the node;
   (ii) a per-node, co-indexed structure external to the node that holds the same per-slot information;
   (iii) per-slot fields embedded in the order objects stored at the corresponding slots (in-slot/embedded priority indicator), any of which may be used exclusively or in combination; or
   (iv) any of the structural-association forms set forth at Feature (a) of priority indicator in Chapter II. E.
(c) an optional metadata section 203 (which may hold node-local administrative fields and/or references to any externalized priority indicator as described in Chapter II. E.).

### Metadata Section 203.

The “metadata 203” label denotes the optional node-local administrative fields (e.g., version, count, or references to the externally located priority indicator). (See FIG. 2) The metadata may include fast-lookup information, such as the current count of orders within the node. In one embodiment, nodes are doubly linked for ease of traversal; however, a singly linked arrangement could be employed if desired, at the cost of greater implementation complexity.

### Exemplary Embodiments—Order Storage Configuration.

Continuing with the Data Holder Node, in embedded-storage embodiments, the orders 201 are stored as objects directly within the node's contiguous section rather than as pointers to externally allocated objects. In an alternative embodiment, the contiguously addressable slot region stores references to externally allocated order objects (e.g., pointers, handles, or {node,slot} tuples). In that alternative embodiment, realignment and cascades move references in slot order while the target order objects remain in place. All base/stride invariants, per-slot indicator updates, and lookup semantics are preserved. In alternative embodiments consistent with Chapter II. C., the node holds a stable reference to an equivalently contiguous slot region-either:
(a) a private allocation (e.g., the underlying storage of an std::vector<T> with predetermined maximum capacity C and no reallocation during normal operation); or
(b) a designated contiguous section [start, end) of a shared slot arena maintained for multiple nodes.

In either case, the node's indexing and any ring semantics are taken relative to its own slot region and preserve invariant base/stride during normal operation. An advantage of this storage configuration over conventional approaches is its use of a fixed-capacity block of memory (Chapter II. C.) that can hold entries with differing prices in contiguous storage, whereas traditional designs typically store an unbounded list of orders at a single price level.

### Exemplary Pointer-Based Embodiment.

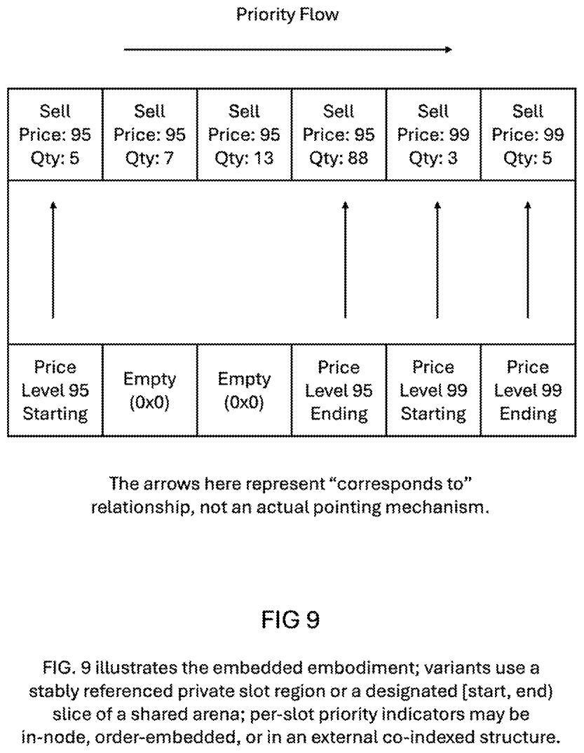

In the pointer-based embodiments, the Data Holder Node 200 implements the priority indicator as a co-indexed array of Price Level Pointers 202. For each price level, the start/head and end/tail anchors are recorded by pointer entries that occupy the slots corresponding to the highest- and lowest-priority orders at that level (see FIG. 9); the pointer array may reside inside the node or in an external per-node structure addressed by the same logical slot indices. The term “Price Level Pointer” is used in the genus sense of reference as defined at Chapter II. A. and is typically realized as a pointer to an externally allocated Price Level Descriptor; the node does not embed the descriptor objects, which are maintained separately (e.g., in a dedicated memory pool). This arrangement reduces node-local memory and preserves stable references needed by the price-level tree described at Chapter III. C. In one configuration, each level maintains two pointers-start/head and end/tail (FIG. 9); an alternative keeps only an end/tail pointer, simplifying maintenance but foregoing certain constant-time operations (e.g., an O(1) jump to the head of the queue).

### Priority Indicators.

Consistent with Chapter II. E., the priority indicator may reside inside the node or in an external, per-node co-indexed structure (per the in-node/external-co-indexed alternatives set forth in the priority-indicator enumeration at Chapter II. E., Feature (a)).

### Dual/Single Priority Tracking—Exemplary Pointer-Based Embodiment.

Because a single order can represent both the highest and lowest priority if it is the only order at its price level, each order may occupy two pointer slots in the Price Level Pointer holder 202 of the pointer-based embodiment. Thus, when both highest- and lowest-priority pointers are employed, the number of pointer slots can be twice the number of order slots 201. Conversely, if only the lowest-priority pointer is used, the pointer slots match the number of order slots. Note that the Price Level Pointer holder (element 202) only exists for pointer-based embodiments, as other embodiments may use different per-slot tracking methodology (e.g., bitmask).

### Priority Indicators in Exemplary Pointer-Based Embodiments.

In the exemplary pointer-based embodiments, when multiple orders occupy the same price level, the container that stores the Price Level Pointers can have unused slots between the highest-priority and lowest-priority orders (see FIG. 9). Each pointer occupies a fixed slot position in the node's logical slot index space (per the in-node/external-co-indexed alternatives set forth in the priority-indicator enumeration at Chapter II. E., Feature (a)).

### Update of Priority Indicators.

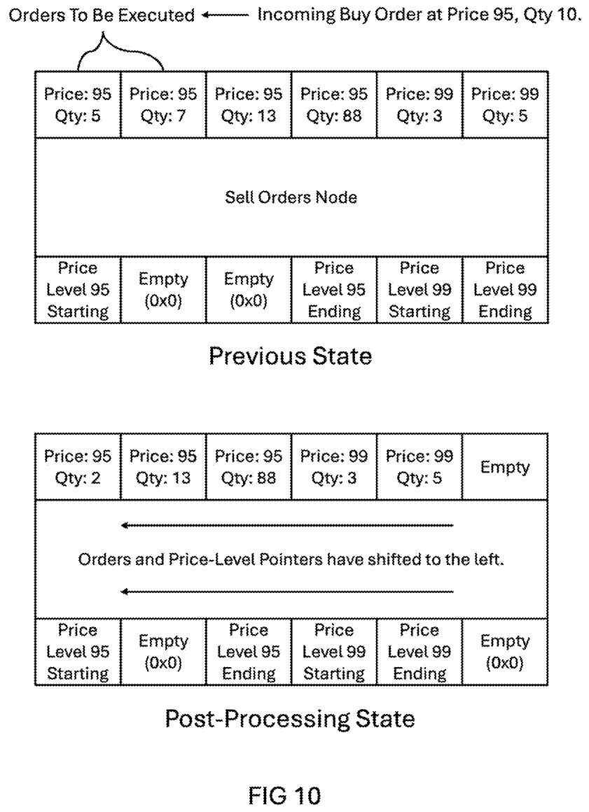

Whenever an execution, insertion, or cancellation changes the order sequence, the priority indicator is updated to ensure coherency. In pointer-array variants, the update is performed by moving or rewriting pointers in the internal array or in the external co-indexed array; in bitmask variants, by shifting and/or toggling flag bits (see Chapter II. E. and FIGS. 15-18). In slot-index-addressed or co-located realizations, the mapping from the node's logical slot indices to the priority indicator positions remains coherent upon completion of such update (see FIG. 10); for register-based realizations, the register's structural identity as a priority predicate is preserved, and for designated-position realizations, the designated slot positions and the encoding of priority status by occupancy are preserved. For example, if the current highest-priority order is removed, the pointer in the “highest” slot now references the next-highest order, while the “lowest” pointer is updated if a new order is appended at the back.

### Chapter III. C.—Price Level Descriptor (FIG. 3).

A Price Level Descriptor includes a metadata section containing the price level itself, the total quantity at that level, and one or more references (genus per Chapter II. A., e.g., pointers, indices, or handles) to the Data Holder Node that currently holds either the highest-priority or lowest-priority order of its price level (depending on the reference's role). The Price Level Descriptor may further include left-child, right-child, parent, predecessor, and successor references that realize the in-order neighbor links of the price-level indexing tree, as set forth at Chapter II. K. Additionally, the Price Level Descriptors are organized as a tree structure (see FIG. 3) to achieve O(log n) lookups when searching for the nearest available price. While one embodiment uses a red-black tree implementation, any balanced tree, whether binary tree (e.g., AVL tree) or not (e.g., B+-tree), is viable, provided it supports O(log n) searching for the closest price. It should be noted that AVL trees often require more frequent rebalancing, which can introduce additional overhead compared to red-black trees. Therefore, the choice of tree structure depends on the exchange's performance requirements and tolerance for rebalancing costs. The trees are constructed on each side of the order book (Buy and Sell) and their roots 802 and 805 are encapsulated in the Order Book object structure 800. (see FIG. 8) As part of its cache warming strategy, one embodiment preloads the tree's traversal path into the L3 cache, enabling efficient read access for subsequent lookups.

### Chapter III. D.—Memory Pools and Allocator Model (FIG. 4-5).

As illustrated in FIG. 4, in one embodiment, the engine uses a memory pool that allocates memory in large contiguous pages-typically 2 MB, but configurable to 1 GB or any hardware-supported huge page sizes, whenever the host operating system and processor support those huge pages. These pages are obtained via page allocation (401) according to the system's huge-page configuration, ensuring optimal memory management and performance. Within each allocated page, the memory is subdivided into fixed-size blocks (402) that store multiple objects (403) of a predetermined type.

### Overview of the Memory Pool Architecture.

Each block is designed to hold a specific number of objects, and its structure is optimized to minimize memory fragmentation and maximize cache locality. The custom block allocator is responsible for mapping and unmapping these large pages. When a block becomes fully occupied, it is removed from the free list; conversely, if a block becomes entirely empty, its parent page is unmapped and returned to the operating system.

### Object Preconstruction.

In one embodiment, the objects are preconstructed within each block at the time of block allocation. Rather than constructing a new object on each assignment request, the pool simply returns a pointer to an already constructed object within the pre-allocated block. This eliminates the runtime overhead of object construction, thereby speeding up the allocation process—an advantage in environments where every nanosecond counts.

### Bookkeeping of Free Slots.

Within each block of one embodiment, free slots are tracked using an array that is directly allocated as part of the block's memory, avoiding an extra heap object for the tracker. This choice concerns the pool's free-slot bookkeeping only and does not constrain the Data Holder Node's order-slot implementation (e.g., an std::vector with reserved capacity C as described in Chapter II. C.). When an object is released, its slot index is returned to this array, ensuring that free slots are efficiently managed and immediately available for reuse. This method of in-block free slot management helps maintain a high level of cache efficiency, as all relevant data remains in a contiguous memory region.

### Use of Huge Page.

By basing page allocations on the system's huge page configuration—2 MB, 1 GB, or any hardware-supported huge page sizes—the memory pool is highly adaptable to various hardware environments. Large page allocations reduce the frequency of TLB misses and improve memory bandwidth, which is essential for the performance of data-intensive applications like matching engines. The combination of preconstructed objects, efficient block-level management, and in-block free-slot tracking creates a scalable, low-latency memory management system.

### Core-Specific Memory Pool.

In one embodiment, each memory pool object is core-specific, rather than shared among multiple processor cores. This design choice avoids the overhead of implementing thread-safe concurrency within the memory pool itself, thereby reducing latency for high-throughput operations. However, it may result in higher overall memory usage if certain cores process fewer orders than others—some pools may remain underutilized while others are at capacity. To address this imbalance, each pool can request a page size tailored to its core's anticipated order volume: for example, 1 GB or larger huge pages for the busiest cores, 2 MB pages for typical traffic, or the standard 4 KB page size when order flow is light. Most modern operating systems support multiple huge-page sizes concurrently, so per-core page sizing lets the exchange minimize waste while preserving the latency benefits of core-local, lock-free memory pools.

### Node Pool and Huge-Page Growth.

In one embodiment, new nodes are first drawn from a per-core node pool. When the pool is empty, the default behavior is to allocate a huge-page-backed block (non-limiting: 2 MB or 1 GB) and populate it with pre-constructed nodes, then replenish the pool and continue the operation. Allocation can be performed without blocking the matching core's critical section if the memory allocator uses a different core than the matching engine's core. If the OS cannot supply memory, the system treats the event as capacity exhaustion and applies the deployment policy (e.g., slow-path enqueue or fail-closed with a retry status).

### Exemplary Linux Implementation.

In an exemplary Linux implementation, the engine pins each core-match thread to its dedicated CPU with sched_setaffinity( ), binds the thread's memory policy to the corresponding NUMA node via set_mempolicy( ), and calls mmap( ) with the appropriate flags. Because the kernel maintains separate pools for every huge-page size, a heavily loaded core can request 1 GB or larger pages while a lightly loaded core maps only 2 MB or 4 KB pages, thereby tailoring TLB coverage to real-time demand without sacrificing core-locality or incurring cross-core locks. Exemplary out-of-memory policy may include the following sequence: upon exhaustion of huge-page arenas, or in configurations where policy prohibits allocation of 1 GB pages, the allocator attempts allocation with 2 MB pages, followed by 4 KB pages; if all such attempts fail, the engine generates a failure-closed status. Blocks may utilize last-in, first-out (LIFO) free-lists to preserve cache locality, and whole-page reclamation may be governed by a hysteresis threshold configured to reduce or prevent reclamation-induced page churn.

### Chapter IV.—Data Transport

### Chapter IV. A.—Queue Semantics (SPSC/SPMC/MPSC/MPMC; Invariants).

The three components introduced above—the inbound order queue 101, the core match unit 102, and the post-processing message queue 103—may be interconnected by any lock-free data-transport topology suitable for deployment constraints. Exemplary queue categories include SPSC, SPMC, MPSC, and MPMC as defined below. For exposition, a “ticket” denotes a conceptual, monotonically increasing identifier associated with each enqueue; implementations may realize tickets via index counters, per-cell sequence fields, or other mechanisms.

### Queue Structure and Cache Geometry.

In one embodiment, the write index, read index, and their private cache copies reside on distinct cache lines to eliminate false sharing. Index updates use release-ordered stores on the writer side and acquire-ordered loads on the reader side, guaranteeing producer-to-consumer visibility without full memory fences. Each payload slot is aligned to the processor's cache-line width, so every element occupies exactly one line; this alignment simplifies both direct-memory-access (DMA) bursts in zero-copy mode and vector-instruction loads/stores in copy-optimized mode.

### Single Producer, Single Consumer (SPSC);

As used herein, an SPSC queue is a bounded queue of capacity C with exactly one producer thread and one consumer thread, that is lock-free (arbitrary delay of either thread does not prevent the other from making progress) and satisfies:
(a) a payload becomes readable only after the producer publishes it via a store that establishes visibility to the consumer (e.g., release→acquire);
(b) a slot is eligible for reuse only after the consumer publishes its release; and
(c) operations appear in FIFO order with respect to enqueued items.

This definition does not require a particular publication scheme and encompasses head/tail index schemes, per-cell sequence schemes, or other logic that satisfies these invariants.

### Single Producer, Multi Consumer (SPMC);

An SPMC queue has exactly one producer and one or more consumers; it is bounded and lock-free in that arbitrary delay of any single consumer does not prevent the producer or at least one other consumer from making progress. It satisfies:
(a) publish/observe and reuse invariants as above;
(b) at-most-once consumption—each enqueued item is consumed by no more than one consumer; and
(c) a total order consistent with enqueue tickets for the logical queue.

This definition encompasses per-cell sequence gating with atomic consumer claims, sharded SPSC rings (one per consumer) with deterministic dispatch together with a global ticket source or merge policy that preserves the logical order, or other logic satisfying these invariants.

### Multi Producer, Single Consumer (MPSC);

An MPSC queue has two or more producers and exactly one consumer; it is bounded and lock-free in that arbitrary delay of any single producer does not prevent the consumer or other producers from making progress. It satisfies:
(a) publish/observe and reuse invariants as above;
(b) unique-slot acquisition for enqueues (no two producers publish to the same slot for the same ticket); and
(c) FIFO order as observed by the single consumer.

This definition encompasses per-cell sequence schemes with a shared atomic enqueue ticket (e.g., fetch_add on a tail counter), per-producer SPSC rings combined by a fair combiner, or other logic satisfying these invariants.

### Multi Producer, Multi Consumer (MPMC).

An MPMC queue has two or more producers and two or more consumers; it is bounded and lock-free such that arbitrary delay of any single thread does not prevent system-wide progress. It satisfies:
(a) publish/observe and reuse invariants as above;
(b) unique-slot acquisition for enqueues and at-most-once consumption for dequeues; and
(c) a total order consistent with enqueue tickets for the logical queue.

This definition encompasses per-cell sequence schemes with atomic enqueue/dequeue tickets, or sharded MPSC/SPMC fabrics with deterministic hashing plus a global ticket source or merge policy that preserves the logical order, or other logic satisfying these invariants.

### Non-Limiting Note.

The foregoing are genus-level definitions aimed at external semantics. Specific algorithms are exemplary only; unless expressly stated, these terms do not exclude other implementations that satisfy the stated invariants.

Chapter IV. B.—Zero-Copy Vs. Copy-Optimized Modes; SIMD_COPY Routine.

The queue supports two strategies:
(a) Zero-copy mode: The producer constructs each payload directly inside the destination slot; the consumer obtains a pointer to that slot, processes the object in place, then retires the slot by advancing the read index. Only the index moves in software. The same physical buffer can be exposed through
   (i) a NIC receive ring whose DMA engine writes messages into the ring,
   (ii) a shared-memory mailbox resident in the last-level cache of a NUMA node,
   (iii) an on-chip inter-core fabric that maintains cache coherence, or
   (iv) an RDMA write window registered for remote access.
(b) Copy-optimized mode: When system tuning indicates that an explicit copy gives lower tail-latency, the consumer performs a single, cache-aligned SIMD_COPY of the payload into a local scratch area before processing (e.g., AVX, NEON, or other SIMD-based block moves, as illustrated by SIMD_COPY in the section below). Because there is at most one copy—and it spans the exact cache line that contains the object—this mode remains lock-free and cache-friendly.

### Baseline Configuration.

In all cases, the transport preserves lock-free queue semantics and is configured to reduce cache invalidation traffic and thrashing. Regardless of the chosen combination, the system routes each incoming order to its designated core match unit 102 and returns acknowledgments and trade confirmations to queue 103, using cache-line-aligned slots, NUMA-aware memory placement, and, where applicable, non-temporal stores to reduce latency and contention.

### SIMD_COPY Routine.

To move bulk data efficiently, the system invokes a platform-optimized routine referred to herein as SIMD_COPY. All memory regions handled by this routine-including the contiguous order-slot regions referenced by each Data Holder Node and the ring-buffer elements used by the incoming-order and post-processing message queues—are aligned to the machine's cache-line size (typically 64 bytes). This alignment enables each cache line to be copied with a small, fixed number of vector instructions per line (e.g., one vector load and one vector store). In a non-limiting x86 implementation: when the processor supports AVX-512, SIMD_COPY issues 512-bit loads and stores (moving 64 bytes per vector operation); if AVX-512 is unavailable, it falls back to AVX2 (256-bit), then SSE2/SSE (128-bit), and ultimately to a standard memory-copy path when wider SIMD is not available. Optionally, for large forward-only transfers, SIMD_COPY may use non-temporal (streaming) stores to reduce cache pollution; otherwise it employs temporal stores to preserve locality.

### Trivially Copyable Objects and Overlapped-Region Correctness.

By treating each movable object as trivially copyable and operating on cache-line-sized chunks (or integral multiples thereof)—and by assuming non-overlapping regions or using memmove-style overlapped-region correctness when overlap is possible—the routine accelerates both intra-node order realignment and inter-thread message transport while remaining portable across architectures. (On non-x86 targets, the routine uses the widest available vector width, e.g., NEON/SVE on ARM or VSX on POWER.)

### Shifting of Small Data.

In addition to moving bulk data, the system also shifts pointer values—often 8 bytes each—between nodes or within the same node. Because these pointer updates are comparatively small (normally, one 64-bit word), they remain very fast even if SIMD instructions are not used. In particular, aligning these pointer slots to at least 8-byte boundaries ensures minimal overhead during pointer swaps or adjustments. This is critical when reassigning Price Level Pointers, updating doubly linked lists, or performing other pointer-based operations (e.g., re-linking nodes after an order is canceled or executed). By carefully managing both large data moves with SIMD and pointer realignments, the system maintains high throughput while minimizing latency throughout the matching process.

### Chapter IV. C.—Cache/NUMA Policy; Non-Temporal Writes; Prefetch Patterns.

If the producer and consumer reside on different NUMA nodes, or if any architectural or system requirement from either the processor or the memory subsystem so dictates, the producer may issue non-temporal store instructions (for example, x86 MOVNTDQ) as illustrated in FIG. 5, such that modified cache lines bypass the producer's private caches and are written directly to the memory controller attached to the consumer's socket. Non-temporal writes are particularly useful when the stored messages do not require retention in the producer's cache. As a general rule of thumb, non-temporal writes may be employed for large, streaming writes that will not be read by the producer in the near term; conversely, they may be avoided on systems with an inclusive last-level cache or when write-combining buffers could introduce undesirable latency, in order to prevent additional DRAM round-trips. Regardless of the policy selected, the queue maintains its lock-free progress guarantees.

### Prefetch and Cache Residency.

The consumer maintains a flag indicating whether the next slot is resident in L1. If it is not, and when multiple elements remain in the queue, the consumer prefetches the next slot's cache line to overlap memory latency with business logic. Where a copy is performed, the consumer uses a single SIMD_COPY transfer of the cache-line-aligned payload before processing. After processing, the consumer releases the slot by advancing the read index.

### Chapter IV. D.—Cache Warming/Cache-Line Alignment/Data Correctness.

As part of the cache-warming strategy, the system performs a storage-realignment routine that compacts orders within the node's order-slot region—embedded or stably referenced per Chapter II. C.—to open contiguous free space for upcoming inserts. The routine validates the target insert offset and the current order count, then selects a movement strategy based on the shift distance and the hardware's cache-line geometry. It prefetches cache-aligned lines for both the order slots and the priority indicator (e.g., Price Level Pointer slots or bitmask words), whether the indicator resides inside the node or in an external array addressed by the same slot indices, and moves data in vector-width blocks via the SIMD_COPY path with scalar fallbacks as needed. When regions overlap, moves use memmove-style overlapped-region correctness to preserve correctness (see Chapter IV. B.—Zero-copy vs. copy-optimized modes; SIMD_COPY routine). The routine updates the associated priority indicators—preserving, for slot-index-addressed, co-located, register-based, or designated-position realizations, the structural association set forth at Chapter II. E. and Chapter III. B.—so that subsequent Append and Prepend operations (Chapter V. A.) typically proceed without further realignment on the hot path. (FIG. 10 illustrates the pointer-based variant; FIGS. 16-20 illustrate the bitmask variant.) When slot payloads are references, the realignment routine moves only pointer-sized values; order objects remain stationary. The priority indicators are updated as described below to preserve, for slot-index-addressed, co-located, register-based, or designated-position realizations, the structural association set forth at Chapter II. E.

### Compile-Time Code Path Optimization.

Depending on the ratio of cache line size to order size, the function selects different code paths using compile-time conditions (e.g., C++'s constexpr if). It aligns prefetching to cache line boundaries and shifts orders in blocks via SIMD-based operations. Prefetching is executed in write mode and directed to the L1 cache to ensure immediate data availability and maximize performance.

### Data Correctness and Internal Consistency.

After shifting the order data, the function updates the priority indicator so that, for slot-index-addressed, co-located, register-based, or designated-position realizations, the structural association set forth at Chapter II. E. is preserved. In pointer-array embodiments, this is realized as a safe memory-move of the co-indexed segment (e.g., memmove in C++). When the priority indicator is externalized (per-node array or a designated region of a shared indicator arena with invariant base/stride), the same move is applied to that external region; if the region uses ring semantics, the move is executed as two bounded segments that straddle the [start, end) boundary. In bitmask embodiments, the update is performed by word operations that shift and/or toggle the affected mask bits rather than relocating storage (see Chapter VI. C.-E. and FIGS. 16-20). In sparse/compressed encodings, moves may materialize or re-elide neutral segments; elision does not change semantics because elided indicator values read as neutral by definition of Chapter II. F. An internal consistency check (e.g., a debug-only assertion) then verifies, for slot-index-addressed, co-located, register-based, or designated-position realizations, the structural association set forth at Chapter II. E., together with applicable invariants (occupancy superset and head/tail uniqueness), and—for pointer-based variants only—that each pointer still resolves to the Price Level Descriptor at the expected price. Together with the foregoing prefetch/realignment, this routine maintains indicator coherency while minimizing cache misses. When a configuration uses embedded priority indicator, the realignment step that moves order payloads moves the embedded indicator implicitly with those payloads. For variants that also maintain aggregate masks (e.g., head/tail), the routine additionally shifts/toggles the affected mask bits to preserve invariants.

### Chapter V.—Core Operations (Policy-Agnostic)

### Chapter V. A.—Append and Prepend (Defined Against the Rule-Defined Reference).

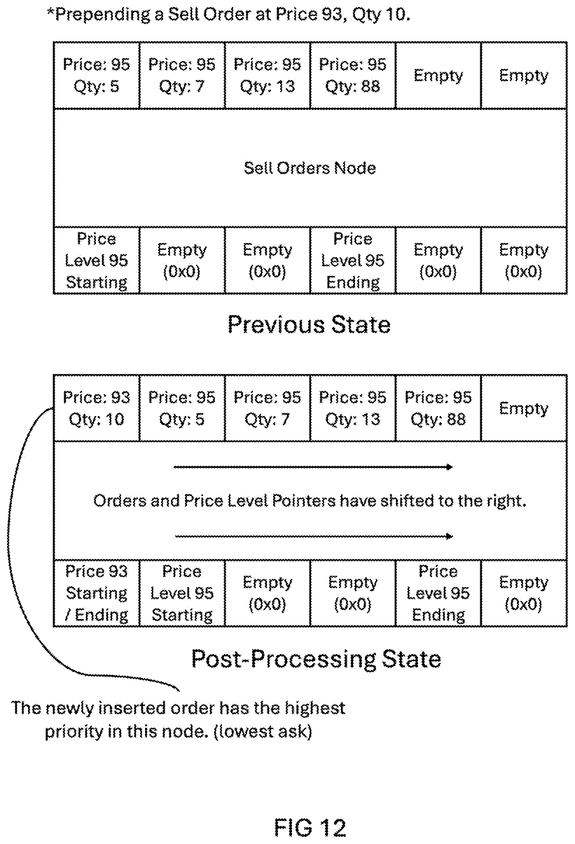

The placement operators Append and Prepend, defined at Chapter II. B. with respect to the level's rule-defined reference, are illustrated for pointer-based embodiments at FIG. 11 (Append) and FIG. 12 (Prepend). In each operator, the in-node placement and the resulting priority-indicator update may each be performed in per-operation constant-bounded work (Chapter II. G.), exclusive of any preceding price-level tree lookup or rebalancing; when the target node is full, the operator may trigger the directed Push Back/Push Forward cascades described below (see also avoidance-of-doubt clause at Chapter II. B.). Unless physical adjacency is expressly recited, “immediately after” and “immediately before” in the definitions of Append and Prepend refer to position in the priority sequence relative to the applicable rule-defined reference, and do not require that the written slot be physically adjacent in memory to the reference slot.

### Chapter V. B.—Directed Relocation Cascades (Push Forward/Push Back); Hop Bound; Exemplary New-Node Attach at Boundary.

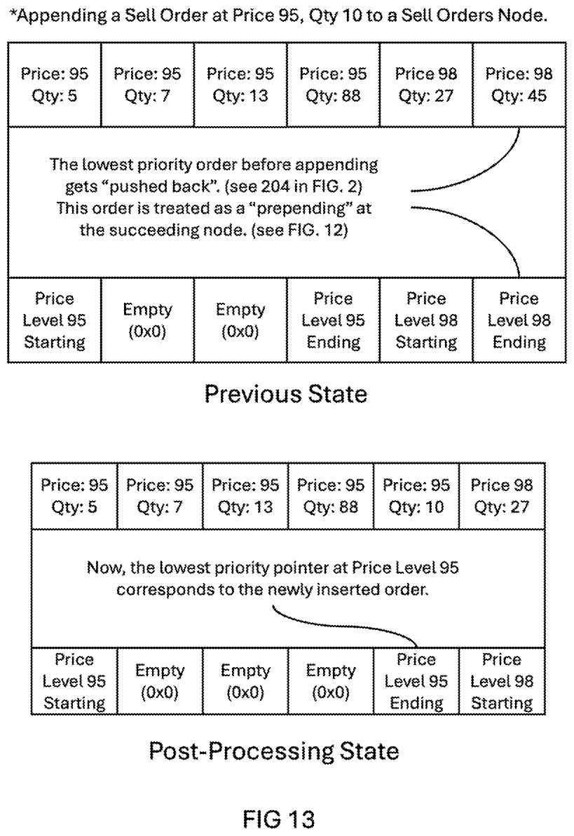

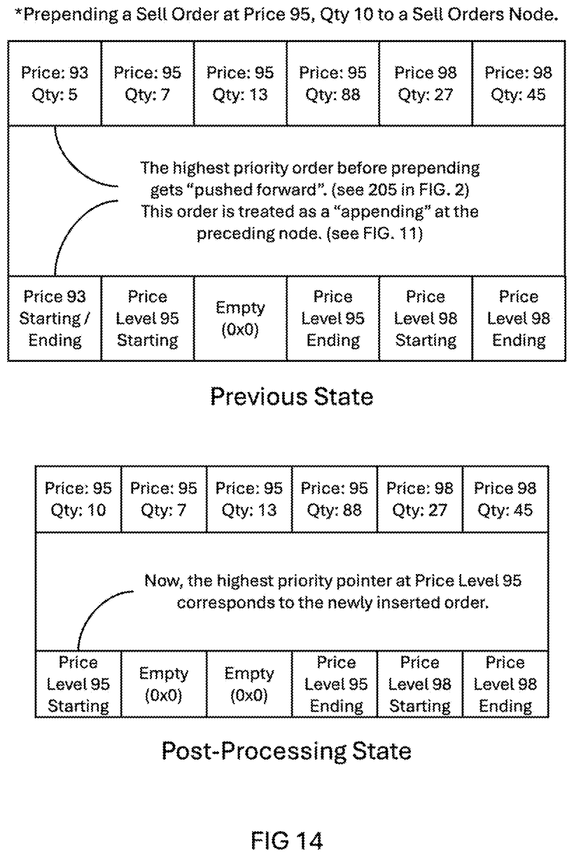

Beyond Append and Prepend, the Data Holder Node supports two relocation operations—Push Back (204) and Push Forward (205)—to keep nodes orderly across the book. In pointer-based embodiments (FIG. 2, FIG. 13, FIG. 14), a relocation moves exactly one order together with its Price Level Pointer (or null if none) in constant-bounded time. In other embodiments within the priority-indicator genus of Chapter II.E (e.g., bitmask, encoded-index-register, embedded-field, or designated-position realizations), the analogous relocation updates the corresponding indicator state (e.g., bit positions, encoded slot indices, embedded fields, or designated occupancy) by constant-bounded operations as set forth in Chapters VI.C-E and Chapter II.E.

### Push Back and Push Forward Relocation.

Push Back relocates one order to the next node toward the tail when an Append targets a full node, and the relocated order is treated there as a newly prepended order (FIG. 13). Push Forward relocates one order to the previous node toward the head when a Prepend targets a full node, and the relocated order is treated there as a newly appended order (FIG. 14). In one embodiment, the relocated order is selected by comparing the incoming order's priority with the boundary slot (last slot for Push Back; first slot for Push Forward) and relocating the lower-priority (Push Back) or higher-priority (Push Forward) order; other selection policies are within the scope of this disclosure.

### Directed, Bounded Cascades.

In one embodiment, when an Append or Prepend would exceed a node's capacity, the system executes a one-directional relocation cascade to free a slot, as one realization of the capacity overflow handling logic. A Push Forward cascade proceeds only toward the head of the book; a Push Back cascade proceeds only toward the tail. The direction is chosen by the operation and never reverses during the cascade. The cascade is bounded to at most a configured maximum hop count (denoted Dmax∈[0, ∞) for convenience); at most Dmax adjacent nodes are visited. Each hop relocates a single order into the next node in that direction and updates the affected node's priority indicator (e.g., the node's array of Price Level Pointers, status descriptor bitmasks, or others) in constant-bounded time. Cascade ordering is deterministic within a symbol; no interleaving reorders the priority sequence defined by the predetermined priority rule.

### Default at the Hop Limit.

If no free slot is found within the configured maximum hop count (Dₘₐₓ), the default behavior is to add a new node in the order book chain at the cascade boundary in the same direction (at the head for Push Forward; at the tail for Push Back) and place the relocating order there. This converts a limit-reached condition into successful completion without reversing direction. Linking the node may adjust predecessor/successor pointers and per-node priority indicator in constant time and then commits the mutation log. Note: Appendix B establishes that cascades terminate even without a hop cap; the configured maximum hop count (Dₘₐₓ) is used to bound worst-case latency, not to ensure termination.

### Invariants and Bounds.

Throughout success, pool growth, or rollback, the following hold: a node's order counts never exceed its capacity; predecessor/successor links and priority indicator remain consistent after each committed hop; the ordering defined by the predetermined priority rule within a node is preserved; and cascades are non-reentrant per price level. Because direction is monotonic and the configured maximum hop count (Dₘₐₓ) is constant, the worst-case cascade cost is deterministic and bounded (within the meaning of Chapter II. G.).

### Capacity Overflow Handling Logic—Genus of Realizations.

The capacity overflow handling logic recited in the independent claims is realized in this specification by any mechanism that, when the selected node lacks a free slot for an operation, yields a selected slot in any of the nodes—including without limitation:
(a) a directed relocation cascade that moves entries across existing nodes until a free slot is obtained, as described in this chapter;
(b) a directed cascade with new-node attach at the cascade boundary, as described in this chapter;
(c) allocation of a distinct new node for the insertion or reinsertion without a preceding cascade, the new node being drawn from any of the allocation sources described at Chapter III. D or Chapter VII. E, or from a heap or other allocator;
(d) expansion, reservation, commitment, or designation of additional slot capacity for the selected node without relocating the previously stored entries of the selected node, including by advancing a high index, high address boundary, or other slot-region boundary while preserving the slot identities and base/stride-addressed locations of the previously stored entries;
(e) a combination of the foregoing, selected according to configuration (for example, cascade-first with new-node fallback, or new-node-first with cascade fallback); or
(f) any other mechanism that yields a free slot in an existing node or in a distinct newly allocated node for performing the operation.

Clarification regarding the scope of “capacity overflow handling logic” genus. The selection among realizations is an implementation choice and does not affect the scope of the capacity overflow handling logic as recited in the claims. For the avoidance of doubt, the phrase “a node allocated for the insertion or reinsertion” as recited in the claims is intended to read on any realization in which a distinct new node is allocated or designated as part of resolving the insertion or reinsertion, including without limitation allocation of a new node at the cascade boundary and allocation of a new node without a preceding cascade. For further avoidance of doubt, capacity overflow handling logic does not encompass capacity growth, reallocation, or resizing of the selected node's own slot region, or of a backing container for that slot region, that causes the previously stored entries of the selected node, as a group, to occupy slot identities or storage locations different from the slot identities or storage locations they occupied before such growth, reallocation, or resizing, where such growth, reallocation, or resizing is performed as part of resolving, or in preparation for resolving, the insertion or reinsertion. This exclusion does not preclude the non-relocating expansion, reservation, commitment, or designation of additional slot capacity described in item (d).

### Chapter V. C.—Order Matching.

The following section describes the algorithms employed by the core match unit 102. Referring to FIG. 6, the processing logic flow for the core matching process is illustrated. In one embodiment, when an order arrives (601), the system sends an order acknowledgment to the post-processing message queue 103. Next, it processes any special-order designations associated with the incoming order (602). Examples of such designations (603) include Immediate-Or-Cancel (IOC) and Fill-Or-Kill (FOK), as defined by the exchange's rulebook and supported order types. The system then checks for any matchable order on the opposite side (604). In one embodiment, the presence of a matchable order is confirmed by determining whether the top priority Price Level Pointer on the opposite side is active. Because the order book structure 800 maintains the references to the highest-priority (lowest ask and highest bid) Price Level Descriptors for both sides (803 and 804), the relevant pointer address is often stored in the processor's register, making the lookup operation fast. Although the system could also inspect the top Data Holder Nodes on each side (FIG. 8, elements 801 (Buy side) and 806 (Sell side)), it is preferable to avoid reading the underlying memory content to reduce latency. Instead, checking only whether the pointer address is null suffices to confirm availability.

### Order Execution Sequence.

Once a matchable order is identified, the system enters an iterative process to execute orders based on a selected priority policy (605). Supported priority policies may include, without limitation, first-in first-out (FIFO), pro-rata, size-time, and parity-based approaches, and the policy-specific logic may be encapsulated within a strategy object or equivalent policy hook, thereby permitting policy substitution without altering the surrounding matching framework. For each execution, the engine emits a trade signal to the post-processing message queue 103. If a price level is exhausted (i.e., no remaining orders at that level), the corresponding Price Level Descriptor is returned to the memory pool. Similarly, if all orders in a Data Holder Node are depleted, that node is returned to the pool. This prompt reclamation of unused resources ensures high performance and efficient memory utilization throughout the matching process. Once no further orders can be matched, the system proceeds to the order insertion step (606), which transitions to the order insertion process (701) of FIG. 7, if any remaining quantity exists on the incoming order; otherwise, it exits the process. The foregoing operations and data structures (Append/Prepend, cascades, and priority indicators) are policy-agnostic: the rule-defined reference and the priority indicator semantics are instantiated by the selected priority rule (e.g., FIFO/price-time, pro-rata, size-time, parity) without changing any constant-bounded indicator-update property.

### Chapter V. D.—Order Insertion/Modification/Cancellation/Storage of Lookup Information.

FIG. 7 outlines the order-insertion process. At step 701 the system determines whether the incoming order's price level already exists in the order book. Two alternative lookup paths are available, and the exchange may enable either or both at configuration time:
(a) Baseline path—Tree lookup: The system performs an O(log n) search in the balanced Price Level Descriptor tree;
(b) Optional path—Auxiliary hash map: If enabled, the system first performs an O(1) lookup in a hash map keyed by price level and consults the tree only when the hash result is null. Using either configuration (tree-only or dual tree-plus-hash map), once a price level is found, the system appends the order to that level. If the price level is absent, control passes to the special case flows in steps 702 and 703. In alternative embodiments, the processing order of steps 702, 703, and 704 may be rearranged to address these cases more efficiently on a given hardware platform. The optional hash map trades a modest increase in memory for predictable per-query constant-time existence checks on heavily traded symbols (the per-query hash-map lookup itself is constant-bounded; this does not eliminate other components of the end-to-end insertion path, including any tree maintenance). However, the performance improvement must be measured on the specific system to justify the added complexity.

### Case 702 (First Ever Order).

This situation arises when the book is empty on the given side (e.g., Buy or Sell). It always involves creating a new Data Holder Node since there are no existing nodes for that side. Because this scenario is relatively rare, the implementation can optimize branch prediction accordingly.

### Case 703 (New Highest Priority).

If the incoming order's price resets the highest-priority level (lowest ask or highest bid), the system performs Prepend rather than Append. It locates the current highest-priority reference (e.g., Price Level Pointer in the pointer-based embodiment, or the corresponding indicator position in bitmask, encoded-index-register, embedded-field, or designated-position realizations within the priority-indicator genus of Chapter II.E) and accesses the corresponding Data Holder Node to place the new order at the front. In some instances, no new Data Holder Node is assigned from the memory pool here—only the prepending operation on the existing node for the current highest priority. In addition, a new Price Level Descriptor is allocated for the new highest-priority price level and is inserted into the descriptor tree (and the auxiliary hash map, if present), as set forth below for the in-order-neighbor insertion path.

### Case 704 (In-Order Neighbor Price Level Search).

For orders whose price level is not present in the book and is not the highest priority, the system locates the appropriate insertion point by performing a ceiling operation (for buy orders) or a floor operation (for sell orders) to identify the in-order neighbor (predecessor) price level. Once the predecessor price level is identified, the system performs an append at the Data Holder Node that contains the end of that level's order list. Implementation note: depending on node layout, the order may be placed in a slot that is physically adjacent to the neighbor level's tail within the same Data Holder Node; it remains a distinct price level and is not part of the neighbor level's order list. Whenever a new Price Level Descriptor is assigned—whether in Case 702, Case 703, or this general insertion path—the system:
(a) places the descriptor in the Price Level Descriptor tree (rooted at element 802 (Buy side) or 805 (Sell side) in FIG. 8) to preserve O(log n) ordering and;
(b) writes an entry to the auxiliary hash map (if present) so that future existence checks can execute in O(1) time. Likewise, when a price level is exhausted, its descriptor is removed from both the tree and, if applicable, the hash map. This synchronized maintenance ensures that the two data structures remain consistent while allowing the exchange to select the latency-memory trade-off that best fits each trading symbol.

### Storage of Order Lookup Information.

In one embodiment, the system maintains, in memory, an indexing data structure (e.g., a hash map) that maps each order identifier to a storage location of a corresponding order entry within the order book, the indexing data structure being updated in response to insertion, removal, or relocation of the order. The storage location may include, for example, (i) an identifier of a Data Holder Node that contains the order entry, (ii) a direct pointer or offset to the entry's memory within that node, or (iii) any equivalent reference. During insertion, the structure records the storage location for the incoming order, ensuring O(1) lookups. The key is the order's unique identifier; the value encodes the storage location, which may include a Data Holder Node reference and any information that identifies the order's physical placement. This mapping enables efficient subsequent operations—such as order cancellation and order modification—because it allows the system to quickly locate and update the relevant order. For relocation operations—including Push Back (204) and Push Forward (205)—the indexing data structure is updated to reflect the new storage location (e.g., a different Data Holder Node). In the reference-payload variant, the mapping may point directly to the external order object while a companion entry continues to track the storage location that carries the reference; both are updated on relocation.

### Order Cancellation.

For order cancellation, the system locates the Data Holder Node containing the order using the indexing data structure described above, then proceeds to cancel the order. At the Data Holder Node level, this cancellation process mirrors order execution: the specified order is removed or invalidated, and if it was the highest or lowest priority at that price level, the corresponding slot priority indicator (Price Level Pointer, in the pointer-based embodiment) is also deleted or adjusted. In one embodiment, the remaining orders in the node are then rearranged to reflect their updated priorities; in alternative embodiments, the orders remain in place and the priority indicators are updated to reflect the vacancy. Finally, once the order is successfully canceled, a signal is emitted through the post-processing message queue 103. In configurations with embedded priority indicator, cancel/removal clears or rewrites the embedded fields in the removed order (or relies on object destruction), and any aggregate co-indexed indicators (if present) are updated accordingly.

### Order Modification.

Order modification is implemented using a two-tiered approach. First, the system locates the Data Holder Node containing the order using the indexing data structure described above. In one embodiment that follows conventional exchange practice, a modification request that only reduces the order's quantity leaves the order's original time-priority in the limit-order book unchanged. Accordingly, the matching engine merely locates the order at its current node and overwrites the stored quantity value; no re-queuing or re-timestamping is required. Conversely, when the amendment involves either a price revision or an increase in quantity, the matching engine first cancels the resting order in the manner set out in the above order cancellation section, then re-enters the revised order as a newly submitted order at the updated price level, thereby assigning it a fresh timestamp and queue position. This approach reflects the convention that altering an order's price across the execution barrier—the best price on the opposite side—may trigger executions in the order book, or at least changes the priority of the order if reinserted at a different price level. As with order cancellation, a successful order modification results in the emission of a signal via the post-processing message queue 103.

### Chapter VI.—Core Operations with Exemplary Bitmask-Based Embodiment

### Chapter VI. A.—Introduction.

In one embodiment the presence or absence of each Price Level Pointer in a Data Holder Node can be abstracted with a single bitmask, rather than an actual presence in a slot of Price Level Pointers. This abstraction encodes pointer presence in a bitmask, so the engine updates a single integer flag instead of physically relocating pointers. Eliminating relocation removes memcpy-style moves and their attendant memory latency. It also deletes the dedicated Price Level Pointer slot, shrinking each Data Holder Node by one (or two if both highest- and lowest-priority are tracked) machine word—typically eight bytes on an LP64 system—for every order slot, yielding a node-metadata size reduction of up to (pointer size×number of priority predicates×maximum orders per node) bytes—a reduction that may be partially or fully offset by the per-order-object embedding described below in embodiments where order objects reside in-node, and substantially preserved in embodiments where order objects are referenced externally. The smaller node packs more nodes per memory page, thereby boosting spatial locality and lowering translation-lookaside-buffer pressure. Each slot in the node maps to one bit of an integer flag, where a bit value “1” indicates that a Price Level Pointer occupies the slot and a bit value “0” indicates that it does not. Whenever the system appends, prepends, or removes an order, it updates the mask with a bit-shift operation instead of copying or moving pointers, thereby reducing maintenance overhead.

Embedding Price Level Pointers into Order Objects.

To achieve this abstraction, an embodiment needs to make each order object embed the Price Level Pointer that corresponds to that order's price level. This embedding is feasible because an order's price remains fixed unless being modified; any price change requires removing the order from the book and reinserting it at the new price level, thereby preserving price-time priority. In most 64-bit processor systems, the embedded Price Level Pointer occupies no more than eight bytes, adding only minimal overhead to each order object. An embodiment that tracks both the highest-priority and lowest-priority Price Level Pointers either:
(a) employs two separate bitmask flags; or
(b) uses a single bitmask with distinct bit fields for each priority.

By contrast, an embodiment that tracks only the lowest-priority pointer uses a single bitmask sized with at least as many bits as the Data Holder Node's maximum order capacity. For clarity, this embedding is not the purpose of per-slot priority tracking since all the orders in the same price level will embed the same pointer value that references the price level's descriptor object.

### Branchless Execution.

Furthermore, the bit-shifting logic inside of this abstraction can easily be implemented without the need to use a branched code. Contemporary 64-bit superscalar processors expose at least two arithmetic-logic units (ALUs) per core; an ALU is the execution block that performs integer arithmetic and logic operations. A 64-bit shift retires in a single cycle, and a compiler can schedule it on an otherwise idle ALU while cache lines for surrounding order data load in parallel, yielding effectively zero added latency. Modern instruction set architectures (ISAs)—the x86-64 BM11/BM12 extensions (e.g., BLSR, BLSI, RORX) and Arm v8's bit-field instructions (BFI, BFC)—fuse shift-and-mask sequences into single μ-ops, further reducing issue-width pressure. Consequently, bit-shifting on bitmasks executes in a branchless way, avoids mis-prediction flushes, and introduces negligible overhead to the matching-engine critical path.

### Constant-Time, Cache-Friendly Access.

Embedding a Price Level Pointer in every order object permits direct O(1) access to the associated Price Level Descriptor, avoiding the O(log n) tree walk or auxiliary hash-map probe used in non-embedding configurations and incurring at most one L1-cache miss per access. This is especially valuable when cancellations or modifications require frequent aggregate-quantity updates at a price level.

Chapter VI. B.—Formal Background: Word-Width Model; Single-Word Vs. Multi-Word; Composite Packing (FIG. 15).

Let a Data Holder Node with maximum order slot capacity C (as a worked example hereunder, C≤64 (see Chapter VI. B, ‘Word Width and Multi-Word Masks’, ‘Multi-Word Case’)), such that a complete Price Level Pointer allocation state in the node fits inside two 64-bit machine words. Denote the Boolean vector space of length-C bit-vectors by

$$V := \text{?} , \{ {e}_{0} , … , {e}_{c - 1} \} the canonical basis ,$$

and recall that the Boolean ring operations are XOR for addition and AND for multiplication. In this setting every mask is both a vector in V and an idempotent element of the Boolean ring. Lastly, let the order book be a left-to-right chain of Data Holder Nodes

$${N}_{0} , {N}_{1} , … , {N}_{d} , capacity of each {N}_{k} = C \leq 64 .$$

### Local Price Level Interval in One Node.

For a fixed node N write

$${π}_{N} : \{ 0 , … , C - 1 \} \to {ℝ}_{+}$$

which maps each slot index to price level that the order currently stored in that slot belongs to. If price level p occurs in N with at least one order, define the block boundaries

$${α}_{N} ( p ) := min \{ i \vert π ( i ) = p \} , {ω}_{N} ( p ) := max \{ i \vert π ( i ) = p \} ,$$

such that the occupied slots of level p form one contiguous run [α_{N}(p), ω_{N}(p)] inside node N. A node may contain no orders of p, one run, or be completely filled with p.

### Global First/Last-Node Predicates.

Define

$$First ( p ) := min \{ k \vert p appears in {N}_{k} \} , \\ Last ( p ) := max \{ k \vert p appears in {N}_{k} \} .$$

A price level that exceeds one node's capacity simply satisfies

$$First ( p ) < Last ( p )$$

where intermediate nodes hold the middle segment of the queue.

### Head/Tail Masks Inside One Node N.

Define two Boolean vectors

$${H}_{N} , {T}_{N} ∈ V , \qquad {H}_{N} = ( {H}_{0} , ⋯ , {H}_{C - 1} ) , \qquad {T}_{N} = ( {T}_{0} , ⋯ , {T}_{C - 1} ) ,$$

by the rule

$$\begin{matrix}{H}_{i} = 1 ⇔ ( N = {N}_{First ( {π}_{N} ( i ) )} ) ∧ ( i = {α}_{N} ( {π}_{N} ( i ) ) ) , \\ {T}_{i} = 1 ⇔ ( N = {N}_{L a s t ( {π}_{N} ( i ) )} ) ∧ ( i = {ω}_{N} ( {π}_{N} ( i ) ) ) .\end{matrix}$$

Thus,
(a) every price level has at most one head bit and at most one tail bit in the entire order book;
(b) if an order is the sole order at its price level, the single order may carry both flags;
(c) interior nodes of a long queue carry no flag for that level.

### Admissible-Mask Set for the Node.

Define the admissible set

$${S}_{N} = \{ ( {H}_{N} , {T}_{N} ) ∈ {V}^{2} \vert definitions ( a ) - ( c ) hold \} .$$

Because the flag positions are determined solely by π_{N}, any two masks in S_{N} agree on every index where a flag is permitted.

### Closure Under Node-Wise Boolean Operations.

For the current node N let

$$( H , T ) ∈ {S}_{N}$$

be the unique head/tail mask that exactly describes the present slot array of N and let

$$( {U}_{H} , {U}_{T} ) ∈ V \times V$$

be a sparse update vector produced by one of the operators in Chapter VI. C. By construction the update vectors toggle only those bit positions that are legally allowed to carry a flag for their price level (never more than one head and one tail slot per price level). The matching engine then may apply one of two word-size primitives:

$$\begin{matrix}( H ⊕ {U}_{H} , T ⊕ {U}_{T} ) \to ( H , T ) & ( XOR toggle ) , \\ ( H ∧ ¬ {U}_{H} , T ∧ ¬ {U}_{T} ) \to ( H , T ) & ( AND clear ) .\end{matrix}$$

Because the support of U_{H}, U_{T} is restricted to the single legal slot for each flag inside N, the above operations can never create an illegal “1” for any price level; they can only erase or flip existing legal bit. Formally,

$$( H , T ) ∈ {S}_{N} ⇒ ( ( H ⊕ {U}_{H} , T ⊕ {U}_{T} ) ∈ {S}_{N} ∧ ( H ∧ ¬ {U}_{H} , T ∧ ¬ {U}_{T} ) ∈ {S}_{N} ) .$$

Therefore S_{N} is closed under component-wise AND and XOR even when a price level queue extends over many Data Holder Nodes.

### Composite Layout.

When register pressure is high or the compiler can fuse two bitmasks into a single scalar variable, an embodiment can embed the ordered pair (H,T) in a single 64-bit word

$$M = H ‖ T ,$$

e.g. the lower 32 bits store heads, the upper 32 tails. Bit-field isolation (BFXIL/BFI on Arm, BEXTR on x86 BM11) and cross-field moves (RORX, logical rotates) let the CPU manipulate the two sub-vectors without branching and with the same latency profile as the dual-mask variant. Let V= [symbol] with the usual tensor product ⊗. The ordered pair of head- and tail-bitmasks is the direct sum

$$V ⊕ V ≅ \text{?} .$$

Thus, the packing/unpacking operation preserves all information without appealing to specialized Boolean-ring properties. The choice between layouts is therefore a micro-architectural optimization, not a semantic one.

### Word Width and Multi-Word Masks.

Unless expressly stated otherwise, the examples herein are illustrated using a 64-bit native machine word under the LP64 data model (for example, most Unix-like x86-64 and AArch64 systems). The described algorithms and corresponding proofs are parameterized by the native machine-word width W, and therefore apply without modification to alternative data models (for example, LLP64, ILP32, ILP64) as well as to subsequently developed architectures having wider native words. Let a node's maximum capacity be m slots.
(a) Single-word case.
   If m≤W, each mask (for example, head mask or tail mask) is represented as a single W-bit word.
(b) Multi-word case.
   If m≥W, represent each mask as an array of k=┌m/W┐ words, denoted M[0, . . . , k−1]. Assuming the native word size W is a power of 2, for a logical slot i∈[0, m−1], the corresponding word index and bit position are computed as follows:

$$j = i ≫ {log}_{2} W , \qquad b = i \& ( W - 1 ) .$$

where >> denotes bitwise right-shift and & denotes a bitwise AND in this expression. Bit operations at logical slot i thereby mapped to the b-th bit of j-th word in the words array.

Suffix/prefix shifts generalize by shifting within word j and propagating a single-bit carry across higher-indexed words; such operations remain branch-free and execute in constant time per touched word. On 128-bit or wider ISAs, an implementation may employ native wide-shift instructions, with the semantics remaining unchanged. Bit indexing as defined herein is symbolic and endianness-neutral. Instruction mnemonics cited for a particular ISA are provided solely by way of example and are non-limiting, as functionally equivalent bit-operations exist on ARM, RISC-V, x86, and future architectures supporting 128-bit or larger native words. Accordingly, the analysis and methods described herein are to be understood as word-width agnostic, with the 64-bit form used merely for purposes of exposition.

### Memory-Footprint Impact.

Substituting the two-pointer (head+tail) layout with the dual- or composite-mask scheme deletes 2×C×pointer-size bytes of node metadata, where C is the node's capacity; a single reference to the corresponding Price Level Descriptor now embedded in each order object often slips into padding that already exists to satisfy cache-line alignment (e.g., the 8-byte gap rounding a 56-byte payload up to 64 bytes), so it costs zero extra space and the node realizes the full 2×C×pointer-size saving. If the padding is smaller than a pointer, the compiler extends the object and the net win falls somewhere between C×pointer-size and 2×C×pointer-size, depending on how many slack bytes are reclaimed; should the legacy design have held only one pointer per order, the new scheme still saves up to C×pointer-size or at worst breaks even. Thus, by harvesting otherwise unused alignment holes, the practical reduction can exceed the baseline C×pointer-size estimate and—in the best-aligned case—approach the full 2×C×pointer-size gain.

### Neutral/Absent Encoding for Bitmasks.

Unless expressly stated otherwise, a cleared bit (0) denotes the neutral/inactive state of a slot's priority indicator. In sparse encodings, cleared bits may be elided from storage and reconstructed as 0 on read without changing the semantics. The shift and clear operations are defined with zero-fill semantics, so eliding 0-bits preserves both the invariants and the update equations used in Chapter VI. C-D. In the multi-word case, elision is applied per word: an all-zero word may be treated as absent and interpreted as zero on read, materializing only when a bit transitions 0→1 within that word.

### Priority-Tracking Variants.

The apparatus and methods detailed in this specification are illustrated with an embodiment that concurrently tracks both the highest- and lowest-priority items. This dual-tracking example is provided solely by way of illustration and should not be construed as limiting. Persons of ordinary skill in the art will appreciate that the lowest priority only tracking may likewise be implemented without departing from the scope of the present disclosure, simply by omitting the head mask path. The single-mask and dual-mask layouts are alternative realizations of the priority indicators. References herein to ‘setting/clearing’ an indicator include functionally equivalent sparse operations that create/remove an entry denoting the asserted state; removing the entry is semantically identical to writing the neutral value.

### Chapter VI. C.—Update Primitives (Shift/Clear/Suffix-Shift; XOR OR Considerations) (Operators Table).

### Formal Invariants.

Let a node state be [symbol] =(O, H, T)∈O^{C}×V², where Oᵢ is either an order object or ⊥ (empty slot). Define the slot-bit bijection

$$η : i ↦ {e}_{i} .$$

The correctness of all subsequent transforms hinges on three invariants:
(a) Occupancy condition—All head/tail bits are subsets of the occupancy set; formally:

$$supp ( H ) ⋃ supp ( T ) ⊆ \{ i \vert {O}_{i} \neq ⊥ \}$$

where for a bit-vector x=(x₀, x₁, . . . , x_{C-1})∈ [symbol] ,

$$supp ( x ) : = \{ i \vert {x}_{i} = 1 \} .$$

(b) Head uniqueness—For every price level π,

$${\sum }_{i : {O}_{i} has price π} H \cdot {e}_{i} \leq 1.$$

(c) Tail uniqueness—The analogous inequality on T.

Because XOR is the additive group law in V, these constraints define an invariant-defined subset

$$i = ( O , H , T ) \vert all conditions ( a ) - ( c ) hold \}$$

of the node state space O^{c}×V². Any affine self-map of V² that preserves the coordinate support of (H,T) is automatically an endomorphism of i, a fact that the matching engine exploits to prove correctness of each update.

### Operators and Algebraic Toolkit.

All mask manipulations are built from four word-parallel primitives, each expressible as a linear or affine map on V:

| | | Linear | Micro-op |
|---|---|---|---|
| Symbol | Definition (on x ∈ V) | rank | realization |
| Sₖ | Left shift by k (x << k, zero-fill) | C - k | 1 cycle |
| | | | SHL / LSL |
| Rₖ | Right shift by k (x >> k, zero-fill) | C - k | 1 cycle |
| | | | SHR / LSR |
| ${P}_{k}^{R}$ | Suffix-right-shift: Fix indices < k; | C - 1 | SHL + AND |
| | send i > k → i + 1, i = k → 0 | | mask |
| ${P}_{k}^{L}$ | Suffix-left-shift: Fix indices < k; | C - 1 | SHR + AND |
| | send i > k → i − 1, i = C − 1 → 0 | | mask |
| Cᵢ | Clear bit i: x Λ [symbol] eᵢ | C - 1 | BTR or AND |
| | | | with |
| | | (idempotent) | negated mask |

Note that

$${P}_{k}^{R} and {P}_{k}^{L}$$

are named in the order arrangement direction (left-to-right, the suffix comes on the right end), thus perform an opposite side logical shift

$$( {P}_{k}^{R}$$

does a left shift,

$${P}_{k}^{L}$$

does a right shift). The micro-op realizations shown in the above table are illustrative of x86-64 cores; Arm and other ISAs offer analogous single-cycle or fused instructions. All other transformations—e.g. prefix shifts, bit injections, or rank-1 toggles—compose these primitives and at most one sparse vector XOR. These maps are linear endomorphisms, therefore not necessarily invertible. Each is injective on the subspace that occurs at runtime, which is enough to preserve correctness. Under the Word-Ram cost model, each primitive is Θ(1) time; on real hardware the latency is dominated by a single 64-bit ALU pipe, schedulable parallel to data-cache fetches. By restricting attention to this toolkit, the matching engine guarantees:
(a) Branch-free critical paths—updates do not incur mispredictions.
(b) Constant-time worst case per node—no data dependent loops; time is bounded by two shifts+two bit-tweaks for bitmask updates.
(c) Information-theoretic minimality—since every operator preserves or reduces the Hamming weight of (H,T), the representation never fattens beyond 2C bits irrespective of workload.

These expanded definitions supply the algebraic foundation for all subsequent operations.

### Non-Uniqueness of Update Equations.

In the following Boolean vector space:

$$V = {𝔽}_{2}^{C} , {V}^{2} = V \times V ≅ {𝔽}_{2}^{2 C}$$

A bitmask update routine transforms a state (H,T)∈V² into a new pair (H′,T′). The most common implementation is an affine endomorphism

$$F ( H , T ) = ϕ ( \begin{matrix}H \\ T\end{matrix} ) ⊕ b , ϕ ∈ End ( {V}^{2} ) , b ∈ {V}^{2}$$

because XOR (↔) is the additive law in V². But, the functional spec does not require linearity: any Boolean circuit that satisfies the following two conditions as well as maintaining the invariant of the system is admissible, even if it is non-linear. The correctness requirement is simply:
(a) F(supp(H)∪supp(T))⊆{i|Oᵢ≠⊥}(mask bits never point to empty slots); and
(b) F preserves the head/tail-uniqueness inequalities price-level-wise.

### XOR↔OR Replaceability Under a Pre-Condition.

Consider the Prepend path (Chapter VI. D.):
(a) Prefix shift S₁ is a zero-fill map, therefore it sets bit 0 to zero.
(b) An embodiment may choose either
   (i) XOR Insertion x [symbol] x⊕e₀
   (ii) OR Insertion x [symbol] x∨e₀ [symbol]
Because both yield the same result on that zeroed-out operand.

Thus, any affine update of the form defined above can be converted into a non-linear variant

$${F}_{V} ( H , T ) = ( {ϕ}_{H} ( H , T ) ⋁ {b}_{H} ) \vert \vert ( {ϕ}_{T} ( H , T ) ⋁ {b}_{T} ) ,$$

where φ is the linear part and (b_{H},b_{T}) are constant masks, without changing the logical book whenever the vacated bits are guaranteed to be 0 in the affine form. In that sense XOR and OR are inter-substitutable under the zero-filled operand pre-condition supplied by the shift operators.

### Affine Endomorphisms, Non-Linearity, and Implementation Freedom.

Hence, two different directions can be employed:
(a) Affine option—keeps the update inside the category of linear maps; rank, kernels, and composition can be reasoned about with matrices. The concrete rules we adopt use exactly one composition of the rank-deficient primitives (Sₖ, Rₖ, Pₖ, Cᵢ) introduced in the above, plus a translation vector b of Hamming weight≤2. The transition vector gives a rank≤2 perturbation—algebraically minimal and compiling to ≤2 BTS/BTR/BTC μ-ops per mask on x86-64 architecture.
(b) Non-linear option—replaces some XORs by ORs. Algebraic linearity is lost, but the correctness requirement still holds, so the routine is functionally correct. In some cases, an embodiment might prefer OR for the following reasons:
   (i) Idempotent flag-set: x∨e₀ cannot clear a flag if the same write happens twice, which is useful under CAS retries or speculative aborts.
   (ii) Concurrent safety: in case of a Data Holder Node being shared among two or more threads, multiple threads OR-ing the same bit only converge to 1; XOR could toggle to 0.
   (iii) Zero hardware penalty: OR imm (immediate operand) and EOR/XOR imm are both single-cycle μ-ops on the latest x86-64 and AArch64.
Because both options satisfy the invariants, and because the matching engine never needs to invert the update, there is no canonical formula. An embodiment can therefore choose the variant that: minimizes latency on a particular ISA, exposes BFI/BFXIL fusion on AArch64, or aligns better with formal-verification strategy (affine maps are easier to reason about in Coq/SSReflect).

### Conclusion on the Non-Uniqueness of Update Equations.

Two routines F₁, F₂, whether both affine, both non-linear, or one of each—are observationally equivalent whenever they maintain the invariant and satisfy the correctness requirement. For each bitmask update equation stated herein, persons of ordinary skill in the art will recognize that an alternative or equivalent update rules may be employed; however, so long as the underlying set of features being evaluated is identical, each such implementation will produce the same resulting bitmask. Hence the specific shift-plus-flag equations as well as their mathematical reasoning presented below are exemplary, not limiting: any mathematically consistent alternative (including, but without limitation, XOR↔OR substitutions under zero-fill) remains within the disclosed scope.

### Chapter VI. D.—Order Matching; Append Paths (Simple and General); Prepend Paths; Branch-Free Updates (FIG. 16-18).

### Match-and-Insert Invariant, Stable Index Mapping (FIG. 16).

Let the order array before execution be the sequence

$$O = ( {O}_{0} , … , {O}_{n - 1} ) {O}_{i} ∈ 𝒪 ⋃ \{ ⊥ \}$$

where [symbol] ={o|o is well defined order}, and assume a set D={d₁< . . . <dᵣ}⊆{0, . . . C−1} of slots is about to be removed (order fills, cancels, etc.). Define the deletion map

$$Π = {P}_{{d}_{r}} ∘ … ∘ {P}_{{d}_{1}} ,$$

where each P_{d}_{ⱼ} is the suffix-left-shift operator that was introduced in the operator table. Because every P_{d}_{ⱼ} deletes only bit information that corresponded to a deleted order, Π(H,T) still satisfies the invariant requirement. Then, the matching engine performs the following updates:
(a) Payload compaction moves the suffixes of O left by the number of deletions r.
(b) Mask compaction applies the rank C—r deletion map H.

During execution, a naïve application of H would seem to require r separate shifts; however, as long as r≤C≤W (word length) an embodiment can vectorize into two shifts plus masks for a single contiguous deletion run. Even when not vectorized, the number of word operations is a constant-bounded number per mask.

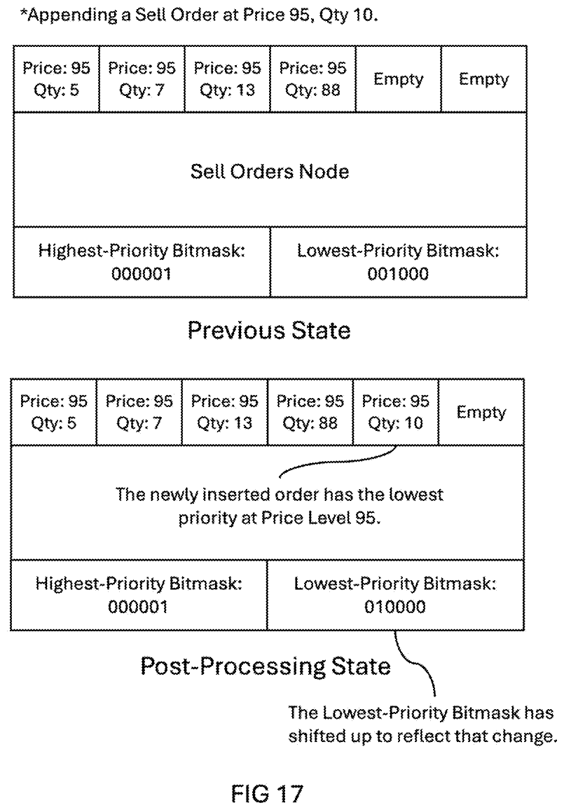

### Simple Append (a Special Case of Block 705, FIG. 7), (FIG. 17).

Suppose the Data Holder Node currently holds k<C active slots, so the incoming order is appended at index k. Define the rank-1 toggling vector

$${δ}_{T} = ( {e}_{k} ⊕ {e}_{k - 1} ) ,$$

i.e. clear bit at k—1 and set bit at k. Then, the matching engine updates the bitmasks with the following equations:

$${H}^{′} = H , {T}^{′} = T ⊕ {δ}_{T} .$$

This equation has the following algebraic properties:
(a) Rank argument—T [symbol] T⊕δ_{T} differs from the identity by a matrix of rank 1; hence it is the minimal linear perturbation that can relocate a single 1-bit.
(b) Endomorphism of i—Because the perturbation only affects two indices, both of which are known occupied (k−1 and k), the subset invariant is preserved. Head/tail uniqueness is preserved because exactly one bit per price level remains set.
(c) μ-op realization—For example, on x86-64:
   (i) BTR mask, (k−1)-bit-test-and-reset (clears the old tail flag).
   (ii) BTC mask, k-bit-test-and-complement (sets the new tail flag).
These two μ-ops share no data dependency except through the mask register, giving a dependency depth 1 and retiring in ≤2 cycles even on a narrow superscalar front end.

Thus, the best-case and worst-case latency of Simple Append differ by at most two ALU μ-ops.

### Generalized Append (General Case of Block 705, 706, FIG. 7), Suffix-Shift Transform and Bit-Flag Injection (FIG. 17).

Unlike the simple “size=k” case, a general Append may insert at an interior slot k even when higher indices already contain orders. The matching engine therefore performs two coupled actions:
(a) Open a gap in both payload and masks—Assume the node currently holds k′ live orders (0≤k<k′−1<C). Using the suffix-right-shift operator,

$${P}_{k} : V \to V , {( {P}_{k} x )}_{i} = \{ \begin{matrix}{x}_{i} & i < k \\ 0 & i = k \\ {x}_{i - 1} & k < i < C\end{matrix}$$

which is injective on the subspace {x|x_{C-1}=0}, because just before the Append, the ending slot C−1 is vacant or about to be evicted. If the slot C−1 was occupied before the Append, apply Push Back to evict the spot. Because the entire node's information (assuming C≤64; see Chapter VI. B, ‘Word Width and Multi-Word Masks’, ‘Multi-Word Case’) fits in one 64-bit word, the suffix-right-shift operator executes in Θ(1) time.
(b) Define a predicate for the new order—After performing bitmask update of (a), we define a generalized predicate φ as follows:

$$φ ( a ) = \{ \begin{matrix}1 & if the incoming order a carries a Price Level Pointer \\ 0 & otherwise\end{matrix}$$

Formally,

$$φ ( a ) = \{ 〈 a , 1 〉 \vert a ∈ 𝒪 ∧ PLP ( a ) \} ⋃ \{ 〈 a , 0 〉 \vert a ∈ 𝒪 ∧ ¬ PLP ( a ) \} .$$

The predicate determines whether the incoming order “a” would carry a Price Level Pointer if it was a pointer-based embodiment. For example, the general insertion case element 706, Append is invoked as a part of creation of a new price level, and thus φ(a)=1. By contrast, the insertion case of element 705 would be φ(a)=0 because the price level for that order already exists in the matching engine's order book, and thus the incoming order would not carry a Price Level Pointer. For the case of Append as Push Forward-derivative (see Chapter V. B.), φ(a) would determine whether the corresponding Price Level Pointer is being pushed forward together with order a. φ(a) is called generalized because it's defined separately in both highest- and lowest-priority context. (respectively, φ_{H}(a), φ_{T}(a)) To eliminate any confusion, φ(a) is defined solely for the incoming order that's being passed as an argument of the Append, and not for the pre-existing orders in a Data Holder Node.
(c) Bitmask Update Equations
   (i) For the case of Append as Push Forward-derivative, the case divides to two cases: whether the Appended Data Holder Node is full or not. If not full, then the matching engine updates bits with the following branchless way:

$$( \begin{matrix}{H}^{′} \\ {T}^{′}\end{matrix} ) = ( \begin{matrix}{P}_{k} & 0 \\ 0 & {P}_{k}\end{matrix} ) ( \begin{matrix}H \\ T\end{matrix} ) ⊕ ( \begin{matrix}{φ}_{H} ( a ) {e}_{k} \\ {φ}_{T} ( a ) {e}_{k}\end{matrix} )$$

Where k is the index of the slot being inserted. If the Data Holder Node being appended is full, the case turns to another cascaded-Push Forward case. After the Push Forward of the order at index 0, the Data Holder Node should now have an empty slot, and the case resolves to the above “non-full” case. This concludes for Append as Push Forward-derivative.
(ii) For the case of Append as a general case of block 705, 706—this case also divides into block 705 and 706. In case 705, there is no new price level being created, and thus φ(a)=0 for both highest- and lowest-priority for the incoming order's price level. Also, the incoming order is being appended to the existing priority, thus it will replace the older lowest-priority flag for that price level. For the case 706, a new price level is being created, thus φ(a)=1 for both highest- and lowest-priority for its price level. Also, the case 706 does not need reallocation of the bit flag since the incoming order is the sole order at that price level. Then, the matching engine updates the bitmask with the following branchless way:

$$( \begin{matrix}{H}^{′} \\ {T}^{′}\end{matrix} ) = ( \begin{matrix}{P}_{k} & 0 \\ 0 & {P}_{k}\end{matrix} ) ( \begin{matrix}H \\ T\end{matrix} ) ⊕ ( \begin{matrix}{φ}_{H} ( a ) {e}_{k} \\ {e}_{k}\end{matrix} ) ⊕ ( \begin{matrix}0 \\ ¬ {φ}_{T} ( a ) {e}_{k - δ ( k )}\end{matrix} )$$

where δ(k) in this context, is defined as follows:

$$δ ( k ) := 1 - {δ}_{k 0} = \{ \begin{matrix}0 & if k = 0 \\ 1 & otherwise\end{matrix}$$

The purpose of δ(k) is to confine the index within the canonical basis boundary when k=0.

FIG. 17 annotates the before-and-after masks, showing the suffix shift and the newly raised bit at index k; all other price levels retain their head/tail markers unchanged, preserving the invariant defined in Chapter VI. C. Within a single Data Holder Node, the in-node mutation—payload move plus mask update, excluding any preceding price-level tree lookup or rebalancing—completes in per-operation constant-bounded time, independent of order book size.

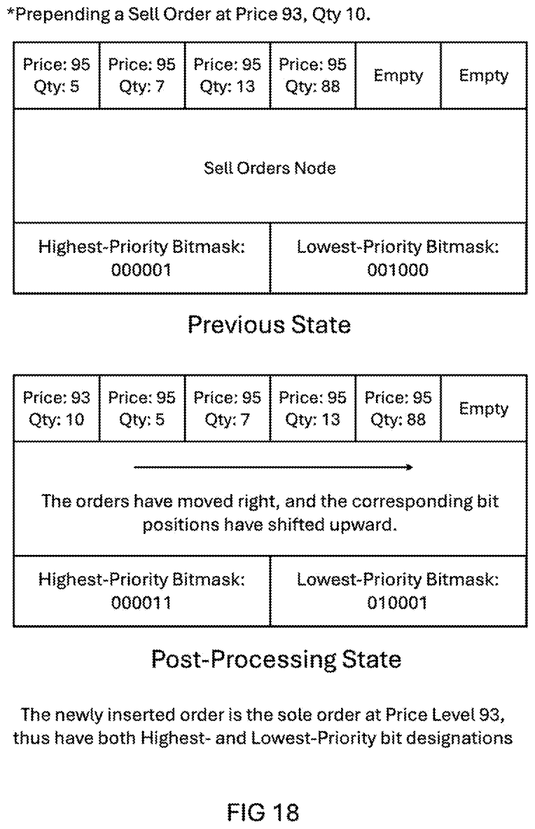

### Generalized Prepend, Prefix-Shift Transform and Bit-Flag Injection (FIG. 18).

In one embodiment that does not implement the “jump to the front” function, Prepend always inserts the incoming order at slot index 0. This is a specialization under the FIFO priority rule and does not apply generally to all priority rule cases. For the “jump to the front” function, which may involve prepending an order at non-zero index location, a different prefix-shifting can be employed (Sₖ, where 1<k<C). For simplicity, this paragraph describes a general scenario where the insertion is done at index 0. Then, the matching engine shifts every pre-existing order (and its priority indicator) one index higher. Let

$$\begin{matrix}{S}_{1} : V \to V , & {S}_{1} ( x ) = x << 1\end{matrix} mod {2}^{C}$$

(logical left shift by 1 in a fixed C-bit word) which has rank(S₁)=C−1; injective on vectors with x_{C-1}=0, since either the node was not full, or the order in the first slot (index 0) is about to be evicted via the Push Forward operation. Then, the matching engine updates the following:
(a) Prefix-shift of both masks—If the node was full, the matching engine evicts the first order and its corresponding bit via the Push Forward. The shift performed by Push Forward (the right-shift 1 defined in Chapter VI. C., mapping surviving orders from slots [1, C−1] to [0, C−2] in the mask) and the Generalized Prepend's prefix shift (the left-shift <<1 defined in this paragraph, mapping the surviving orders from [0, C−2] back to [1, C−1] in the mask) compose to leave the surviving orders at their original slot indices and slot 0 free for the prepended order; thus, no additional shift beyond these two is required. However, if the node was not full, the matching engine uses the above defined S₁ operator. Then, the shifting operator is defined as:

$$ϕ = \{ \begin{matrix}I & if the first slot was evicted before the Prepend \\ {S}_{1} & otherwise\end{matrix}$$

where I: V→V is the identity matrix defined in the respective dimension.
(b) Adjust head and tail flags for the new order—In case of prepending due to creating a new price level (block 706, FIG. 7), by definition, the prepended order is both highest- and lowest-priority at its price level w since it's the sole order at its price level, thus we have:

$$( \begin{matrix}{H}^{′} \\ {T}^{′}\end{matrix} ) = ( \begin{matrix}( I - {E}_{0} ) ϕ & 0 \\ 0 & ( I - {E}_{0} ) ϕ\end{matrix} ) ( \begin{matrix}H \\ T\end{matrix} ) ⊕ ( \begin{matrix}{e}_{0} \\ {e}_{0}\end{matrix} )$$

where E₀ is defined as an outer product of canonical basis e₀,

$${E}_{0} = {e}_{0} {e}_{0}^{T} , \qquad ( I - {E}_{0} ) ∈ End ( V ) ,$$

or simply as non-linear expressions,

$${H}^{′} = ϕ H ⋁ {e}_{0} \qquad ( sets bit 0 unconditionally )$$

$${T}^{′} = ϕ T ⋁ {e}_{0} \qquad ( likewise sets bit 0 ) .$$

However, if the price level if already existed, wherein the case Prepend is invoked as a derivative mechanism of Push Back, then there is no guarantee that the newly inserted order is either highest- or lowest-priority at its price level. Then, the matching engine uses the generalized predicate:

$$φ ( a ) = \{ \begin{matrix}1 & if the prepended order a carries a Price Level Pointer \\ 0 & otherwise\end{matrix}$$

In other words, the predicate φ(a) tells whether the prepended order would carry a Price Level Pointer if it was a pointer-based embodiment. Then, the matching engine updates the bitmasks with the following equations:

$$( \begin{matrix}{H}^{′} \\ {T}^{′}\end{matrix} ) = ( \begin{matrix}ϕ & 0 \\ 0 & ϕ\end{matrix} ) ( \begin{matrix}H \\ T\end{matrix} ) ⊕ ( \begin{matrix}{φ}_{H} ( a ) {e}_{0} \\ {φ}_{T} ( a ) {e}_{0}\end{matrix} )$$

This concludes the bit-shifting for Prepend method.
(c) Complexity analysis—The priority indicator update performs one 64-bit shift per mask, up to two 64-bit word writes, and no data-dependent branches inside the critical path (the result of the predicate φ(a) is already known at the time of invocation of Prepend). Thus, the prepend path retains Θ(1) latency, matching the information-theoretic lower bound for inserting one order and updating at most two Boolean flags.

### Chapter VI. E.—Cascades (Mask Shifts and Clears; Derivative Append/Prepend) (FIG. 19-20).

### Push Back (FIG. 19).

Per the selection-by-priority rule of Chapter V. B., ‘Push Back’, the engine selects the order to relocate by comparing priorities; in the bitmask embodiment described below, this selection is performed as follows:
(a) Node state and invariant—The mapping “slot i [symbol] bit i” is a slot-to-bit correspondence in which the 1-bits in either mask identify slots satisfying the tracked head/tail predicates. Inside the Boolean ring [symbol] {0,1}^{C}, ⊕, ∧ [symbol] each mask is simply a length-C Boolean vector.
(b) Clearing the information of the evicted order—The operator “clear bit” is the Boolean-ring endomorphism

$${C}_{C - 1} : x ↦ x ∧ ¬ {e}_{C - 1} .$$

Because it fixes every bit except the one being cleared, it is idempotent but not invertible; that is exactly what we need when permanently removing the tail slot. Also, at the same time the matching engine calculates the generalized predicate that will be used in the following derived-Prepend operation for the evicted order

$${φ}_{x} ( a ) = \{ ( x , 1 〉 \vert x ∈ V \hat{} {e}_{C - 1}^{T} x = 1 \} ⋃ \{ ( x , 0 〉 \vert x ∈ V \hat{} {e}_{C - 1}^{T} x = 0 \}$$

where x∈{H,T} in the above expression is each bitmask. Then, the matching engine updates the bitmask of the Data Holder Node as follows:

$$( \begin{matrix}{H}^{′} \\ {T}^{′}\end{matrix} ) = ( \begin{matrix}{C}_{C ‐ 1} & 0 \\ 0 & {C}_{C ‐ 1}\end{matrix} ) ( \begin{matrix}H \\ T\end{matrix} )$$

(c) Transforming the node—Removing the last order restricts the index set from {0, . . . , C−1} to {0, . . . , C−2}; the identity map on those surviving indices remains a bijection and preserves their natural order. Applying the clearing endomorphism to H and T therefore maintains the slot-bit bijection on the smaller index set. After the relocation, the matching engine proceeds the insertion process as Prepend on the successor node.
(d) Cost—One order is copied out, two single-word Boolean-ring operations are executed. Constant time irrespective of C.

### Push Forward (FIG. 20).

Per the selection-by-priority rule of Chapter V. B., ‘Push Forward’, the matching engine then reevaluates the generalized predicate φ(a) from Chapter VI. D. by checking whether that displaced order retains a corresponding Price Level Pointer. Then, the matching engine updates the bitmask of the Data Holder Node as follows
(a) Define a shift down operator—On the sub-space {x∈V|x₀=0} the logical right shift operator R₁: V→V is defined as:

$${R}_{1} ( x ) = ( x >> 1 ) .$$

R₁(x) preserves XOR and AND, so it is an endomorphism of the Boolean ring [symbol] {0,1}^{C}, ⊕, ∧ [symbol] . Because all vectors fed into R₁(x) satisfy x₀=0, no information is lost when the shift discards bit 0. Within this subset, R₁ is therefore injective (one-to-one) on the subset {x∈V|x₀=0}.
(b) Order-index bijection—The map on slot indices,

$$i ↦ i - 1 ( 1 \leq i \leq C - 1 )$$

is an order-preserving bijection from the old index set {1, . . . , C−1} onto the new set {0, . . . , C−2} Applying R₁(x) to both masks transports every ‘1’ bit through exactly this bijection, thus the slot-bit invariant is maintained.
(c) The bitmask update—The matching engine calculates the generalized predicate that will be used in the following derived-Append operation for the evicted order

$${φ}_{x} ( a ) = \{ ( x , 1 〉 \vert x ∈ V \hat{} {e}_{0}^{T} x = 1 \} ⋃ \{ ( x , 0 〉 \vert x ∈ V \hat{} {e}_{0}^{T} x = 0 \} .$$

Then, the matching engine updates bitmasks as follows:

$$( \begin{matrix}{H}^{′} \\ {T}^{′}\end{matrix} ) = ( \begin{matrix}{R}_{1} & 0 \\ 0 & {R}_{1}\end{matrix} ) ( \begin{matrix}H \\ T\end{matrix} ) .$$

In a case where the shifting operator R₁ is defined as non-zero-fill (particularly, in non-linear expressions that use non-zero-fill shifting operators), the bitmask update equation is as follows:

$$( \begin{matrix}{H}^{′} \\ {T}^{′}\end{matrix} ) = ( \begin{matrix}{C}_{C - 1} & 0 \\ 0 & {C}_{C - 1}\end{matrix} ) ( \begin{matrix}{R}_{1} & 0 \\ 0 & {R}_{1}\end{matrix} ) ( \begin{matrix}H \\ T\end{matrix} )$$

After the transfer, the insertion continues as Append on the predecessor node. If the predecessor is also full, the hop repeats toward the book head. The shift of both masks keeps the relative position of any existing Price Level Pointer correct after the physical order array shift, and the cascade depth cap again bounds latency.
(d) Cost—One order is transferred to the predecessor node, two single-word shifts are executed (one per mask). Constant-bounded per cascade hop, irrespective of C; total cascade time is bounded by the configured hop limit.

Together, the bitmask abstraction delivers per-operation pointer-management—including without limitation the in-node bit set/clear, single-word shift, and per-cascade-hop relocation—in constant-bounded time (exclusive of any preceding price-level tree lookup, rebalancing, or subsequent maintenance, as defined at Chapter II. G.), saves cache space, and maintains the strict latency budget demanded by high-performance matching engines.

### Chapter VII.—Flexible Node Capacity

### Chapter VII. A.—Motivation; Depth-Aware Capacity Function.

In one embodiment, the maximum number of orders a Data Holder Node can hold is defined as a monotone, non-increasing function of its depth—the number of hops from the order book head. Nodes at or near the head experience orders-of-magnitude higher access rates than those further away, thus allocating larger contiguous blocks to these “hot” nodes amortizes cache-line shifts and reduces the frequency of Push-Back/Push-Forward cascades. Nodes deeper in the book, by contrast, may stay intentionally “thin,” shrinking their cache- and TLB-footprint without harming latency-critical paths. This depth-aware sizing preserves all slot-bitmask invariants introduced in Chapter VI. C. while aligning memory usage with observed locality, thereby lowering the expected L1-miss cost per matched or modified order.

### Scope-Neutral Disclaimer.

The mathematical derivation of the depth-aware Flexible Node Capacity strategy and the machine-learning optimization loop are illustrative only. Practitioners may employ other analytical or data-driven techniques—including, without limitation, a whole-book latency-minimization objective, gradient-boosted decision trees, boosted regression trees, random forests, linear and generalized-linear models, kernel methods, Gaussian-process regressors, mixture models, contextual bandits, and reinforcement-learning controllers—or static heuristics/rule-based reallocators, without departing from the teachings or claimed subject matter.

### Formal Introduction to Flexible Node Capacity.

Let

$$κ : ω \to {𝒩}_{\geq 1} , d ↦ {C}_{d}$$

assign to every Data Holder Node at distance d∈ω from the order book head (hereunder “depth”), an order capacity C_{d}. Assume the following constraints:
(a) Monotone non-increasing property,

$${C}_{0} \geq {C}_{1} \geq {C}_{2} \geq …$$

(b) Maximum order capacity,

$${C}_{0} \leq {C}_{Max} \leq 64$$

such that each bitmask can describe the entire node's status within one 64-bit word. The maximum order capacity 64 is illustrative and non-limiting. When an embodiment requires a relaxed requirement for the maximum order capacity, use two or more words for each bitmask.
(c) No artificial cap in the total order book size,

$${\sum }_{d < ω} {C}_{d} = ∞ .$$

The rationale for the above assumption is as follows: Empirical telemetry on live matching engines shows that the access frequency decays super-exponentially with depth; allocating larger buckets near the head amortizes O(1) updates over more orders while keeping tail pages leaner and cache-friendlier. This flexible node-capacity model guarantees safety against infinite recursion, even in the absence of an explicit cascade limit and irrespective of how each node's capacity is determined. A formal proof of this property is provided in Appendix B (illustrative and non-limiting).

### Chapter VII. B.—Latency Optimization Model (Hit/Miss, Per-Node Cost).

Consider an optimization problem of processing latency per order basis.

### Formal Introduction.

An embodiment may implement minimization of the following cost function:

$${L}_{i} ( {k}_{j} ) = {P}_{L 1} ( i ) {T}_{hit} ( {k}_{j} ) + [ 1 - {P}_{L 1} ( i ) ] {T}_{m i s s} ( {k}_{j} )$$

where, Lᵢ is the processing latency of order i which is contained in the Data Holder Node at depth j, kⱼ is the capacity of that Data Holder Node, P_{L1} is the probability of order i being in L1 cache, Tₕᵢₜ is the processing latency at L1 cache hit, and Tₘᵢₛₛ is the processing latency at L1 cache miss. One thing to note here is that Tₕᵢₜ and Tₘᵢₛₛ are both functions of the Data Holder Node size kⱼ, since every insertion/deletion requires adjustment of the entire node storage, thus Tₕᵢₜ, Tₘᵢₛₛ grow linearly with kⱼ. Then,

$${T}_{hit} ( {k}_{j} ) = A {k}_{j} , A = \frac{{t}_{c} + w u}{2} , {T}_{m i s s} ( {k}_{j} ) = A {k}_{j} + {t}_{m}$$

where t_{c} is L1 cache round trip latency (~4 CPU cycles), w is write/all-access ratio, u is slot shifting latency (~5 CPU cycles per shifted order, assuming each order size is 64 bytes), and tₘ is the remote memory access penalty (normally, +120 CPU cycles). The constant A reflects the expected value of linear scan and shift cost.

### Empirical Access Model.

The empirical order book data from one of the most liquid books, such as Nvidia stock, shows that the orders in the top of the book are exponentially more likely to be accessed than the orders in the deeper region of the order book. This shows a remarkably straight line on a log-log plot. Consequently:

$$\# of updates ( l ) ∝ {l}^{- β}$$

where β is an empirical parameter to be determined from actual data, and l is each price level counted from the top of the book. Then, assume that a price level that is closer to the top of the book contains exponentially more orders than the remote price levels

$${n}_{l} = {n}_{1} {e}^{- γ ( l - 1 )} ( γ > 0 ) .$$

where n₁ is the number of orders contained in best bid-ask price level (top of the book). For simplicity, within the price level, assume that the orders in the front are equally likely to be hit as the orders in the back of the queue.

$$Pr ( hit offset j \vert l ) = 1 / {n}_{l} .$$

Then, an embodiment can construct the per-order hit probability as follows:

$${p}_{l , j} = Pr ( price level l ) Pr ( offset j \vert l ) = \frac{{l}^{- β}}{{Z}_{lvl}} \cdot \frac{1}{{n}_{l}} .$$

where the following normalizer is used in the above equation,

$${Z}_{lvl} = {\sum }_{m = 1}^{∞} {m}^{- β} ( Across price levels , Riemann zeta series )$$

Putting it together gives,

$${p}_{l} = \frac{{l}^{- β}}{{Z}_{lvl} {n}_{l}} .$$

### Sanity Checks.

The postulated exponential decay of queue length with price level depth holds only when the decay constant γ is re-estimated from live telemetry, and not hard-wired to the first few ticks, which are frequently “humped” rather than monotone. Parameter γ—and, by extension, any distributional parameter—therefore resides squarely within an implementer's design freedom and does not limit the scope of the invention. Likewise, the intra-level hit-probability term is meaningful only under FIFO or price-time priority; in a pure pro-rata matcher the offset-within-level factor collapses to unity, leaving a model driven solely by the cross-level term.

### Ingredients to Construct the Global Linear Rank i.

For algorithms that need the one-dimensional ranking used in earlier sections:

$$i = {\sum }_{m < l} {n}_{m} + j ⇒ l = 1 + \frac{1}{γ} ln \frac{{n}_{1}}{{n}_{l}} ,$$

### Recap of the Ingredients:

| Component | Formula | Parameter |
|---|---|---|
| Level-hit frequency | # of hits(l) ∝ l^{-β} | β > 1 |
| Queue length | nₗ = n₁r^{l-1}, r = e^{-γ} | γ > 0 |

### Normalizers:

$${X}_{lvl} = {{\sum }_{m = 1}}^{∞} {m}^{- β}$$

$${N}_{max} = \frac{{n}_{1}}{1 - r} .$$

### Conversion of Prefix-Sum.

A resting order with global rank i (1≤i≤Nₘₐₓ) sits in the unique price level l that satisfies

$$i = {S}_{l - 1} + j , {S}_{l - 1} = {n}_{1} \frac{1 - {r}^{l - 1}}{1 - r} , 1 \leq j \leq {n}_{l}$$

where Sₗ₋₁ is prefix-sum up to the price level l−1, and j is the offset within the price level l. Here l(i) is defined as the ordinal price level (not an actual price) for rank i, which is a natural number. Therefore, the effect of j inside of logarithm becomes negligible. Solving for l without j gives:

$$l ( i ) = 1 + \frac{ln [ 1 - \frac{( 1 - r ) i}{{n}_{1}} ]}{ln r}$$

because 1≤i≤Nₘₐₓ, the value of the bracket is in (0,1) range, which makes the logarithm in the numerator negative. Since ln r=−γ<0, the expression l(i) as whole is well-defined and l(i)≥1 throughout the live book.
Express nₗ and l^{-β} in Terms of i.

Substituting l(i) into n₁=n₁r^{l-1} gives:

$${n}_{l} ( i ) = {n}_{1} {r}^{l ( i ) - 1} = {n}_{1} {r}^{\frac{ln [ 1 - \frac{( 1 - r ) i}{{n}_{1}} ]}{ln r}} = {n}_{1} [ 1 - \frac{( 1 - r ) i}{{n}_{1}} ]$$

$$using {N}_{max} = {n}_{1} / ( 1 - r ) ,$$

$${n}_{l} ( i ) = ( 1 - r ) ( {N}_{max} - i ) .$$

For level factor l^{-B}, it is straightforward from the previous expression:

$${l}^{- β} = {[ 1 - \frac{1}{γ} ln ( 1 - \frac{i}{{N}_{max}} ) ]}^{- β} .$$

### Assembling pᵢ.

Substituting l^{-β} into the probability expression in empirical access model gives,

$${p}_{i} ( β , γ ) ∼ \frac{1}{{Z}_{lvl} ( 1 - r )} \cdot \frac{{[ 1 - \frac{1}{γ} ln ( 1 - \frac{i}{{N}_{max}} ) ]}^{- β}}{{N}_{max} - i} .$$

The closed-form expression pᵢ(β,γ) is derived from a continuum approximation that maps (i,j) [symbol] i. As a result, it is not the exact probability. However, normalization of the error term is not required since this expression serves only as an intermediate step. The final latency model only relies on the asymptotic expressions that follows below.

### Asymptotic Expressions.

Near the top of the book—Let x be,

$$x = \frac{i}{{N}_{max}} ≪ 1.$$

### Then,

$$l ( i ) = 1 - \frac{ln ( 1 - x )}{γ} = 1 + \frac{x}{γ} + O ( {x}^{2} ) ,$$

$${l ( i )}^{- β} = 1 - \frac{β}{γ} x + O ( {x}^{2} ) ,$$

$$\frac{1}{{N}_{max} - i} = \frac{1}{{N}_{max}} ( 1 + x + O ( {x}^{2} ) ) .$$

### Therefore,

$${p}_{i} = \frac{1}{{Z}_{lvl} {n}_{1}} [ 1 + ( 1 - \frac{β}{γ} ) x + O ( {x}^{2} ) ] ( i ≪ {N}_{max} ) .$$

In the deeper book—Set

$$i = {N}_{max} ( 1 - ε ) with ε ↓ 0.$$

### Then,

$${N}_{max} - i = ε {N}_{max} ,$$

$$and$$

$$l ( i ) = 1 - \frac{ln ε}{γ} = 1 + \frac{\vert ln ε \vert}{γ} ⇒ {l ( i )}^{- β} \approx {( \frac{γ}{\vert ln ε \vert} )}^{β} .$$

### Therefore,

$${p}_{i} \approx \frac{1}{{Z}_{lvl} {n}_{1}} \cdot \frac{{( \frac{γ}{\vert ln ε \vert} )}^{β}}{ε} ( i = {N}_{max} ( 1 - ε ) , 0 < ε ≪ 1 ) .$$

Hence the tail decays like 1/[ε|ln ε|^{β}], which is considerably flatter than the naive power law l^{-β}. This is because as the book goes deeper, the price level also becomes shorter (nₗ↓0).

### Chapter VII. C.—Optimal Node Capacity.

Based on the probabilistic model derived in the above paragraph, an embodiment may derive the further concrete model as follows.

Probability that a Whole Node is Cached.

A node sits in L1 if and only if any order in it was accessed recently. For small probabilities pᵢ, and deeper nodes are assumed to have a small node size kⱼ,

$${P}_{L 1} ( node j ) = 1 - {{\prod }_{n = 0}}^{{k}_{j} - 1} ( 1 - {p}_{{s}_{j} + n} ) \approx {{\sum }_{n = 0}}^{{k}_{j} - 1} {p}_{{s}_{j} + n} = {P}_{j} ( {k}_{j} )$$

where sⱼ in this context is defined as the global rank (1-based) of the first order stored in node j. Since every write/delete on an order requires linear adjustment of the entire storage of the node, it's reasonable to assume that every order in the same node has the same cache-hit probability

$${p}_{{s}_{j} + n} = {p}_{{s}_{j}} ( n = 0 , … , {k}_{j} - 1 ) .$$

Summing over the node gives:

$${P}_{j} ( {k}_{j} ) = {{\sum }_{n = 0}}^{{k}_{j} - 1} {p}_{{s}_{j} + n} = {k}_{j} {p}_{{s}_{j}} .$$

### Per-Order Cost Inside Node j.

Insert the last identity into the equation derived in latency cost model:

$${L}_{i} ( {k}_{j} ) = {Ak}_{j} + [ 1 - {P}_{j} ( {k}_{j} ) ] {t}_{m}$$

where A, tₘ are previously introduced in the previous subsection. Except for the additive constant tₘ, the only part that depends on the node size is

$${Δ}_{j} ( {k}_{j} ) = {Ak}_{j} - {P}_{j} ( {k}_{j} ) {t}_{m} .$$

Minimizing Δⱼ(kⱼ) at Deep Nodes.

Translation to computer-executable instructions requires Pⱼ(kⱼ) in closed form. Using the asymptotic expression derived in the previous subsection and assuming the node is “thin” compared with its distance from the top (kⱼ<<sⱼ), the following asymptotic expression is achieved for the deep nodes,

$${p}_{{s}_{j}} \approx \frac{{C}_{top}}{1 - \frac{{s}_{j}}{{N}_{max}}} {( \frac{γ}{\vert ln [ 1 - \frac{{s}_{j}}{{N}_{max}} ] \vert} )}^{β}$$

where, Cₜₒₚ is defined as:

$${C}_{top} := \frac{1}{{Z}_{\vert v \vert} {n}_{1}} .$$

Using the result:

$${P}_{j} ( {k}_{j} ) = {\sum }_{n = 0}^{{k}_{j} - 1} {P}_{{s}_{j} + n} = {k}_{j} {p}_{{s}_{j}}$$

gives,

$${Δ}_{j} ( {k}_{j} ) = {k}_{j} [ A - {t}_{m} {p}_{{s}_{j}} ] .$$

Because pₛ_{ⱼ} is already extremely small, there exists a rank s^{†}, such that

$$∃ {s}^{†} s . t . {p}_{{s}^{†}} = \frac{A}{{t}_{m}} .$$

For every node whose first rank satisfies sⱼ>s^{†},

$${Δ}_{j} ( {k}_{j} ) = {k}_{j} [ A - {t}_{m} {p}_{{s}_{j}} ] > 0$$

the coefficient in the above bracket is positive, which implies

$${k}_{j}^{*} = {k}_{min}$$

as the optimal node size.

### The Nodes Near Top of the Book.

At near the top of the book, the assumption (kⱼ<<sⱼ) no longer holds. Therefore, this case requires a more precise derivation without the linearization. Using ln(1−x)≈−x,

$${P}_{j} ( {k}_{j} ) = 1 - {\prod }_{n = 0}^{{k}_{j} - 1} ( 1 - {p}_{{s}_{j} + n} ) \approx 1 - exp ( - {\sum }_{n = 0}^{{k}_{j} - 1} {p}_{{s}_{j} + n} ) .$$

From the asymptotic expression in the previous subsection,

$${p}_{i} = \frac{1}{{Z}_{\vert v \vert} {n}_{1}} [ 1 + ( 1 - \frac{β}{γ} ) x + O ( {x}^{2} ) ] .$$

Because x≈0 at near top of the book, take only O(1) term from above. Also using pₛ_{ⱼ}₊ₙ=pₛ_{ⱼ} for (n=0, . . . , kⱼ−1), gives:

$$1 - exp ( - {\sum }_{n = 0}^{{k}_{j} - 1} {p}_{{s}_{j} + n} ) \approx 1 - exp ( - {k}_{j} {C}_{top} ) .$$

Then, the derivative of Δⱼ is given as:

$$\frac{d {Δ}_{j}}{{dk}_{j}} = A - {t}_{m} \frac{\partial {P}_{j} ( {k}_{j} )}{\partial {k}_{j}} = A - {t}_{m} {C}_{top} exp ( - {k}_{j} {C}_{top} ) ,$$

which crosses zero at

$${k}_{j}^{*} = \frac{1}{{C}_{top}} ln [ \frac{{t}_{m} {C}_{top}}{A} ] .$$

### Remark.

Thus, the optimal top-node size grows logarithmically with tₘ/A, which logically makes perfect sense because of the following reasons:
(a) a large L1-cache miss penalty tₘ pushes the designer to pack more orders into the top nodes, such that a single cache load amortizes the cost,
(b) whereas a large per-shift scan cost A favors smaller nodes to curtail the linear work done on every modification.
   Dimension analysis confirms the mathematical soundness of the formula: both tₘ and A are measured in CPU cycles, thus their ratio is dimension-free. Also, Cₜₒₚ is a dimensionless quantity, which in turn confirms

$${k}_{j}^{*}$$

as dimensionless quantity. Therefore, the above formula is well-posed.

### Practical Caveat for the First Few Price Levels.

The derivation relies on the exponential decay nₗ=n₁e^{-γ(l-1)}, which holds empirically deeper in the book. The first one to five ticks of many liquid equities exhibit a “hump”—queue lengths that are longer than the extrapolated exponential. Because the model underestimates the true hit probability for such orders in top nodes, the analytic value

$${k}_{j}^{*}$$

should be treated as a conservative lower bound for the actual top-node size. If tighter sizing is required, replace the exponential tail by a richer density—e.g. a discrete-Gamma fit or a lightweight neural regressor. Either alternative plug seamlessly into the latency formula but introduces additional parameters and runtime cost; the incremental complexity must be weighed against the (usually modest) latency savings.

### Chapter VII. D.—Online Controller (Parameter Learning; Safety Rails; Rate Limiting).

In one embodiment, the parameters used in the above (β,γ) can be learned on-the-fly and be optimized to the real time data. Every order hit generated by the matching engine can be immediately turned into one stochastic-gradient step using the otherwise idle SIMD arithmetic units.

### Data Point Definition.

For every incoming message or appropriately sampled message that is routed to a resting order an embodiment can log (or generate on-the-fly):

| Symbol | Recorded Value |
|---|---|
| lₜ | Price level index (ordinal rank) of the hit at time t |
| nₗ | Queue length just before the hit |
| | (number of resting orders at that price level) |

Probabilistic Model Recap—from the Empirical Access Model,

$${p}_{θ} ( β , γ ) = \frac{{l}^{- β}}{{Z}_{\vert v \vert} {n}_{l}}$$

where nₗ=n₁r^{l-1}, r=e^{-γ} and the Riemann zeta series Z_{|v|} can be approximated by truncating tail terms at certain threshold. The per-event negative log-likelihood is

$${l}_{t} ( θ ) = β ln {l}_{t} + ln {Z}_{\vert v \vert} ( β ) + ln ( {n}_{l} ) .$$

### Online Stochastic-Gradient Update for (β,γ).

(a) Gradients

$${\partial }_{β} {l}_{t} = ln {l}_{t} + \frac{{\partial }_{β} {Z}_{\vert v \vert}}{{Z}_{\vert v \vert}} ,$$

$${\partial }_{β} {Z}_{\vert v \vert} = - {\sum }_{m = 1}^{{M}_{max}} ( ln m ) {m}^{- β} ;$$

$${\partial }_{γ} {l}_{t} = {\partial }_{γ} ln ( {n}_{l} ) = - ( {l}_{t} - 1 ) .$$

where Mₘₐₓ is aforementioned truncating threshold. Because ∂_{β}Z_{|v|} only depends on β, an embodiment may cache the series value and its derivative and refresh them every few thousand steps for computational efficiency.
(b) Adaptive-SGD rule

$${θ}_{t + 1} = {\prod }_{( 1 , ∞ ) \times ( 0 , ∞ )} [ {θ}_{t} - {η}_{t} {g}_{t} ] ,$$

$${g}_{t} = {( {\partial }_{β} {l}_{t} , {\partial }_{γ} {l}_{t} )}^{T}$$

where ηₜ=η₀/(1+Δt) (sliding learning-rate schedule, or Adam if necessary), and Π is a projection operator onto the admissible region β>1, γ>0.

### Lightweight Streaming Alternative for γ.

Since the queue length process {nₗ} evolve much more slowly than hit locations, an embodiment may instead, estimate γ by running regression of In nₗ on l. Then,

$$ln {n}_{l} = ln {n}_{1} - γ ( l - 1 ) + {ε}_{l} .$$

Maintain exponentially weighted moments (Welford update, weight α<<1):

$${\overline{l}}_{t} = {\overline{l}}_{t - 1} + α ( {l}_{t} - {\overline{l}}_{t - 1} ) ,$$

$${\overline{y}}_{t} = {\overline{y}}_{t - 1} + α ( ln {n}_{{l}_{t}} - {\overline{y}}_{t - 1} ) ,$$

$${S}_{ll , t} = ( 1 - α ) ( {S}_{ll , t - 1} ) + α ( {l}_{t} - {\overline{l}}_{t - 1} ) ( {l}_{t} - {\overline{l}}_{t} ) ,$$

$${S}_{ly , t} = ( 1 - α ) ( {S}_{ly , t - 1} ) + α ( {l}_{t} - {\overline{l}}_{t - 1} ) ( ln {n}_{{l}_{t}} - {\overline{y}}_{t - 1} ) ,$$

where S_{ll,t} is weighted variance accumulator of price levels, and S_{ly,t} is weighted covariance accumulator between level and log-depth. Then,

$${γ}_{t} = - \frac{{S}_{ly , t}}{{S}_{ll , t}} ( e . g . α \approx 1 {0}^{- 5} for \sim 0.1 s half - life ) .$$

This estimator can run in parallel with the SGD step for β.

### Alternative Estimator Families.

In lieu of or in addition to the scalar-parametric updates described above, an embodiment may employ any supervised, unsupervised, semi-supervised, reinforcement-learning, or online-learning estimator to map runtime features (e.g., depth, queue length, volatility, time-of-day embeddings) to either
(a) the model parameters, such as β, γ of the exemplary node-hit probability model; or
(b) a direct prediction of node-hit probability Pⱼ(kⱼ) and/or the optimal node capacity

$${k}_{j}^{*} .$$

Non-limiting examples include: multi-layer perceptrons and other deep feed-forward neural networks; convolutional or recurrent nets; transformer-style feed-forward layers; gradient-boosted decision trees, boosted regression trees, random forests; linear and generalized-linear models with regularization (ridge, lasso, elastic-net); kernel machines (e.g., support-vector regression/classification); Gaussian-process regressors; mixture-of-experts; contextual bandits; and policy-gradient or value-based reinforcement-learning controllers. The estimator choice is implementation-dependent and non-limiting; outputs are post-processed, if needed, to satisfy the admissible region β>1, γ>0 and the monotone non-increasing capacity constraint

$${C}_{0} \geq {C}_{1} \geq {C}_{2} \geq ⋯ .$$

### Training Regimes (Online, Incremental, Batch).

The learning component may be trained online (e.g., per-event stochastic updates), incrementally (e.g., histogram-based boosting rounds added as data accumulate), or offline in mini-batches, with the controller applying updated parameters or models between batches subject to the rate-limiting and Δ-change constraints that bound tail latency during reconfiguration. For non-differentiable estimators (e.g., boosted trees, random forests), fitting may occur on a sidecar thread or process, with the active model swapped in atomically at batch boundaries to preserve determinism.

### SIMD and Low-Precision Packing in Estimator Implementations.

In embodiments where the estimator admits vectorized arithmetic, scalar parameters or intermediate statistics may be stored in reduced-precision formats such as FP16 or bfloat16, with accumulators retained in FP32 to avoid numerical overflow. Implementations may pack a full SIMD register of reduced-precision values and apply updates with a single vector operation. Non-limiting examples include:
(a) on x86-64, AVX-512FP16 fused multiply-add (e.g., vfmadd132ph) and AVX-512 BF16 dot-product (e.g., vdpbf16ps); and
(b) on Armv8 NEON or SVE, fused multiply-add (fmla) and widened accumulate (fmlal), and where available, BF16 dot-product (bfdot).

Where native FP16/BF16 arithmetic is unavailable, operands may be widened to FP32 for computation and compacted for storage/transport. For estimators based on decision trees or ensembles, statistics such as histogram bins, gradient/Hessian sketches, split scores, or leaf values may likewise be stored in reduced precision, or computed in FP32 and compacted for transport. These optimizations are optional and do not constrain the choice of estimator or model family; they may be enabled via compile-time flags and/or run-time feature detection (e.g., CPUID) so that the same source builds and dispatches for AVX-512, AVX2, NEON, or SVE without altering estimator semantics.

### Chapter VII. E.—Allocator Integration (Node-Size Classes; Pool Refresh; Swap-In/Out).

Integration with Node-Size Controller.

In one embodiment, the node-size update algorithm may operate as follows: at each T_{rebalance} interval (for example, every 10 ms or after 100,000 processed messages), the controller reads the latest parameters and computes an updated optimal node capacity k* for each Data Holder Node. Parameter updates are rate-limited and applied only between batches, and the controller is configured such that the node capacity cannot change by more than Δ slots per T_{rebalance} interval, thereby guaranteeing a bounded tail latency during reconfiguration. If k* differs from the current capacity by more than a predetermined threshold (for example, two or more slots), the system resizes the Data Holder Nodes by
(a) dynamically allocating new Data Holder Nodes in each memory pool based on the updated capacity, and
(b) retiring or recycling Data Holder Nodes whose capacities no longer conform to the updated setting.

If the machine-learning-based controller is disabled or diverges from acceptable operating bounds, a static policy (for example, a geometric taper sequence of 64→32→16→8) may be employed instead; such a static policy remains within the scope of the invention.

### Estimator-Agnostic Controller Contract.

Regardless of estimator family, the controller exposes a uniform interface that
(a) reads telemetry and model outputs;
(b) computes the optimal node capacity

$${k}_{j}^{*}$$

or its model parameters such as β, γ of the exemplary node-hit probability model;
(c) projects the results into the admissible set β>1, γ>0 and enforces monotonicity of capacity as a function of depth; and
(d) applies changes only between batches with a maximum permitted change of a slots per update interval, thereby preserving the latency bound during reconfiguration. (see the static-policy fallback set forth at Chapter VII. E., ‘Integration with Node-size Controller’).

### Memory Allocator Integration.

In one embodiment, the core-local memory pool (see Chapter III. D.) may pre-carve a fixed set of node-size classes—such as 8-slot, 16-slot, 32-slot, and 64-slot Data Holder Nodes—during start-up. When the order book requires growth or shrinkage, the engine can replace a node by swapping in a pre-built instance through a pointer swap, thereby avoiding the latency of a heap allocation. Where hardware constraints or memory-footprint considerations favor precise sizing, the same allocator may synthesize a node on demand by drawing from its huge-page arena and constructing only the capacity actually required. Both allocation paths may operate from the same lock-free pool, permitting implementers to combine them—for example, favoring pre-allocation on latency-critical symbols while biasing toward just-in-time allocation where cache size, TLB coverage, or order-flow volatility make finer granularity more efficient.

### Chapter VIII.—Neighbor-Aware Insertion/Deletion for Price Levels

### Chapter VIII. A.—Tree Model (Binary and Multi-Way; EQ-BST Category Notion).

As used in this Chapter VIII, the term “node” means a node of the price-level tree—that is, a Price Level Descriptor (Chapter II. K.). The “node” or “Data Holder Node” recited in the claims of this application and defined in Chapter III. B. is a distinct concept; the present Chapter VIII addresses topology operations on the price-level tree, not the contents of any Data Holder Node.

### Introduction of Improved Balanced-Search Tree.

In one embodiment, the matching engine represents each active price level as a Price Level Descriptor in a balanced search tree—preferably a red-black tree, although any other balanced search tree functions equivalently, and not limited to binary search trees. The engine inserts a new price level only when the book receives the first order at a previously empty level, and it removes a price level only when the last order at that level cancels or executes. In an embodiment, the balanced search trees implemented inside of the matching engine track the in-order predecessor and successor of every active price level; the tree algorithms accept those two pointers as explicit parameters. Supplying this contextual knowledge collapses the conventional O(log n) search phase to O(1) in most cases; the algorithm does not have to descend the tree to locate an insertion gap or an in-order successor for deletion.

### Formal Model of the Price Level Manifold and its Tree Embedding.

(a) The ordered price group: Let,

$$( ℙ , + , 0 , \leq )$$

be a countable, totally ordered Abelian group that is Archimedean-embedded in

$$( ℚ , + , 0 , \leq )$$

i.e., ∀p, q∈ [symbol] , ∃N∈ [symbol] : np≥q. No multiplicative structure is postulated here. The discreteness assumption

$$∀ p ∈ ℙ , ∃ ε > 0 : ( p - ε , p + ε ) ⋂ ℙ = \{ p \}$$

reflects that price ticks are quoted on a lattice of minimal quantum δ>0.
(b) Descriptor Fiber bundle: Define the order-descriptor bundle

$$π \text{:} 𝒟 \to ℙ , {π}^{- 1} ( p ) = \{ non - empty FIFO list of orders at price p \} .$$

For each exchange event time t∈ [symbol] the limit-order book is the partial section

$$\begin{matrix}{σ}_{t} : ℙ \to 𝒟 , & supp {σ}_{t} := \{ p \vert\end{matrix} {σ}_{t} ( p ) defined \} ,$$

which is finite because of bounded standing-order capacity. Equip supp σₜ with the sub-order inherited from [symbol] .
(c) Functional embedding into a category: Consider the category

$${BalBST}_{h} = \{ T = ( V , E , root ) \vert T is a binary search tree and height ( T ) \leq h \} ,$$

with morphisms the order- and ancestry-monotone embeddings/quotients. Fix a balancing scheme [symbol] ∈{red—black,AVL,weight—balanced, chromatic, . . . }. Then, write

$${ε}_{ℬ} \text{:} ( \begin{matrix}Finite , totally ordered sets \\ ( S , \leq )\end{matrix} ) \to {BalBST}_{O ( log \vert S \vert )}$$

for the canonical balanced-tree functor that inserts the elements of S in increasing order while continuously re-balancing under [symbol] . The state of the book at time t is then the object

$${T}_{t} := {ε}_{ℬ} ( supp {σ}_{t} ) .$$

Crucially, the in-order traversal

$$𝒾 : V ( {T}_{t} ) \to supp {σ}_{t}$$

is an order-isomorphism; however, the edge set E(Tₜ) stores balancing information only and is generally not the Hasse diagram of (supp σₜ, ≤).

### Chapter VIII. B.—Neighbor-Aware Insertion.

### Definition.

Neighbor-aware insertion is performed by splicing a new price level at the unique parent location determined by its in-order neighbors at the lowest common ancestor, using a bounded number of reference writes, independent of the number of price levels stored in the tree, and then rebalancing along a single root-to-leaf path via local transforms.

### Path-Minimum Lemma.

Let p∈ [symbol] \supp σₜ and suppose both of its immediate neighbors with respect to supp σₜ exist and are known:

$$P = {max}_{q} \{ q < p \} , S = {min}_{q} \{ q > p \} , where q ∈ supp {σ}_{t} .$$

Then, exactly one pointer in the set {right(P), left(S)} is ⊥ (null), and that null slot is the unique parent location for inserting p that preserves the binary search tree property.

### Proof to the Lemma.

Because P<S and there is no key strictly between them, every key in the right-subtree of P is ≥S; dually, every key in the left-subtree of S is ≤P. Therefore,

$$right ( P ) \neq ⊥ ⇒ min ( r i g h t ( P ) ) = S ⇒ l e f t ( S ) = ⊥ ,$$

and vice-versa. Uniqueness follows because two simultaneous nulls would contradict the strict ordering triple P<p<S. This is even more obvious when considering the lowest common ancestor

$$A = L C A ( P , S )$$

which is necessarily either P or S. If A∉{P, S} then

$$key ( P ) < key ( A ) < key ( S ) ,$$

which contradicts the assumption that no key lies strictly between P and S. Therefore, exactly one of P, S is the ancestor; the other is a descendant located in the corresponding child-side subtree. When A=P, min(right(P))=S and left(S) must be null; otherwise, there would be another key that separates P and S. The symmetric argument applies to the case A=S. All statements combined validate that exactly one pointer in the set {right(P), left(S)} is null.

### Exemplary Neighbor-Aware Splice Algorithm.

Define the following

$$\text{?} ( p , P , S ) : {T}_{t} \to {T}_{t} ⋃ \{ p \} by$$

$$\text{?} ( p , P , S ) = \{ \begin{matrix}right ( P ) := {Z}_{p} , & if right ( P ) = ⊥ \\ left ( S ) := {Z}_{p} , & otherwise\end{matrix}$$

where Zₚ is defined as the pointer address of p. In the actual implementation, Zₚ is a pointer to the Price Level Descriptor that corresponds to the price level p. The application is straightforward; apply the operator [symbol] (p, P, S) when the in-order neighbors P,S are known. By the Path-minimum lemma, this writes ≤2 pointers (not including the in-order traversal Prev and Next pointers, which would still be bounded by a constant if included) and costs O(1). After splicing, invoke the rebalance transducer

$$\begin{matrix}\text{?} : T \to T , & height ( \text{?}\end{matrix} ( T ) ) \leq \text{?} log \vert {V}_{T} \vert ,$$

where [symbol] =2 for red-black trees, and [symbol] ≈1.44 (using base-2 logarithm). Hence,

$${T}_{Insert} ( \vert {V}_{T} \vert ) = {\underbrace{O ( 1 )}}_{splice} + {\underbrace{O ( log \vert {V}_{T} \vert )}}_{rebalance} .$$

If either neighbor is not supplied, the matching engine defaults to a root-to-leaf search costing O(log|V_{T}|), thus the algorithm degrades gracefully.

### Exemplary Handling of Boundary Cases.

The algorithmic complexity bound still applies the same in the boundary cases.
(a) Leftmost insert (P=⊥): then left(S)=⊥ and p splices as S's left child

$$( left ( S ) := {Z}_{p} ) .$$

(b) Rightmost insert (S=⊥): then right(P)=⊥ and p splices as P's right child

$$( right ( P ) := {Z}_{p} ) .$$

(c) Empty tree (P=⊥,S=⊥): p becomes the root.

### Application to the Matching Engine.

During the insertion workflow shown in FIG. 7—whether invoked by a fresh order (Chapter V. D.) or by a modification that re-inserts an order—control ultimately reaches either block 705 or 706:
(a) Path from block 702 to block 706. The tree of Price Level Descriptors is empty; the incoming node becomes the root and no rebalancing is required.
(b) Path from block 703 to block 706. The matching engine already holds references to the highest-priority Price Level Descriptors (elements 803 and 804 in FIG. 8). Each descriptor maintains direct previous and next pointers to its in-order neighbors, enabling constant-time identification of the parent slot. The splice itself therefore costs O(1), followed by an O(log|V_{T}|) rebalancing step.
(c) Path from block 704 to block 706. The absence of a Price Level Descriptor at the target price has already been confirmed—either by the preceding traversal of the descriptor tree (rooted at elements 802 and 805 in FIG. 8) or by a lookup in the auxiliary hash map referenced in Chapter V. D. That same search returns the immediate in-order predecessor and successor, allowing the neighbor-aware splice to be executed in constant time. Consequently, only the O(log|V_{T}|) rebalancing step remains.
(d) Block 705. This is the sole path that attaches the incoming order to the existing price level, which does not require modification of the Price Level Descriptor tree.

### Scope Note—Illustrative Store Counts.

Where this section or its examples enumerate a particular number of reference writes (e.g., “≤4 stores”), those counts illustrate one canonical script; the limiting definition is the genus statement above. Functionally equivalent scripts that group or split primitives may differ by a constant without departing from this disclosure.

### Chapter VIII. C.—Neighbor-Aware Deletion.

### Definition.

Neighbor-aware deletion is performed by replacing a designated node with an in-order neighbor of the designated node—the in-order successor, the in-order predecessor, or either as determined at deletion time—using a bounded number of reference writes, independent of the number of price levels stored in the tree, and then rebalancing along a single root-to-leaf path via local transforms. The following paragraphs describe successor-graft as worked example.

### Notation and Primitives: For any Node v Write,

(a) par(v): parent pointer, possibly ⊥ (null pointer) if v is the root;
(b) left(v), right(v): child pointers, also possibly ⊥.

Define three constant-time primitives (each performs ≤2 pointer stores, not including Prev/Next pointer adjustments for the in-order neighbors, which would still be bounded by a constant if included), where each arrow means value assignment in the following table:

| Symbol | Effect on pointers | # of stores |
|---|---|---|
| Transplant(u, v) | childₚₐᵣ₍ᵤ₎ ← v; par(v) ← par(u) | ≤2 |
| Attach_L(u, v) | left(u) ← v; par(v) ← u | 2 |
| Attach_R(u, v) | right(u) ← v; par(v) ← u | 2 |

All primitives treat ⊥ on the right-hand side as no-op store.

Piecewise successor-graft: Let Z be the node to delete, supplied by the caller together with its in-order successor Y, if any. When Y exists, two mutually exclusive cases exhaust the topology of Y; a separate case applies when Y does not exist:

### Notational Convention.

The following exemplary functions are provided in closed-form notation and use left-to-right composite reading—i.e., the leftmost operation is applied first. This convention is local to this sub-section and differs from the right-to-left operator composition convention used elsewhere in this specification (e.g., the deletion map Π at Chapter VI. D.).

### Case A—Successor is the Direct Right Child:

$$Y = right ( Z ) ,$$

$${SG}_{A} ( Z , Y ) = Transplant ( Z , Y ) ∘ Attach\_L ( Y , left ( Z ) ) .$$

which has pointer cost of Transplant+Attach_L≤4 stores. No aliasing arises because the original right(Z) is now the root of the graft and is never re-attached to itself.

### Case B—Successor is Deeper in the Right Subtree:

$$Y \neq right ( Z ) .$$

In this case, let Q=par(Y), where necessarily Q≠Z. The standard algorithm removes Y from its current position, fills the gap with right(Y), then transplants Y to Z's position and attaches both of Z's subtrees.

$$S {G}_{B} ( Z , Y ) = Transplant ( Y , right ( Y ) ) ∘ Attach\_R ( Y , right ( Z ) ) ∘ Transplant ( Z , Y ) ∘ Attach\_L ( Y , left ( Z ) )$$

which has pointer cost of 2 Transplant+Attach_R+Attach_L≤8 stores. Ordering guarantees that each pointer read in a later primitive still contains its original value:
(a) right(Y) is read before any primitive modifies it;
(b) right(Z) and left(Z) are untouched until they are moved under their new parent Y.

### Case C—Z has No Successor:

$$Y = ⊥ .$$

In this case, there is no in-order successor to Z and, by definition, Z has no right child. Then, the deletion reduces to the one-child/leaf case handled in the usual binary search tree delete routine. Formally,

$$S {G}_{C} ( Z ) = Transplant ( Z , left ( Z ) ) .$$

The Transplant overwrites the appropriate child pointer of par(Z) and, if left(Z)≠1, updates par(left(Z)). Thus SG_{C} has a pointer cost of at most 2 stores (only one store when left(Z)=⊥).

### Exemplary Successor-Graft Algorithm—the Algorithm Becomes

$$SG ( Z , Y ) = \{ \begin{matrix}{SG}_{A} ( Z , Y ) , & Y = right ( Z ) \\ {SG}_{B} ( Z , Y ) , & Y \neq right ( Z ) \\ {SG}_{C} ( Z ) , & Y = ⊥\end{matrix} .$$

The application of the operator is just as straightforward as it is for the neighbor-aware insertion case. It is applied using the point of deletion, Z, and its in-order successor, Y.

### Complexity and Correctness.

The following statements hold
(a) Lookup phase: when Z is supplied and Y is supplied or known to be ⊥⇒O(1).
(b) Pointer rewrites: constant (at most 8 stores).
(c) Balancing fix-up: Let T⁻=Tₜ be the state of the tree before the operation and T⁺=SG(Z, Y)(Tₜ) be the state immediately after the graft. The set of red-black invariants i_{RBT}, is preserved throughout the tree except, at most, locally at the original position of the successor Y; this statement holds for other balancing schemes, such as AVL balance-factor invariants. To restore the invariants, a classical delete-fixup algorithm is invoked. This process traverses a single ancestor path from the point of the local violation up to the root, which has a maximum length of O(log|V_{T}|). Along this path, it performs a constant amount of work per node (e.g., rotations and color changes). The worst-case for this fix-up is therefore O(log|V_{T}|), matching the neighbor-aware insertion bounds.

### Application to the Matching Engine.

The neighbor-aware deletion routine is invoked when a Price Level Descriptor becomes empty—more commonly after an order is cancelled or modified, and less frequently when the remaining quantity at that price is fully executed. Because each descriptor stores direct pointers to its immediate in-order predecessor and successor, the matching engine can supply the addresses of the descriptor to be removed (Z) and its in-order successor (Y, if any) to the successor-graft operator without first traversing the Price Level Descriptor tree. The graft rewrites at most eight pointers in constant time; when Y is absent (Case C), the cost drops to at most two pointer stores (not accounting for the Prev/Next pointer adjustment costs). A standard delete-fixup walks up a single ancestor path to restore the tree's balancing invariants, performing O(log|V_{T}|) work. Consequently, the end-to-end cost of excising a Price Level Descriptor is bounded by

$${T}_{Delete} ( \vert {V}_{T} \vert ) = {\underbrace{O ( 1 )}}_{successor - graft ( SG )} + {\underbrace{O ( log \vert {V}_{T} \vert )}}_{rebalance} ,$$

matching the complexity guarantee established for neighbor-aware insertion.

### Scope Note-Illustrative Store Counts.

The “≤4/≤8/≤2 store” tallies in Cases A-C enumerate one canonical realization using the primitives given in this section. Implementations that, for example, coalesce parent/child updates, mask writes to L, or maintain Prev/Next links inline may adjust the constant. The normative requirement is the section's opening definition.

### Chapter VIII. D.—Variants: Red-Black, AVL, B/B+-Tree, Weight-Balanced, Randomized (Expected Case).

### Mathematical Background and Scope.

The neighbor-aware insertion/deletion framework is not confined to binary search trees; it applies across the family of balanced search trees, including binary and m-ary variants. In practice, the engineering procedure is straightforward: when predecessor and successor links are available, perform insertion by splicing the new node in O(1) time and perform deletion by grafting the in-order successor or predecessor (i.e., replacing the target node with its in-order neighbor) in O(1) time; in both cases, follow with the tree's standard O(log n) rebalancing. A person having ordinary skill in the art can readily express analogous update equations for common variants-red-black, AVL, B/B+-tree, weight-balanced, and later-developed balanced trees.

### Exemplary Procedures for the Multi-Way Trees.

(a) Neighbor-aware insertion.
   In an m-ary EQ-BST, the interval (P,S) selects a unique gap at

$$α = {LCA}_{T} ( {loc}_{T} ( P ) , {loc}_{T} ( S ) ) ;$$

where loc_{T}(k) is the unique node of T containing key k. The splice descends into exactly one child toward that gap.
(b) Neighbor-Aware Deletion (Successor-Graft).
   To delete key z choose y=succ_{T}(z) (or y=pred_{T}(z) if z is rightmost). The pair (z,y) determines a unique corridor anchored at

$$α = {LCA}_{T} ( {loc}_{T} ( z ) , {loc}_{T} ( y ) ) .$$

Replace z by y with a constant number of pointer rewrites inside the subtree of α; repair any underflow by sibling borrow/merge along that corridor bottom-up toward the root.

### Embedding/Quotient-Morphism Balanced Search Tree.

As used herein, an “Embedding/quotient-morphism balanced search tree” (hereunder EQ-BST) is a search tree that:
(a) preserves the in-order key sequence during any rebalancing operation;
(b) performs rebalancing via local, structure-preserving transforms (e.g., rotations; re-colorings; split/merge/borrow/redistribute; separator promote/demote) that modify at most a constant number K of nodes or pages per transform, where K is independent of the number of stored keys n; and
(c) maintains height O(log n).

Structures whose rebalancing includes subtree rebuilds that modify more than a constant number of nodes in a single operation (e.g., scapegoat-style rebuilds) are not EQ-BSTs for purposes of this specification. Such rebuilds must not be confused with the ordinary fix-up walk in balanced trees within the EQ-BST category, where rebalancing is carried out as a sequence of local transforms along the update-to-root path—each transform touches at most a constant number K of nodes, although the walk may span O(log n) levels.

### Application of the Generalized Balanced Tree Category.

The neighbor-aware insertion and deletion primitives lift from the binary case to embedding/quotient-morphism balanced search trees (EQ-BSTs) without change. This is because these operations rely only on in-order traversal and subtree ancestry relationships, properties which remain invariant under the broader class of structure-preserving embedding or quotient morphisms allowed in the EQ-BST category.
(a) The following non-exhaustive, illustrative instances of EQ-BST:
   (i) Balanced binary search trees: red-black, AVL, weight-balanced, and their top-down 2-3-4 encodings;
   (ii) B-trees of arbitrary order—from 2-3-4 trees and 2-4 trees up to high-fan-out page-oriented variants;
   (iii) B+-trees, where keys reside in leaves and internal nodes hold only separators;
   (iv) B*-trees, which postpone splits by redistributing keys between siblings to improve space utilization;
   (v) B-link trees and blink-balanced trees, whose extra right-sibling pointers support concurrent updates without global locks;
   (vi) (a, b)-trees in their many fixed-degree specializations, such as 2-3 trees, 3-5 trees, and 4-7 trees;
   (vii) Fractal trees and BE-trees, which choose m and d to maximize write buffering while still meeting the category's balance constraints;
   (viii) Cache-oblivious B-trees (e.g., van Emde Boas-layout trees) where fan-out is tuned implicitly by the memory hierarchy but remains bounded between d and m;
   (ix) Prefix B-trees and compressed-key B-trees that store only compressed discriminators in internal nodes;
   (x) UB-trees and other space-filling-curve indexes that keep z-values in multi-way balanced nodes.
(b) The next list captures probabilistic structures that are not in the EQ-BST category in a deterministic sense, but exhibit the same behavior in expectation:
   (i) Classical Binary Treap—a binary search tree (BST) ordered by key, with a heap ordering by a random priority at each node;
   (ii) Generalized Multiway Treap—a multiway search tree (analogous to a B-tree) that uses randomness (e.g. random priorities or skip-list style promotions) to maintain balance. Examples include skip trees (randomized multiway trees derived from skip lists) and B-Treaps (randomized B-tree analogs).
      For every structure in the first list (a)—and, for the second list (b), with high probability under their standard randomness assumptions—the matching engine can obtain the in-order predecessor and successor of a located price level in O(1) time (via maintained neighbor links), then perform the necessary splice, split, merge, or borrow using a constant number of pointer writes. The subsequent rebalancing touches at most one root-to-leaf path, preserving the overall bounds:

$${T}_{Insert} ( n ) = {\overbrace{O ( 1 )}}^{splice} + {\overbrace{O ( log n )}}^{rebalance} ,$$

$$and$$

$${T}_{Delete} ( n ) = {\underbrace{O ( 1 )}}_{successor - graft ( SG )} + {\underbrace{O ( log n )}}_{rebalance} .$$

These bounds are independent of whether the book is maintained as a binary tree, a high-fan-out B+-tree, or any other member of the EQ-BST category, and they extend to the randomized structures in the expected-case sense.

### Chapter IX.—Hardware Accelerator

### Chapter IX. A.—Hardware Accelerator Overview.

In one embodiment, the price level indexing and maintenance logic described in Chapter VIII is realized as a dedicated order-book price-level accelerator (OBA) that operates on price level metadata. The OBA comprises:
(a) descriptor memory implemented as a contiguous array of fixed-size Price Level Records;
(b) tree logic that represents those records as nodes of a balanced search tree keyed by price;
(c) neighbor-link registers that hold per-node predecessor/successor references;
(d) an insertion pipeline that performs the neighbor-aware structural splice of Chapter VIII. B. given supplied in-order neighbors (the neighbor discovery itself, when not supplied externally, may invoke the tree search described in Chapter VIII. B.);
(e) a deletion pipeline that performs the corresponding neighbor-aware structural graft of Chapter VIII. C.; and
(f) a fix-up micro-sequencer that executes constant-size local transforms (rotations, recolorings, split/merge/redistribute, or height updates) along at most a single root-to-leaf path, consistent with the EQ-BST discipline and the procedures summarized at Chapter VIII. D.

The accelerator services one symbol (instrument) per core to preserve time priority and may be instantiated in multiple copies to process one or more symbols in parallel.

### Software/Hardware Equivalence.

All accelerator behaviors are observationally equivalent to the software procedures in Chapter VIII.: given the same sequence of price level events and neighbor hints, both embodiments produce isomorphic trees with identical in-order sequences and the same top-of-book outcomes.

### Non-Limiting Figures.

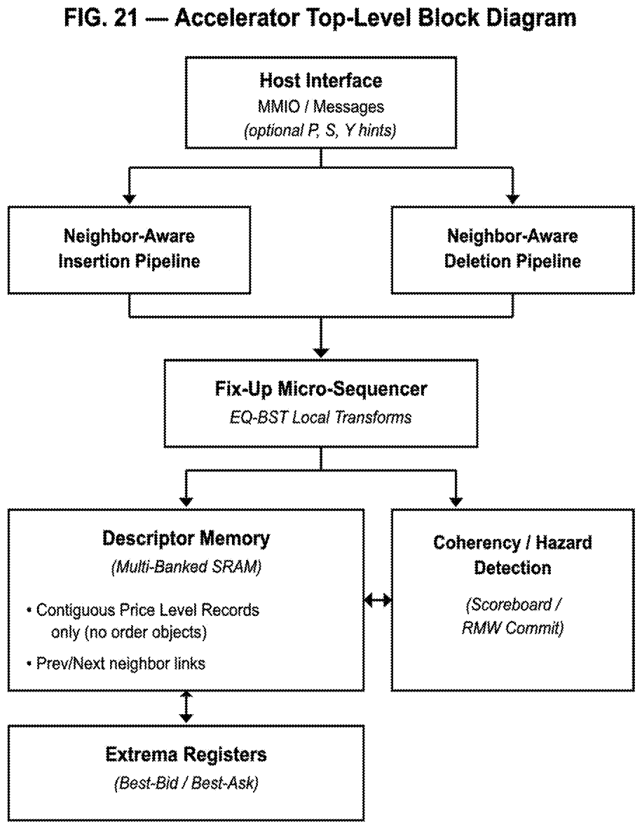

FIG. 21 illustrates the accelerator top-level block diagram, depicting descriptor memory, pipelines, fix-up sequencer, coherency, and host interface. FIG. 22 illustrates the Price Level Record layout. FIG. 23 illustrates the insertion/deletion pipelines. FIG. 24 illustrates the tick-comparator and configuration registers. The depicted arrangements are non-limiting examples of one or more embodiments described herein and do not restrict the scope of the disclosure.

### Chapter IX. B.—Descriptor Memory and Banking (FIG. 22).

Price Level Record layout.

As used herein, ‘Price Level Descriptor’ (software) and ‘Price Level Record’ (hardware) have the meaning set forth at Chapter II. K., ‘Price Level Descriptor/Price Level Record/Price Level Pointer’.

For B/B+-tree variants, price level records occupy the leaf level and include price, aggregate quantity, and leaf-sibling (prev/next) links; internal page (see Chapter II. H.) nodes separately hold arrays of keys and child references (see Chapter IX. C.). To enable page-local transforms, each leaf record additionally stores a leaf-container reference (a handle to its owning internal page) and, optionally, a slot-in-page subindex. Optional fields include a side flag (bid/ask) and cached best-of-book marks to speed extrema updates (see Chapter V. C. and FIG. 8 elements 803/804). Writes to any single field are performed as one word write when the field is word-aligned and the memory supports byte/word enables; otherwise the update completes in one or a few cycles using a bounded sequence of word writes.

### Descriptor Memory and Banking.

The descriptor memory is realized as multi-banked SRAM (or equivalent on-chip RAM) comprising M banks with interleaved addressing on the record index. Each record is RAM-word/burst aligned and may occupy an integral number of RAM words. A read or write of one record completes in one or a few cycles, subject to port and bank availability; implementations may use dual-ported or multi-ported macros where available. Bundles of dependent fields (e.g., parent and one child) can be fetched in parallel when they map to distinct banks; otherwise, they are issued over successive cycles. Banking parameters (M, interleave stride) are design-time or configuration-time constants and do not constrain the EQ-BST discipline. The constant bounds cited herein apply to the number of distinct reference fields edited per operation; elapsed cycles may exceed one due to port/bank scheduling in this SRAM. The contiguous, fixed-slot layout mirrors the contiguous, fixed-size pools described for software in Chapter III. D.

### Reference Encoding.

References include, without limitation, physical pointers, indices, handles, or other reference forms (Chapter II. A.). An FPGA implementation often uses index references to the descriptor array; a CPU implementation may use either pointers or indices. Conversions between encodings are strict isomorphisms that preserve the EQ-BST structure (Chapter VIII. D.).

### Record Allocation.

Hardware allocation of new Price Level Records draws from a free-list in descriptor memory, implemented as a singly linked list of free indices, with the head cached in a control register. Returning a record pushes its index back to the list. Allocation does not touch order objects or Data Holder Nodes. In overlapped variants, the free-list uses an (index, generation) pair or an epoch/quarantine to prevent ABA reuse while readers are active.

### Chapter IX. C.—Insertion/Deletion Pipelines; Fix-Up Micro-Sequencer (FIG. 23).

As used in Chapters IX. A. through IX. G. in connection with the order-book price-level accelerator, the term “node” carries the meaning set forth in Chapter VIII (a node of the price-level tree, i.e., a Price Level Descriptor of Chapter II. K.). This construction does not apply to Chapter IX. H., where order-queue storage nodes and slot regions retain the meanings set forth elsewhere in this specification. References to Data Holder Nodes (Chapter III. B.) elsewhere in this disclosure are unaffected by this paragraph.

### Tree Logic and Local-Transform Fix-Up.

The OBA implements any embedding/quotient-morphism balanced search tree (EQ-BST) per Chapter VIII. D. For binary EQ-BSTs (e.g., red-black, AVL, weight-balanced), the record layout of previous subsection applies and the fix-up micro-sequencer issues RotateL, RotateR, Recolor, and HeightAdj micro-ops, each touching a constant number of nodes along at most one root-to-leaf path. For B/B+-tree variants, price level records reside in the leaf level, while separate internal page (see Chapter II. H.) nodes hold arrays of keys and child references; the fix-up micro-sequencer applies constant-size local transforms at the page granularity (e.g., split/merge/redistribute) that preserve in-order sequence per Chapter VIII. D. The leaf container reference (Chapter IX. B.) allows fix-up to locate and modify the owning page without a scan.

### Neighbor-Aware Insertion Pipeline.

When the host supplies the in-order predecessor P and successor S for a missing price (as in Chapter VIII. B.), the OBA executes a four-stage insertion:
(a) Allocate a free record slot and stage its address (reference) in a pipeline register;
(b) Attach the record as the null child of exactly one of {right(P), left(S)} according to the path-minimum lemma at Chapter VIII. B.;
(c) Update neighbor links (Prev/Next) for the new node and its two neighbors with a constant-bounded number of stores (bound is on fields touched); and
(d) Schedule fix-up on the unique update-to-root path via local transforms.

If hints are absent or fail validation against current links, the OBA finds P and S by an internal tree search in O(log n) and then proceeds; (per the constant-bounded structural-edits property set forth in Chapter IX. C., ‘Constant-bounded structural edits’, below).

### Neighbor-Aware Deletion (Successor-Graft as Worked Example) Pipeline.

When the host supplies a node Z to remove and its in-order successor Y, the OBA performs the piecewise successor-graft of Chapter VIII. C. The pipeline executes the primitive Transplant, Attach_L, and Attach_R edits, each a constant-size pointer rewrite, and then invokes delete-fix-up along one root-to-leaf path. Definition (for clarity): childpar(u) writes left(par(u)) if u is its parent's left child; otherwise, it writes right(par(u)). If Y is not supplied or is stale, the OBA locates Y internally in O(log n) and proceeds. (per the constant-bounded structural-edits property set forth in Chapter IX. C., ‘Constant-bounded structural edits’, below).

### Constant-Bounded Structural Edits (Counts Stated Before any Rebalancing Step).

For both hardware and software embodiments, attaching a new node with known neighbors or grafting a successor is realized as a bounded, constant number of single-word reference stores before any rebalancing step. Neighbor-link (Prev/Next) adjustments likewise complete in a constant-bounded number of stores per link. These bounds apply to the number of distinct reference fields edited per operation and are independent of book size; elapsed cycles may exceed one due to banking/port scheduling in descriptor SRAM (Chapter IX. B.). Interpretive note: numerical pointer-write counts given anywhere in the specification are illustrative, in the same sense that the bitmask update equations are exemplary and non-unique (Chapter VI. C.). The controlling, limiting statements are those at the start of the respective sections-Chapter VIII. B. (insertion) and Chapter VIII. C. (deletion)-which require a bounded, constant number of single-word reference writes prior to any rebalancing.

### Chapter IX. D.—Neighbor Links; Extrema Registers & Snapshot Semantics.

The OBA maintains Best-Bid and Best-Ask registers that point to the current extrema records, permitting constant-time retrieval of top-of-book. The host may request depth snapshots computed solely from records by traversing successor links from an extremum. Snapshots use a quiescent cut: the OBA captures the extremum reference and a monotonic snapshot epoch; traversal follows successor links visible under that epoch. Implementations may use a read fence or per-node version counters (seqlock pattern) to avoid torn reads during concurrent maintenance: pointer rewrites publish under a commit epoch, and readers either (i) consult a shadow image at/before that epoch or (ii) validate identical version reads before/after traversal.

### Best-of-Book Hot Path.

The OBA exposes one-cycle read ports for Best-Bid/Best-Ask registers in the accelerator clock domain. Host reads across clock domains use synchronized shadow registers. Updates to these registers are triggered by (i) insertion at a new extremum, (ii) deletion of the current extremum, or (iii) decrements that exhaust the extremum's aggregate quantity, and are handled as part of the same bounded store scripts as the structural edits (see Chapter V. C. and FIG. 8, elements 803/804).

### Chapter IX. E.—Host Interface; Tick-Indexed Comparators (FIG. 24).

A memory-mapped or message-based host interface accepts price level update messages (create/increment/decrement/remove) and optional neighbor hints (P,S, Y). Hints are validated against current links; on mismatch the OBA disregards the hint and returns a diagnostic code while completing the operation. The interface complements the lock-free queues already disclosed (Chapter IV.) and preserves the single-thread-per-symbol sequencing semantics.

### Tick-Indexed Comparators.

Prices inhabit a discrete tick lattice as stated in Chapter VIII. A. In hardware, comparisons may be performed on an integer tick index

$$k = ⌊ \frac{P - {P}_{0}}{δ} ⌋$$

where P₀ (base price) and δ (tick size) are programmable OBA configuration registers. Each record may store k directly or compute it on ingress using integer fixed-point (e.g., reciprocal-multiply+shift); comparator parameters are fenced when P₀ or δ change to avoid races with in-flight compares. The tree key is either P or k, with an order isomorphism between them for fixed P₀, δ. When the tree key is P, changing P₀ or δ updates only comparator parameters and does not disturb the in-order sequence. When the key is stored k, changing P₀ or δ requires re-deriving keys or rebuilding to preserve order.

### Chapter IX. F.—Coherency/Hazard Handling; Atomicity; Configuration Images.

In one embodiment, the OBA processes exactly one update at a time per symbol. In variants that allow limited overlap, a coherency module prevents conflicting edits by (i) scoreboarding nodes that may be touched by the structural edit and its fix-up, i.e., Z, Y, P, S and the nodes on the selected fix-up corridor toward the root, (ii) rejecting or deferring a message that would alias any currently claimed node or its Prev/Next neighbors, and (iii) committing the set of pointer updates as a read-modify-write transaction that either completes in full or is retried. The corridor is discovered incrementally during the ascent; the scoreboard extends the claim one node at a time. Host reads are either stalled or routed to the pre-commit image to prevent torn observations. In operation, the host processor dispatches price level update operations to the OBA via the host interface and processes completion responses—including diagnostic codes and updated extrema—returned by the OBA.

### Atomic Word Updates (Software Variant).

Although the core matcher is single-threaded per symbol, an embodiment that permits concurrent maintenance (e.g., maintenance thread or multi-symbol service) performs each reference edit (left, right, parent, prev, next) as a single-word atomic read-modify-write, for example compare-and-swap (CAS) or load-linked/store-conditional (LL/SC), with release/acquire ordering analogous to the lock-free queues (Chapter IV.-A.). Under contention, retries may be unbounded; the design targets obstruction-free or lock-free progress rather than wait-free bounds. Primitive counts bound the number of distinct fields to update per operation, not the retry count under contention.

### Aggregate-Quantity Semantics.

The aggregate quantity field of a record is updated by a single word-sized store when only the owner thread mutates it, or by CAS when concurrent writers may race (e.g., asynchronous decrement by a separate execution unit). The value is application-level and does not participate in tree balancing; therefore, its atomicity is independent of the structural pointer edits above.

### Reconfigurable-Logic Realization.

In one embodiment, the OBA is implemented in reconfigurable logic (e.g., FPGA). A configuration image (bitstream) defines: (i) the descriptor memory (bank count, record size, interleave); (ii) tree logic and the fix-up micro-sequencer for the selected EQ-BST discipline; (iii) neighbor-link registers; (iv) the insertion and deletion pipelines; (v) the coherency module; (vi) the tick-comparator parameters; and (vii) the host interface registers and message formats. Loading the configuration image instantiates a complete OBA instance that performs neighbor-aware splice and neighbor-aware deletion (e.g., successor-graft or predecessor-graft) followed by local-transform rebalancing using references as defined at Chapter II. A. The host interface includes CDC synchronizers for multi-clock deployments.

### Chapter IX. G.—Micro-Architectural Variants (Red-Black/AVL/B/B+ Selectable).

The configuration image may select among red-black, AVL, or B/B+-tree balancing at synthesis time, or expose a microcode table of local transforms that a privileged agent can patch while the engine is quiescent (or via shadow-update with an atomic switch) within predefined safety bounds. The observable behavior at the host interface remains a balanced search tree that preserves in-order key sequence and bounds fix-up to a single root-to-leaf path.

### Chapter IX. H.—Order-Queue Storage in Hardware Circuitry.

### Order-Queue Storage Accelerator Overview.

The following describes non-limiting exemplary embodiments in which one or more of the order-queue storage operations described in Chapters V-VI are realized in hardware circuitry (Chapter II. M.), including without limitation as a standalone accelerator circuit, as a functional unit within a larger system-on-chip, or as any other hardware-circuitry embodiment per Chapter II. M. The order-queue storage accelerator operates on order entries—storing order objects or references thereto in contiguously addressable slot regions—and is distinct from the price-level accelerator (OBA) described in Chapters IX. A.-G., which operates on price-level metadata. The two accelerators may be instantiated independently, together on the same device, or one or both may be realized in software; any combination is within the scope of this disclosure.

### Scope of On-Chip Memory.

As used herein, “on-chip memory” includes memory that is directly accessible by the accelerator circuit's logic without traversing a host memory bus. A “host memory bus,” as used herein, means a fabric requiring address translation through a host-controlled memory controller or root complex, such as a PCIe root complex DRAM channel or a board-level DDR channel; the host memory bus does not include coherent or low-latency die-to-die interconnects or coherent fabrics extending from the accelerator circuit, even where such interconnects share physical-layer infrastructure with a host I/O bus. On-chip memory encompasses, without limitation:
(a) memory residing on the same die as the logic, including block RAM, distributed RAM, embedded SRAM, ultra-RAM, register files, and content-addressable memory;
(b) memory residing on a separate die that is co-packaged with the logic and reachable via a die-to-die interconnect, including without limitation 2.5D-stacked SRAM, 3D-stacked SRAM, V-Cache, and high-bandwidth memory (HBM), and including embodiments in which a memory die is hybrid-bonded to the logic die regardless of whether such configurations are characterized as single-die or multi-die;
(c) memory attached to the accelerator circuit via a coherent or low-latency interconnect, including without limitation CXL, CCIX, NVLink C2C, Infinity Fabric, UCIe, or a proprietary coherent fabric, that the accelerator circuit addresses as a contiguously addressable region; and
(d) other architectures providing equivalent direct, low-latency access from the accelerator circuit's logic to the memory cells.

The qualification turns on access path—defined as the sequence of fabric and protocol elements traversed between the accelerator circuit's logic and the memory cells—rather than physical die residency.

### Co-Packaged On-Chip Memory.

In some embodiments, the on-chip memory comprises memory residing on a die distinct from but co-packaged with the accelerator logic and reachable via a die-to-die interconnect. Such embodiments include configurations in which a memory die is mounted on a silicon interposer with the logic die, in which a memory die is bonded directly atop or beneath the logic die, in which a memory die is co-packaged on an organic substrate with a silicon bridge, and in which a memory die is co-packaged within a system-in-package or multi-chip module assembly. Such embodiments share with same-die embodiments the property that the memory cells are reachable from the accelerator circuit's logic without traversing a host memory bus.

### Integrated Price Level Indexing.

In one embodiment, the order-queue storage accelerator circuit and the price-level accelerator described in Chapters IX. A.-G. are combined into a single accelerator circuit. In such embodiments, the insertion logic or removal logic supplies in-order neighbor references directly to price level indexing logic within the same circuit, and the price level indexing logic performs structural modifications to the price level indexing data structure without routing the neighbor references through a host interface. The combined circuit operates on both order entries in contiguously addressable slot regions and price-level metadata in the price level indexing data structure.

### Network-Attached Deployment.

In one embodiment, the order-queue storage accelerator circuit resides within a network interface device, a data processing unit, or SmartNIC (Chapter II. M., item (g)), and receives order-entry operations from a network parser pipeline implemented on the same device. In such embodiments, incoming network packets are parsed and converted to insertion, removal, or modification operations that are supplied directly to the accelerator circuit without traversing a host interface. The accelerator circuit may operate without a communicatively coupled host processor on the data path; a host processor, if present, may serve a control-plane role such as configuration, monitoring, or logging.

### Multi-Port On-Chip Memory.

The on-chip memory may provide at least two independent access ports, enabling concurrent access to the indicator storage and the contiguously addressable slot region within a single operation. The independent access ports may also enable concurrent read access and write access to different slots of the contiguously addressable slot region—for example, reading a source slot during a relocation while writing a destination slot, or reading the indicator storage while writing an entry into a selected slot. Non-limiting examples include dual-port block RAM, multi-port register files, or banked SRAM with independent read and write ports.

### Clock-Domain Co-Location of Indicator Storage and Slot Region.

In one embodiment, the indicator storage and the contiguously addressable slot region are accessible within a single clock domain, such that accesses by the operation logic to the indicator storage and the contiguously addressable slot region occur without a clock-domain crossing synchronization delay. In alternative embodiments where the host processor and the accelerator circuit operate in different clock domains, the host interface includes synchronization logic, but the indicator storage and slot region remain co-located within the accelerator clock domain.

### Insertion Logic.

The insertion logic is configured to determine a target insertion position according to the predetermined priority rule using the priority indicators—including, in embodiments that include a priority-resolution circuit (Chapter II. E., “Priority-resolution circuit”), reading the indicator storage to identify a slot of interest as set forth at Chapter II. E., ‘Priority-resolution circuit’ and ‘Relationship to software embodiment’—and to write an entry into a selected slot of a contiguously addressable slot region of the memory, including on-chip memory in some embodiments. When the selected slot region lacks a free slot, the insertion logic may invoke capacity overflow handling logic that performs a directed relocation cascade (Chapter V. B.) within the memory, including on-chip memory in some embodiments, relocating one or more entries across one or more slot regions in a bounded number of hops, or that allocates a new slot region.

### Removal Logic.

The removal logic is configured to remove or invalidate an entry stored in a designated slot and may update the priority indicators for affected slots. Removal may, where the applicable indicator encoding so provides, mark the slot as vacant by writing a neutral indicator value (Chapter II. F.) without physically erasing the slot payload; in further embodiments, entries remaining in the slot region may be compacted (as set forth in Chapter VI. D.) or rearranged in software (as set forth in Chapter V. D.). Each of the non-erasure, compaction, and rearrangement realizations is within the scope of the disclosed removal logic.

### Indicator-Update Logic (Optional).

Optional indicator-update logic may be separately instantiated or merged into insertion logic, removal logic, shared datapath or control circuitry, or any combination thereof, and is configured to update the priority indicators for affected slots in response to a change in the entries stored in the slot region. In bitmask-based embodiments (Chapter VI), the update logic performs shift, mask, and bitwise-logical operations on the indicator storage in a constant-bounded number of cycles per affected entry, consistent with the bit-manipulation operations described in Chapter VI. In hardware, these operations may be realized as combinational datapath stages without requiring execution as processor instructions.

### On-Chip Order-Identifier Indexing.

In one embodiment, the accelerator circuit further comprises an on-chip indexing structure (e.g., a hash table realized in block RAM, a content-addressable memory, or any other associative lookup structure) that maps each order identifier to a storage location of a corresponding entry within the contiguously addressable slot region. The on-chip indexing structure is updated by the insertion logic, the removal logic, or the indicator-update logic in response to storing, removing, invalidating, or relocating an entry, consistent with the software-embodiment indexing data structure described in Chapter V. D. In embodiments where the accelerator circuit operates without a host processor on the data path and includes removal logic, insertion logic, or both—for example, within a network interface device, a data processing unit, or SmartNIC—the on-chip indexing structure enables such logic to resolve an incoming cancel or modify request to a target slot without requiring a host-mediated lookup.

### Pipelined Operation Acceptance.

In one embodiment, the insertion logic, the removal logic, or the indicator-update logic is organized as a multi-stage pipeline, wherein the accelerator circuit accepts a subsequent operation while a preceding operation is being processed. The pipeline initiation interval—the minimum number of clock cycles between the start of consecutive operations—may be less than the total number of clock cycles required to complete one operation. Non-limiting pipeline stage decompositions include without limitation: read indicator storage, resolve priority or identify free slot, write slot payload, and update indicator storage.

### Coherency and Hazard Handling in Pipelined Operation.

In embodiments that support pipelined operation acceptance per the “Pipelined operation acceptance” disclosure above, the accelerator circuit may include coherency and hazard-resolution logic that prevents conflicting edits between in-flight operations. Coherency and hazard-resolution logic may be realized by any mechanism that prevents an externally observable state of the engine instance from presenting incoherent slot payload and priority-indicator interpretations for the affected operation scope, including by deferring exposure of incoherent state to an external observer or to a subsequent operation that relies on the slot payload or priority-indicator state.

### Non-Limiting Realizations of the Coherency and Hazard-Resolution Logic.

Non-limiting realizations of the coherency and hazard-resolution logic include any one or any combination of the following, alone or in combination with other conflict-resolution, versioning, arbitration, logging, serialization, replay, transactional, or snapshotting mechanisms:
(a) Indicator-storage forwarding: in-flight writes to the indicator storage are forwarded to subsequent reads by a priority-resolution circuit or by insertion, removal, or indicator-update logic, such that a subsequent operation reads the pending indicator state produced by a preceding in-flight operation before that state is committed to the indicator storage.
(b) Slot-payload forwarding: in-flight writes to a slot of the contiguously addressable slot region are forwarded to subsequent reads of the same slot, such that a subsequent operation targeting the slot observes the pending slot state produced by a preceding in-flight operation.
(c) Scoreboarding: a scoreboard tracks slots, indicator bit positions, or other storage elements claimed by in-flight operations; a subsequent operation that would alias any claimed element is stalled, deferred, or retried until the claim is released.
(d) Cascade scoreboarding: when a directed relocation cascade (Chapter V. B.) is in flight, the scoreboard extends to cover the cascade's corridor of slots and nodes, such that a subsequent operation targeting any slot or node in the corridor is stalled, deferred, or retried until the cascade completes.
(e) Pipeline interlocks: the pipeline stalls subsequent operations at the entry stage until detected hazards are resolved, the resolution being signaled by the release of claimed resources.
(f) Retry semantics: a subsequent operation that cannot be resolved through forwarding or stalling is rejected at the host interface with a retry indication; the host interface or dispatching logic re-submits the operation after an intervening period.
(g) Atomic commit: the indicator storage and slot payload updates for each operation are committed atomically as a read-modify-write transaction that either completes in full or is retried, such that external observers and subsequent operations see either the pre-operation or the post-operation state of the affected storage elements.
(h) Serialized per-node operation: in one embodiment, the accelerator processes at most one operation at a time per node, with hazards resolved by serializing operations targeting the same node while allowing pipelined operation across different nodes.

In one embodiment, host reads of the indicator storage or the contiguously addressable slot region are either stalled until a consistent state is available or routed to a pre-commit image to prevent torn observations, consistent with the coherency handling described for the order-book price-level accelerator at Chapter IX. F.

### Independently Implemented Coherency Logic or Hazard-Resolution Logic.

In various embodiments, an accelerator circuit may include coherency logic alone, hazard-resolution logic alone, a unified logic block performing both coherency-preservation and hazard-resolution functions, or separate coherency logic and hazard-resolution logic blocks operating cooperatively. Such logic prevents conflicting in-flight edits from producing an externally observable incoherent slot-payload or priority-indicator state, including by one or more of the mechanisms enumerated in this subsection. Any such arrangement is within the scope of the disclosed coherency or hazard-resolution logic.

### Depth-Aware Heterogeneous Slot-Region Allocation in Hardware Circuitry.

In embodiments where any portion of the order-queue storage engine is realized as hardware circuitry (Chapter II. M.) and adapts the depth-aware principle of Chapter VII, the circuitry's memory may be organized as a tiered memory hierarchy in which slot regions for entries near the top of the order book reside in faster, lower-latency memory and slot regions for entries at greater depth reside in slower, higher-capacity memory. The tiered allocation reflects the principle that top-of-book entries are accessed more frequently than tail entries, while accommodating hardware-specific constraints such as memory-block granularity, aggregate memory budget, and addressing complexity that differ from the cache-line-driven optimization of Chapter VII's software model. Other hardware-circuitry realizations of depth-aware allocation, including continuous capacity functions, multi-tier hierarchies with three or more tiers, or hybrid policies combining tiered memory with per-region capacity variation, are within the scope of this disclosure.

### Non-Limiting Examples of Tiered Memory Embodiments.

Non-limiting examples of the top tier include distributed RAM (e.g., LUT-based RAM), register files, or other low-latency on-die storage configured as one or more fixed-capacity slot regions. Non-limiting examples of the tail tier include block RAM, embedded SRAM, ultra-RAM (URAM), or memory accessed via a coherent or low-latency interconnect, configured as one or more slot regions of larger aggregate capacity. The boundary between top and tail tiers—for example, the number of top-tier nodes or the cumulative depth covered by the top tier—may be fixed at synthesis or configuration time based on expected workload parameters, or may be dynamically reconfigured by a host processor or other control logic that updates the tier boundary based on telemetry.

### Configurable Priority Rule.

In one embodiment, the predetermined priority rule implemented by the operation logic is selectable via at least one of: a configuration register writable by the host processor, a configuration image loadable onto the accelerator circuit, or a synthesis parameter applied at design time. Different priority rules (e.g., price-time FIFO, pro-rata, tiered maker-taker) may share the same memory layout and indicator storage structure, differing only in how the operation logic determines any target insertion position or otherwise applies the rule, and how the operation logic (e.g., indicator-update logic, insertion logic, removal logic, shared datapath or control circuitry performing indicator-update functionality, or any combination thereof) maintains the priority indicators. This enables a single accelerator design to serve multiple markets or instruments with different priority policies.

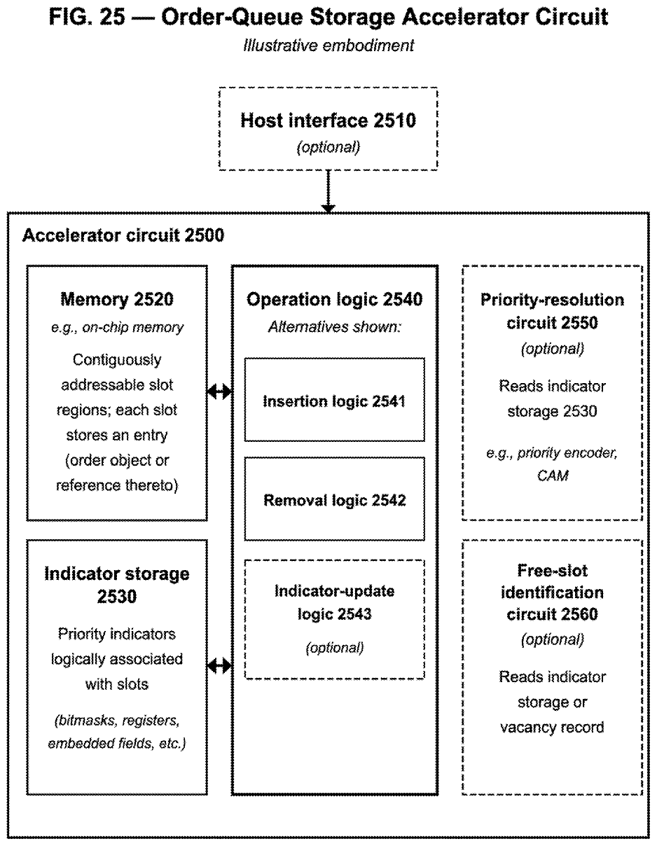

### Order-Queue Storage Accelerator Circuit Overview (FIG. 25).

In one embodiment, the order-queue storage accelerator circuit 2500 illustrated in FIG. 25 may include some or all of the following (elements 2510, 2550, and 2560 being non-essential): a host interface 2510 (per Chapter II. J. and Chapter II. M.) for communicatively coupling the accelerator circuit 2500 to a host processor or to an upstream protocol pipeline, the host interface being optional in deployments where the accelerator circuit is integrated with a network parser pipeline, with an embedded packet-processing front-end, with a SmartNIC or similar in-NIC realization (e.g., per Chapter II. M. and Chapter IX. H.), or with another upstream interface that does not require a separate host-interface block; memory 2520 (e.g., on-chip memory) providing one or more contiguously addressable slot regions configured to store entries each comprising an order object or a reference thereto; indicator storage 2530, which may be realized as a region of the memory 2520 or as a separate memory bank, configured to hold one or more priority indicators logically associated with the slots of the contiguously addressable slot regions; operation logic 2540 (per Chapter II.R, “Operation logic”), illustratively depicted as including insertion logic 2541, removal logic 2542, or both, with optional indicator-update logic 2543, the operation logic 2540 being configured, as applicable, to write entries to the memory, remove entries therefrom, or maintain the priority indicators in accordance with the active predetermined priority rule; a priority-resolution circuit 2550 configured to determine slot indices corresponding to a priority status under the active predetermined priority rule; and a free-slot identification circuit 2560 configured to determine slot indices identifying vacant slots within the contiguously addressable slot regions. The accelerator circuit 2500 may further include a vacancy record (illustrated in FIG. 25 without a separate reference numeral; optional) accessible to the free-slot identification circuit 2560 as a vacancy-state source. The depicted partitioning is illustrative; embodiments may merge, separate, or reorder the elements 2510-2560, may share circuitry across one or more functional blocks, including by instantiating insertion logic, removal logic, or both, with indicator-update logic optionally instantiated separately or merged into other operation logic, and may incorporate additional control, coherency, or hazard-handling logic per Chapter IX. H. The illustrated FIG. 25 reference numerals are non-limiting; functional equivalents satisfying the structural-meaning framework of Chapter II. R. are within scope.

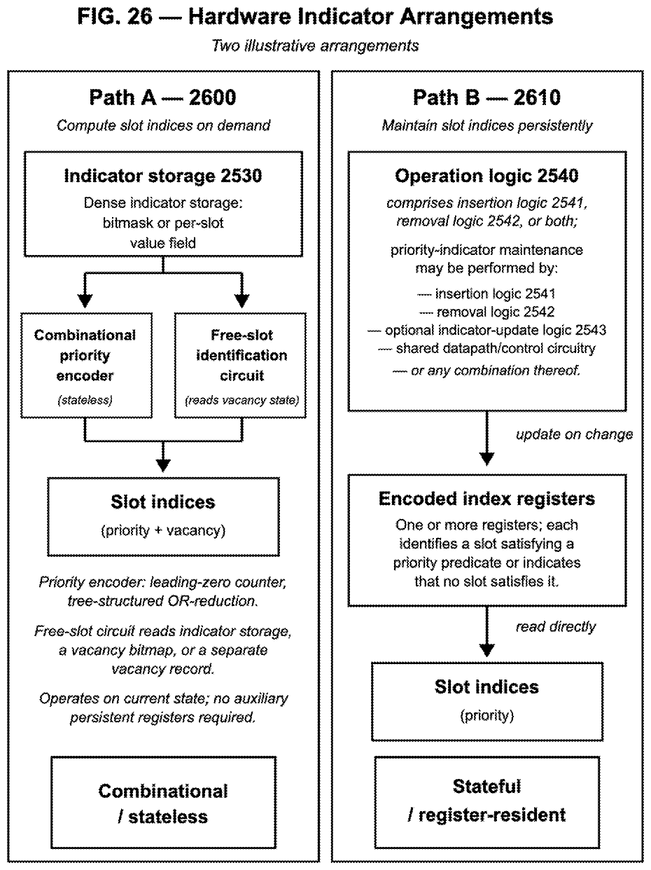

### Illustrative Hardware Indicator Arrangements (FIG. 26).

In one embodiment, the priority-resolution circuit and the free-slot identification circuit are realized in non-limiting arrangements illustrated in FIG. 26. In a first arrangement (Path A, FIG. 26 element 2600), a combinational priority encoder (Chapter II. E., “Priority-resolution circuit”) reads the indicator storage on demand to produce slot indices for the priority-resolution circuit; in further embodiments, a free-slot identification circuit reads vacancy state derived from the indicator storage, a vacancy bitmap, or a separate vacancy record to produce indices of vacant slots, separately from or in cooperation with the priority encoder. The Path A circuits compute their outputs on demand from current indicator-storage or vacancy state, without requiring the Path B encoded index registers. In a second arrangement (Path B, FIG. 26 element 2610), one or more encoded index registers (Chapter II. E., “Encoded index register representation”) maintain slot indices persistently, with each register identifying a slot satisfying a priority predicate or indicating that no slot satisfies the predicate, and the registers are updated by operation logic, including indicator-update logic, insertion logic, removal logic, shared datapath or control circuitry performing indicator-update functionality, or any combination thereof, in response to changes in occupancy or priority status. Either arrangement, alone or in combination with one or more other realizations within the priority-indicator genus described in Chapter II. E., may be employed; embodiments are not limited to the depicted arrangements.

### Realization-Neutral Disclaimer.

The embodiments described in this Chapter IX. H., FIG. 25, and FIG. 26 are illustrative and do not restrict the scope of the order-queue storage accelerator circuit. Any hardware-circuitry embodiment per Chapter II. M. that performs one or more of the order-queue storage operations described in Chapters V-VI using a contiguously addressable slot region and priority indicators is within the scope of this disclosure, regardless of whether it incorporates the specific micro-architectural features described or illustrated.

### Chapter X.—Ordered Replicated Deployments, Including Consensus-Ledger Embodiments

The embodiments in this Chapter describe deployments in which one or more engine instances apply order-related events according to an event order, where the engine instances may be replicated, partitioned across shards, or distributed among participants (e.g., validators, follower replicas, sequencer nodes, state-summary participants, or other roles described at Chapter X. A. and Chapter X. D.) according to the deployment topology. The event order may be derived from a consensus ledger, total-order broadcast, leader-replicated log, sequencer, or any other mechanism that establishes an ordering sufficient for the affected engine scope. A consensus ledger is one species of event-order source; references to ordered replicated deployments in this Chapter do not modify the meaning of “consensus ledger” where that term is specifically recited. As used in this chapter, “the engine” or “the service” include realizations as computer-executable instructions executed by one or more processors, as hardware circuitry per Chapter II. M., or as any combination thereof; the operations described herein are realization-neutral and may be performed by software, by hardware circuitry, or by hybrid software/hardware deployments.

### Chapter X. A.—Consensus Ledger; Roles; Replicated Deployment; Ingestion.

As used herein, a “consensus ledger” denotes any append-only log that provides a total order of application events via a consensus protocol (e.g., BFT, proof-of-stake/work, Raft/Paxos). A “validator” is a process, machine, hardware circuitry, or combination thereof that participates in proposing, voting on, or finalizing ledger entries; “finality” refers to the point at which an entry is treated as irrevocable for state application. In some embodiments, the order-queue storage engine is replicated across a plurality of computers, hardware circuitry, or combinations thereof (e.g., validator nodes and read replicas) that participate in a peer-to-peer network. A replication module on each validator subscribes to the consensus ledger and ingests committed blocks or log entries in order; for each block, the module extracts per-instrument order events (add, cancel, modify) and dispatches them in ledger order to the corresponding engine instance. The replication module may be realized as computer-executable instructions, as hardware circuitry per Chapter II. M., or as a combination thereof.

### Total-Order Broadcast Protocol.

Beyond the consensus-protocol mechanisms enumerated above, the event order of application events for purposes of this Chapter may also be derived from a total-order broadcast protocol (in which messages are delivered to all participants in the same order via an underlying broadcast primitive), a leader-replicated log (in which a designated leader sequences events and replicates the log to follower participants), a sequencer architecture (such as those used in layer-2 rollups, hosted matching-as-a-service infrastructures, or centralized matching engines that designate one or more sequencer processes to assign canonical ordering), or any combination of the foregoing.

### Terminology Clarification.

As used herein, an “event order” includes a total order of application events, a per-shard or per-instrument order derived from a total order or other ordering mechanism, or any composite or partial order that determines, for each operation, an unambiguous ordering position relative to operations sharing its applicable scope. As used herein, “participant” refers to a process, machine, hardware circuitry, or combination thereof that participates in the replicated deployment in any role, including without limitation a validator, a follower replica, a read replica, a light client, an observer, a partial-replica node, a shard-specific node, a sequencer node, or a state-summary node. The participants may collectively maintain replicas, partial replicas, sharded replicas, or state summaries of the contiguously addressable slot regions and the priority indicators, with no requirement that any individual participant maintain the entirety of such state. A “state summary derived from” the contiguously addressable slot regions and the priority indicators encompasses without limitation a hash, Merkle root, snapshot digest, sampled subset, fingerprint, or other derivative representation of such state, as further described at Chapter X. D.

### Disambiguation Regarding “Node.”

As used in this Chapter X, the term “node” when appearing as a compound role-identifier (including without limitation validator node, sequencer node, partial-replica node, shard-specific node, and state-summary node) refers to a deployment participant per the foregoing definition and is distinct from “node” (see Chapter II. S.) recited in the claims of this application. To avoid ambiguity, references in this Chapter X to a claim-recited order-queue storage node are made using the term “Data Holder Node.” References to other uses of “node” elsewhere in this disclosure are unaffected by this paragraph.

### Chapter X. B.—Deterministic Application to Slot Regions and Indicators; Convergence.

For each instrument, the engine processes events according to the event order on a deterministic execution context and (i) writes orders into contiguously addressable slot regions of Data Holder Nodes according to a predetermined priority rule (e.g., append or prepend), and (ii) updates priority indicators (e.g., bitmasks or slot-indexed flags) to reflect head/tail status. Cancels and modifies locate the target slot via an indexing data structure that maps each order identifier to a storage location of the corresponding entry, as described at Chapter V. D. and (in hardware-circuitry embodiments) at Chapter IX. H., and update the slot and the priority indicators. Given the event order and deterministic update rules, all correct replicas converge—after each event-order-defined commit boundary (e.g., a committed block in a consensus-ledger deployment, a finalized batch in a sequencer deployment, or a corresponding boundary in another event-order source per Chapter X. A.)—to a logically equivalent state of the contiguously addressable slot regions and the priority indicators.

### Equivalence Over “Logically Equivalent State.”

As used herein, “logically equivalent state” means that, across replicas, the interpreted slot occupancy, stored entries, and priority status under the active predetermined priority rule correspond, allowing for replica-specific differences in physical layout, sparse-versus-dense encoding, or implementation-specific canonicalization. Where sparse encodings elide neutral regions, a replica may canonicalize state for hashing (e.g., re-materialize as explicit zeros) or hash a normalized form; both approaches are equivalent because elided neutral priority-indicator values in sparse or compressed indicator encodings are semantically equivalent to present neutral indicator values per Chapter II. F.; this equivalence does not alter the stored-entry or slot-occupancy state. In embodiments where any portion of the engine is realized as hardware circuitry (Chapter II. M.), the slot regions are realized within or accessible to the hardware circuitry, including in some embodiments as memory of an order-queue storage accelerator circuit per Chapter IX. H. The deterministic execution context may be a dedicated hardware pipeline rather than a software thread.

### Chapter X. C.—Bounded Directed Relocation in Ordered Replicated Deployments.

When a selected Data Holder Node lacks a free slot, embodiments may perform directed relocation that moves one order per hop to an adjacent Data Holder Node in a single direction (e.g., toward head or toward tail), bounded by a configured maximum hop count (Dmax), per Chapter V. B.; if Dmax is reached without finding a free slot, a new Data Holder Node may be added at the cascade boundary, or the overflow may be resolved by another realization of capacity overflow handling logic (see Chapter V. B.). After each hop, the engine may update only a bounded set of machine-word locations corresponding to the priority indicators and any node-local administrative fields used by the embodiment, preserving, for slot-index-addressed or co-located realizations, a coherent mapping between slot indices and indicators, and, for register-based or designated-position realizations, the structural association set forth at Chapter II. E. In embodiments where any portion of the engine is realized as hardware circuitry (Chapter II. M.), the directed relocation may be implemented as a pipelined datapath that performs each hop in a bounded number of clock cycles, with the overall cascade bounded by at most Dmax hops, consistent with the per-hop work bound at Chapter V. B. and the constant-bounded property of Chapter II. G., for hardware-circuitry embodiments.

### Chapter X. D.—Finality, Reorganization, Verification, and Sharding.

With deterministic finality, blocks are applied once upon commit. With probabilistic finality, the engine may tentatively apply recent blocks and retain sufficient rollback state—for example, a per-block journal of inverse operations, a pre-block snapshot of the slot regions and priority indicators, or a copy-on-write maintained alternate state—to roll back and replay upon a ledger reorganization, maintaining, for slot-index-addressed or co-located realizations, the slot/indicator logical mapping, and, for register-based or designated-position realizations, the structural association set forth at Chapter II. E. After processing a committed block, an engine instance may compute a state fingerprint (e.g., a hash, Merkle root, or other cryptographic digest) over the slot regions, priority indicators, and optionally other engine state, and may use the fingerprint to verify replica equivalence at block boundaries—for example, by publishing the fingerprint, comparing it across replicas, committing it to the ledger, signing it, or otherwise communicating it across validators.

### Partitioned Embodiments

Instruments may be partitioned across shards (e.g., ledger topics or namespaces, instrument-hash partitions, validator-set partitions, subnet or chain separations, or other partitioning schemes), with each shard's engine instance applying its shard's ordered events to its own slot regions and priority indicators; a composite total order for cross-shard operations may be obtained from ledger guarantees or by assigning global tickets and applying a merge policy that preserves logical order.

### Further Clarification.

The state-fingerprint computation, rollback-state maintenance, and shard-level event dispatch described in this subsection may be realized as computer-executable instructions executed by one or more processors, as hardware circuitry (Chapter II. M.), or as any combination thereof. As used in this Chapter X. D. only, the terms “block,” “committed block,” “per-block journal,” “pre-block snapshot,” “block boundaries,” and “ledger reorganization” describe consensus-ledger deployments; the foregoing structures and operations apply to analogous structures of non-ledger event-order sources per Chapter X. A. (including without limitation streaming, per-event-finality, batch-finality, and sequencer architectures), without limiting the meaning of those terms where specifically recited elsewhere.

### Chapter XI.—Appendices (Illustrative, Non-Limiting)

### Appendix A: Bitmask Algebra/Proofs (Word-Width Model; Operators; Invariants)

Clarifying note on the “Rank” usage.

Unless stated otherwise, all vector-space operations are over [symbol] ₂ and throughout, “⊕” denotes component-wise addition in [symbol] ₂ (i.e., bitwise XOR); there is no inter-bit carry. Likewise, “∨” denotes component-wise multiplication in [symbol] ₂ (bitwise AND). References herein to the “rank” of an update mean the rank of the linear operator that either:
(a) is the linear part of the stated affine update; or
(b) agrees with the affine update on the relevant admissible subset defined in the specification.

Mask updates in this disclosure are modeled as affine endomorphisms on V² (shifts/XOR/AND with a sparse translation vector), and non-linear XOR↔OR variants remain within scope as noted above.

### Regarding the Rank Example Used in Simple Append.

On states with Tₖ₋₁=1 and Tₖ=0, the affine update T [symbol] T⊕(eₖ⊕eₖ₋₁) coincides with the linear map M defined by Meₖ₋₁=eₖ and Meⱼ=eⱼ for j≠k−1. Equivalently,

$$M = I ⊕ ( ( {e}_{k} ⊕ {e}_{k - 1} ) {e}_{k - 1}^{T} ) ,$$

so M⊕I is a single outer product and therefore rank-1 over [symbol] ₂.

### Regarding the Rank Example Used in General Append.

The linear part acting on (H,T) is diag(Pₖ,Pₖ), where the zero-fill suffix-shift Pₖ has rank C−1 (injective on the subspace with x_{C-1}=0), per the precondition stated in that paragraph. Hence the block-diagonal linear part has rank 2(C−1) (or C−1 if only T is tracked). The accompanying translation term raises the newly created flags and does not affect the stated rank of the linear part. Accordingly, in this Appendix and in references throughout this specification to the rank of a linear operator, linear endomorphism, affine update, or matrix over F2, any use of “rank” is shorthand for “rank of the linear operator” that either:
(a) is the linear part of the stated affine update; or
(b) matches the stated affine update on the admissible subset at issue and imposes no limitation beyond the implementation-agnostic affine/Boolean formulations already provided.

### Appendix B: Cascade Termination

### Order Book System Model.

Let the order book be represented by a finite sequence of Data Holder Nodes,

$$𝒩 = {( {N}_{k} )}_{k = 0}^{D}$$

where N₀, N_{D} are the first Data Holder Node and the last Data Holder Node in the order book chain, respectively. A cascade operation is a sequence of state transitions, σ₀→σ₁→ . . . . A state σ is defined by the configuration of orders in [symbol] and the index k of the currently operative node Nₖ.

### Recursion Safety on Cascades.

Both Push Forward and Push Back cascade algorithms are governed by a strictly decreasing measure on a well-ordered set, which guarantees their termination. Therefore, infinite recursion is mathematically impossible regardless of any changes to Data Holder Node capacities. Here's the proof:
(a) Push Forward cascade safety—Let →_{PF} be the state transition relation for a Push Forward cascade. A transition moves the operative focus from a full node Nₖ to preceding node Nₖ₋₁. Define a ranking function ƒ_{PF} mapping the state to the well-ordered set ( [symbol] , <):

$${f}_{P F} ( σ ) := k$$

For any transition from a state with operative index k to one with index k−1, the rank strictly decreases (ƒ_{PF}(σ′)<ƒ_{PF}(σ)). As the rank is a natural number bounded below by 0, the relation is well-founded, and no infinite Push Forward cascade can exist.
(b) Push Back cascade safety—Let the measure of a state a whose operative node is Nₖ be the lexicographically ordered pair:

$${f}_{P B} ( σ ) = ( c ( σ ) , d ( σ ) ) ∈ ℕ \times ℕ$$

where c(σ) is the total number of full nodes from Nₖ to the tail (inclusive), and d(σ) is the distance from Nₖ to the snapshot tail Tail₀ (the tail index captured when the cascade starts). During a transition from state σ (at index k) to σ′ (at index k+1), the primary measure c(σ) cannot increase. Because Tail₀ is fixed for the duration of the cascade, each hop strictly reduces (c, d) in lexicographic order even when the physical tail grows (e.g., the capacity-1 extend-tail case). The extend-tail case (allocation of a new node beyond Tail₀) terminates the cascade and is not a transition in the state sequence; accordingly, the measure (c,d) need only be evaluated across hop transitions, all of which occur at indices k≤Tail₀.
   (i) If c(σ′)<c(σ) (which occurs if node Nₖ becomes non-full and this change is not offset by other nodes becoming full), the pair strictly decreases.
   (ii) If c(σ′)=c(σ), the secondary measure d(σ) strictly decreases:

$$d ( {σ}^{′} ) < d ( σ ) .$$

In all cases, the pair (c(σ),d(σ)) strictly decreases with respect to the lexicographical order on [symbol] × [symbol] . Since this order is well-founded, infinite Push Back cascades are impossible.

1. An order-queue storage engine for an electronic order book, the engine embodied as computer-executable instructions executed by one or more processors, as hardware circuitry, or as a combination thereof, wherein the engine comprises:
(a) at least one node having a contiguously addressable slot region configured to store up to a predetermined number of entries, each entry comprising an order object or a reference thereto, the contiguously addressable slot region providing sequential memory access;
(b) one or more priority indicators logically associated with slots of the contiguously addressable slot region, the one or more priority indicators denoting priority status of entries stored in the slots in accordance with a predetermined priority rule, the engine determining therefrom priority status of an entry in a slot without requiring a search across the entire order book;
(c) insertion logic configured to insert or reinsert an entry by:
(i) determining a target insertion position according to the predetermined priority rule;
(ii) storing an entry into a selected slot of a selected one of the nodes; and
(iii) when the selected one of the nodes lacks a free slot, invoking capacity overflow handling logic that yields a selected slot in any of the nodes, including in a node allocated for the insertion or reinsertion, for performing step (ii);
(d) removal logic configured to remove or invalidate an entry stored in a slot of any of the nodes; and
(e) wherein upon completion of each operation involving an entry in the slot region, the engine maintains the priority indicators in coherent state with the priority status of entries stored in the slots under the predetermined priority rule.

2. The engine of claim 1, wherein maintaining the priority indicators in coherent state comprises changing one or more priority indicators to denote a changed priority status of a slot other than a slot into which an entry is stored or from which an entry is removed or invalidated.

3. The engine of claim 1, wherein the capacity overflow handling logic executes a relocation cascade that relocates entries in a single direction across nodes until a free slot is obtained.

4. The engine of claim 3, wherein the relocation cascade is bounded to at most a configured maximum hop count, and wherein the capacity overflow handling logic allocates a new node when no free slot is obtained within the configured maximum hop count.

5. The engine of claim 1, further comprising a price level indexing data structure, wherein the engine supplies one or more in-order neighbor references for a target price level to the price level indexing data structure for use in performing a structural modification to the price level indexing data structure.

6. The engine of claim 1, wherein, for each of a plurality of nodes, the predetermined number of entries is determined according to a depth-aware capacity policy based on the node's distance from a head of the order book.

7. The engine of claim 1, wherein absence of a corresponding priority-indicator value, or a neutral priority-indicator value, denotes, under the predetermined priority rule, non-occupancy of a slot, a non-asserted priority status for a slot, or that no slot satisfies the denoted predicate.

8. The engine of claim 1, wherein the insertion logic determines the target insertion position with respect to a rule-defined reference designating a slot position of the selected one of the nodes.

9. The engine of claim 1, further comprising an indexing data structure that maps each order identifier to a storage location of a corresponding entry within the order book, the indexing data structure being updated in response to storing, removing, invalidating, or relocating an entry.

10. The engine of claim 1, wherein maintaining the priority indicators in coherent state comprises a constant-bounded number of operations.

11. An order-queue storage accelerator circuit for an electronic order book, the accelerator circuit comprising:
(a) memory comprising at least one node, each node having a contiguously addressable slot region configured to store up to a predetermined number of entries, each entry comprising an order object or a reference thereto, the contiguously addressable slot region providing sequential memory access;
(b) indicator storage maintaining one or more priority indicators logically associated with slots of the contiguously addressable slot region, the one or more priority indicators denoting priority status of entries stored in the slots in accordance with a predetermined priority rule, the accelerator circuit determining therefrom priority status of an entry in a slot without requiring a search across the entire order book; and
(c) operation logic comprising one or both of:
(i) insertion logic configured to write an entry into a selected slot according to the predetermined priority rule; or
(ii) removal logic configured to remove or invalidate an entry stored in a selected slot;
(d) wherein the operation logic is configured to maintain, upon completion of each operation performed by the accelerator circuit involving an entry in a slot region, the priority indicators in coherent state with the priority status of entries stored in the slots under the predetermined priority rule.

12. The accelerator circuit of claim 11, further comprising a priority-resolution circuit, wherein the priority-resolution circuit comprises a combinational priority encoder, a leading-zero counter, a trailing-zero counter, a tree-structured OR-reduction with index propagation, or a content-addressable comparison network.

13. The accelerator circuit of claim 11, wherein the accelerator circuit resides within a network interface device, a data processing unit, or a SmartNIC and receives order-entry operations from a network parser pipeline implemented on the same device, the accelerator circuit being configured to operate without a host processor on a data path of the order-entry operations.

14. The accelerator circuit of claim 11, wherein entries at different depths of the order book are stored in slot regions residing in different tiers of a tiered memory hierarchy, the different tiers comprising any combination of: distributed RAM, register files, embedded SRAM, block RAM, ultra-RAM, off-chip DRAM, or memory accessed via a coherent or low-latency interconnect.

15. The accelerator circuit of claim 11, wherein the indicator storage comprises one or more bitmasks, encoded index registers, embedded fields, or indicator memory separate from the contiguously addressable slot regions, and wherein absent slot-indexed indicator values in sparse or compressed slot-indexed encodings are interpreted as neutral values.

16. The accelerator circuit of claim 11, wherein the indicator storage maintains, for each priority predicate defined by the predetermined priority rule, an encoded index register identifying a slot satisfying that predicate or indicating that no slot in the slot regions satisfies that predicate.

17. The accelerator circuit of claim 11, further comprising a free-slot identification circuit configured to identify a vacant slot by bounded examination of vacancy state associated with the slot region, including vacancy state in the indicator storage, a vacancy bitmap, or a separate vacancy record.

18. The accelerator circuit of claim 11, further comprising coherency or hazard-resolution logic configured to prevent conflicting edits between in-flight operations by forwarding, scoreboarding, interlocking, retrying, atomic commit, serialized per-node operation, or any combination thereof.

19. The accelerator circuit of claim 11, wherein the predetermined priority rule is selectable via at least one of: a configuration register writable by a host processor, a configuration image loadable onto the accelerator circuit, or a synthesis parameter applied at design time, enabling the accelerator circuit to implement different priority policies.

20. The accelerator circuit of claim 11, wherein the indicator storage and the contiguously addressable slot regions are accessible within a shared accelerator clock domain without a clock-domain crossing synchronization delay for accesses by the operation logic.

21. The accelerator circuit of claim 11, wherein the accelerator circuit is configured to accept a subsequent operation while a preceding operation is being processed.

22. The accelerator circuit of claim 11, wherein the memory provides at least two independent access ports enabling concurrent read access and write access to different slots of the contiguously addressable slot regions.

23. The accelerator circuit of claim 11, further comprising a price level indexing data structure, wherein the accelerator circuit supplies one or more in-order neighbor references for a target price level to the price level indexing data structure for use in performing a structural modification to the price level indexing data structure.

24. The accelerator circuit of claim 11, further comprising an on-chip indexing structure that maps each order identifier to a storage location of a corresponding entry within the contiguously addressable slot regions, the on-chip indexing structure being updated in response to storing, removing, invalidating, or relocating an entry.

25. A non-transitory machine-readable medium storing machine-executable content for an order-queue storage engine for an electronic order book, wherein the machine-executable content, when loaded onto a target device, causes the target device to:
(a) instantiate at least one node, each node having a contiguously addressable slot region configured to store up to a predetermined number of entries, each entry comprising an order object or a reference thereto, the contiguously addressable slot region providing sequential memory access;
(b) maintain one or more priority indicators logically associated with slots of the contiguously addressable slot region, the one or more priority indicators denoting priority status of entries stored in the slots in accordance with a predetermined priority rule, the engine determining therefrom priority status of an entry in a slot without requiring a search across the entire order book;
(c) insert or reinsert an entry by:
(i) determining a target insertion position according to the predetermined priority rule;
(ii) storing an entry into a selected slot of a selected one of the nodes; and
(iii) when the selected one of the nodes lacks a free slot, invoking capacity overflow handling logic that yields a selected slot in any of the nodes, including in a node allocated for the insertion or reinsertion, for performing step (ii);
(d) remove or invalidate an entry stored in a slot of any of the nodes; and
(e) upon completion of each operation involving an entry in the slot region, maintain the priority indicators in coherent state with the priority status of entries stored in the slots under the predetermined priority rule.

26. The medium of claim 25, wherein maintaining the priority indicators in coherent state comprises changing one or more priority indicators to denote a changed priority status of a slot other than a slot into which an entry is stored or from which an entry is removed or invalidated.

27. A service for an electronic order book, the service embodied as computer-executable instructions executed by one or more processors, as hardware circuitry, or as a combination thereof, the service comprising:
(a) an application-programming interface (API) configured to receive at least one of add, cancel, or modify requests for orders, or any combination thereof; and
(b) a store realized as an order-queue storage engine comprising at least one node, each node having a contiguously addressable slot region configured to store up to a predetermined number of entries, each entry comprising an order object or a reference thereto, the contiguously addressable slot region providing sequential memory access, and one or more priority indicators logically associated with slots of the contiguously addressable slot region, the one or more priority indicators denoting priority status of entries stored in the slots in accordance with a predetermined priority rule, the engine determining therefrom priority status of an entry in a slot without requiring a search across the entire order book;
the service being configured to:
(c) insert or reinsert an entry by:
(i) determining a target insertion position according to the predetermined priority rule;
(ii) storing an entry into a selected slot of a selected one of the nodes; and
(iii) when the selected one of the nodes lacks a free slot, invoking capacity overflow handling logic that yields a selected slot in any of the nodes, including in a node allocated for the insertion or reinsertion, for performing step (ii);
(d) remove or invalidate an entry stored in a slot of any of the nodes; and
(e) upon completion of each operation involving an entry in the slot region, maintain the priority indicators in coherent state with the priority status of entries stored in the slots under the predetermined priority rule.

28. The service of claim 27, wherein maintaining the priority indicators in coherent state comprises changing one or more priority indicators to denote a changed priority status of a slot other than a slot into which an entry is stored or from which an entry is removed or invalidated.

29. The service of claim 27, wherein the service maintains an indexing data structure that maps each order identifier to a storage location of a corresponding entry within the order book, the indexing data structure being updated in response to storing, removing, invalidating, or relocating an entry.

30. The service of claim 27, executing on a plurality of participants, wherein one or more participants maintain the contiguously addressable slot regions and priority indicators, one or more participants maintain replicas, partial replicas, sharded replicas, or state summaries thereof, and the service applies received add, cancel, or modify requests according to an event order derived from total-order broadcast, a consensus protocol, a leader-replicated log, a sequencer, or any combination thereof, or according to a per-shard or per-instrument order consistent therewith.
